(19) United States
(12) Patent Application Publication
(10) Pub. No.: US 2023/0189192 A1
(43) Pub. Date: Jun. 15, 2023

(54) Access to Second Network by Wireless Device

(71) Applicant: Ofinno, LLC, Reston, VA (US)

(72) Inventors: Peyman Talebi Fard, Vienna, VA (US); Esmael Hejazi Dinan, McLean, VA (US); Jinsook Ryu, Oakton, VA (US); Kyungmin Park, Vienna, VA (US); Taehun Kim, Fairfax, VA (US)

(73) Assignee: Ofinno, LLC, Reston, VA (US)

(21) Appl. No.: 18/107,556

(22) Filed: Feb. 9, 2023

Related U.S. Application Data
(63) Continuation of application No. PCT/US2021/045347, filed on Aug. 10, 2021.
(60) Provisional application No. 63/064,170, filed on Aug. 11, 2020.

(51) Int. Cl. H04W 60/04; H04L 12/46; H04W 12/082; H04W 12/088

(52) U.S. Cl. CPC H04W 60/04; H04L 12/4633; H04W 12/082; H04W 12/088; H04W 80/10

(57) ABSTRACT

A wireless device sends, to a base station of a first network, a registration request. The wireless device receives, from a mobility management function of the first network, a registration accept message indicating that the first network provides underlay support for a second network. The wireless device sends, to the mobility management function of the first network and based on the indication of underlay support, a request to establish a session with the first network.

### CROSS-REFERENCE TO RELATED APPLICATIONS

This application is a continuation of International Application No. PCT/US2021/045347, filed Aug. 10, 2021, which claims the benefit of U.S. Provisional Application No. 63/064,170, filed Aug. 11, 2020, which is hereby incorporated by reference in its entirety.

### BRIEF DESCRIPTION OF THE SEVERAL VIEWS OF THE DRAWINGS

Examples of several of the various embodiments of the present invention are described herein with reference to the drawings.

FIG. 1 is a diagram of an example 5G system architecture as per an aspect of an embodiment of the present disclosure.

FIG. 2 is a diagram of an example 5G System architecture as per an aspect of an embodiment of the present disclosure.

FIG. 3 is a system diagram of an example wireless device and a network node in a 5G system as per an aspect of an embodiment of the present disclosure.

FIG. 4 is a system diagram of an example wireless device as per an aspect of an embodiment of the present disclosure.

FIG. 5A and FIG. 5B depict two registration management state models in UE 100 and AMF 155 as per an aspect of embodiments of the present disclosure.

FIG. 6A and FIG. 6B depict two connection management state models in UE 100 and AMF 155 as per an aspect of embodiments of the present disclosure.

FIG. 7 is diagram for classification and marking traffic as per an aspect of an embodiment of the present disclosure.

FIG. 8 is an example call flow for registration procedure as per an aspect of an embodiment of the present disclosure.

FIG. 9 is an example call flow for registration procedure as per an aspect of an embodiment of the present disclosure.

FIG. 10 is an example call flow for service request procedure as per an aspect of an embodiment of the present disclosure.

FIG. 11 is an example call flow for service request procedure as per an aspect of an embodiment of the present disclosure.

FIG. 12 is an example call flow for PDU session establishment procedure as per an aspect of an embodiment of the present disclosure.

FIG. 13 is an example call flow for PDU session establishment procedure as per an aspect of an embodiment of the present disclosure.

FIG. 14 illustrates example mobile communication networks as per an aspect of an embodiment of the present disclosure.

FIG. 15 illustrates an example embodiment of a present disclosure.

FIG. 16 illustrates an example embodiment of a present disclosure.

FIG. 17 illustrates an example embodiment of a present disclosure.

FIG. 18 illustrates an example embodiment of a present disclosure.

FIG. 19 illustrates an example embodiment of a present disclosure.

FIG. 20 illustrates an example embodiment of a present disclosure.

FIG. 21 illustrates an example embodiment of a present disclosure.

FIG. 22 illustrates an example embodiment of a present disclosure.

FIG. 23 illustrates an example embodiment of a present disclosure.

FIG. 24 illustrates an example embodiment of a present disclosure.

FIG. 25 illustrates an example embodiment of a present disclosure.

FIG. 26 illustrates an example embodiment of a present disclosure.

FIG. 27 illustrates an example embodiment of a present disclosure.

FIG. 28 illustrates an example embodiment of a present disclosure.

FIG. 29 illustrates an example embodiment of a present disclosure.

FIG. 30 illustrates an example embodiment of a present disclosure.

FIG. 31 illustrates an example embodiment of a present disclosure.

FIG. 32 illustrates an example embodiment of a present disclosure.

FIG. 33 illustrates an example embodiment of a present disclosure.

FIG. 34 illustrates an example embodiment of a present disclosure.

FIG. 35 illustrates an example flow chart of a present disclosure.

FIG. 36 illustrates an example flow chart of a present disclosure.

FIG. 37 illustrates an example flow chart of a present disclosure.

FIG. 38 illustrates an example flow chart of a present disclosure.

### DETAILED DESCRIPTION

Example embodiments of the present invention enable implementation of enhanced features and functionalities in 5G systems. More particularly, the embodiments of the technology positioning via user plane transmission (e.g. for 5G or future communication system). Throughout the present disclosure, UE, wireless device, vehicle terminal, and mobile device are used interchangeably. Throughout the present disclosure, base station, (Radio) Access Network ((R)AN), Next Generation Radio Access Network (NG-RAN), New radio Node B (gNB), Next Generation eNodeB (ng-eNBs) are used interchangeably. Throughout the present disclosure, base station, Radio Access Network (RAN), eNodeB are used interchangeably.

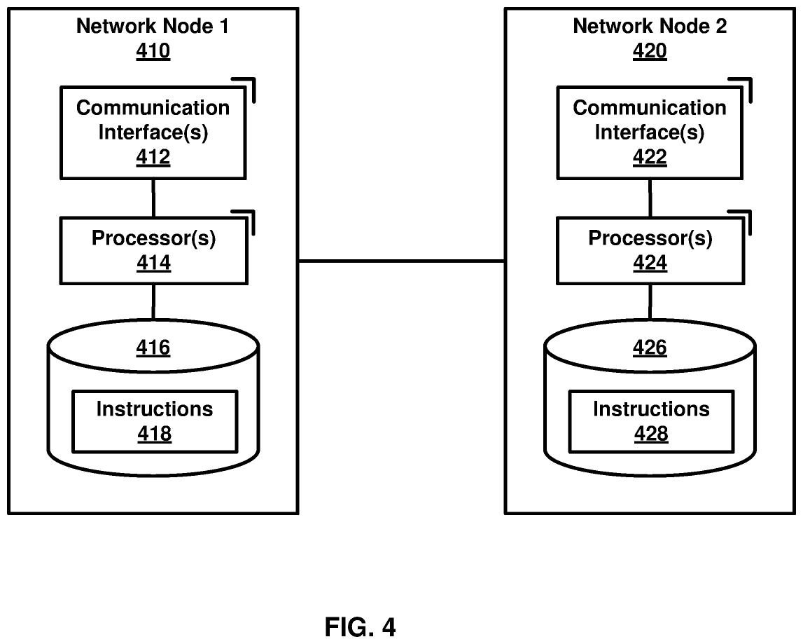

Throughout the present disclosure, AMF, LMC, LMF, UDM, OAM, GMLC, LCS client, NEF and AF are example network functions which may be implemented either as a network element on a (dedicated) hardware, and/or a network node as depicted FIG. 4, or as a software instance running on a (dedicated) hardware and/or shared hardware, or as a virtualized function instantiated on an appropriate platform.

The following acronyms are used throughout the present disclosure:

5G 5th generation mobile networks

5GC 5G Core Network

5GS 5G System

5G-AN 5G Access Network

5QI 5G QoS Indicator

ACK Acknowledgement

AF Application Function

A-GNSS Assisted GNSS

AMBR Aggregate Maximum Bit Rate

AMF Access and Mobility Management Function

AN Access Network

ANDSP Access Network Discovery & Selection Policy

APN Access Point Name

ARP Allocation and Retention Priority

BD Billing Domain

BPS Barometric Pressure Sensor

CCNF Common Control Network Functions

CDR Charging Data Record

CHF Charging Function

CIoT Cellular IoT

CN Core Network

CP Control Plane

C-V2X Cellular Vehicle-To-Everything

DAB Digital Audio Broadcasting

DDN Downlink Data Notification

DDoS Distributed Denial of Service

DL Downlink

DN Data Network

DN-AAA Data Network Authentication Authorization and Accounting

DNN Data Network Name

DTMB Digital Terrestrial Multimedia Broadcast

ECGI E-UTRAN Cell Global Identifier

ECID Enhanced Cell Identity

E-CSCF Emergency Call Session Control Function

eNodeB evolved Node B

EPS Evolved Packet System

E-UTRAN Evolved Universal Terrestrial Radio Access Network

FDD Frequency Division Duplex

FQDN Fully Qualified Domain Name

F-TEID Fully Qualified TED

GAD Geographical Area Description

GMLC Gateway Mobile Location Centre

gNB Next Generation Node B

gNB-CU-CP gNB Central Unit Control Plane

GNSS Global Navigation Satellite System

GPSI Generic Public Subscription Identifier

GTP GPRS Tunneling Protocol

GUTI Globally Unique Temporary Identifier

GWGateway

HGMLCHome GMLC

HTTP Hypertext Transfer Protocol

ID Identifier

IMEI International Mobile Equipment Identity

IMEI DB IMEI Database

IMS IP Multimedia Subsystem

IMSI International Mobile Subscriber Identity

IP Internet Protocol

IP-CAN IP Connectivity Access Network

L2 Layer 2 (data link layer)

L3 Layer 3 (network layer)

LADN Local Area Data Network

LAN local area network

LCS LoCation Services

LI Lawful Intercept

LMC Location Management Component

LMF Location Management Function

LPP LTE Positioning Protocol

LRF location retrieval function

MAC Media Access Control

MEI Mobile Equipment Identifier

MIB Master Information Block

MICO Mobile Initiated Connection Only

MME Mobility Management Entity

MO Mobile Originated

MO-LR Mobile Originated Location Request

MSISDN Mobile Subscriber ISDN

MT Mobile Terminating

MT-LR Mobile Terminated Location Request

N3IWF Non-3GPP InterWorking Function

NAI Network Access Identifier

NAS Non Access Stratum

NAT Network address translation

NB-IoT Narrow Band IoT

NCGI NR Cell Global Identity

NEF Network Exposure Function

NF Network Function

NGAP Next Generation Application Protocol

ng-eNB Next Generation eNB

NG-RAN NR Radio Access Network

NI-LR Network Induced Location Request

NR New Radio

NRF Network Repository Function

NRPPa New Radio Positioning Protocol A

NSI Network Slice Instance

NSSAI Network Slice Selection Assistance Information

NSSF Network Slice Selection Function

NWDAF Network Data Analytics Function

OAM Operation Administration and Maintenance

OCS Online Charging System

OFCS Offline Charging System

OTDOA Observed Time Difference of Arrival

PCC Policy and Charging Control

PCF Policy Control Function

PCRF Policy and Charging Rules Function

PDN Packet Data Network

PDU Packet Data Unit

PEI Permanent Equipment Identifier

PGW PDN Gateway

PLMN Public Land Mobile Network

ProSe Proximity-based Services

QFI QoS Flow Identifier

QoS Quality of Service

RM Registration Management

RA Random Access

RAN Radio Access Network

RAT Radio Access Technology

RRC Radio Resource Control

RM Registration Management

S1-AP S1 Application Protocol

SBA Service Based Architecture

SCM Security Context Management

SEA Security Anchor Function

SET SUPL Enabled Terminal

SGW Serving Gateway

SIB System Information Block

SLP SUPL Location Platform

SM Session Management

SMF Session Management Function

SMSF SMS Function

S-NSSAI Single Network Slice Selection Assistance information

SS Synchronization Signal

SSC Session and Service Continuity

SUCI Served User Correlation ID

SUPI Subscriber Permanent Identifier

SUPL Secure User Plane Location

TA Tracking Area

TM Tracking Area Identity

TBS Terrestrial Beacon System

TCP Transmission Control Protocol

TED Tunnel Endpoint Identifier

TMSI Temporary Mobile Subscriber Identity

TNAN Trusted Non-3GPP Access Network

TNGF Trusted Non3GPP Gateway

TRP Transmission and Reception Point

UCMF UE radio Capability Management Function

UDR Unified Data Repository

UDM Unified Data Management

UDP User Datagram Protocol

UE User Equipment

UL Uplink

UL CL Uplink Classifier

UPF User Plane Function

V2X Vehicle-To-Everything

WLAN Wireless Local Area Network

XML Extensible Markup Language

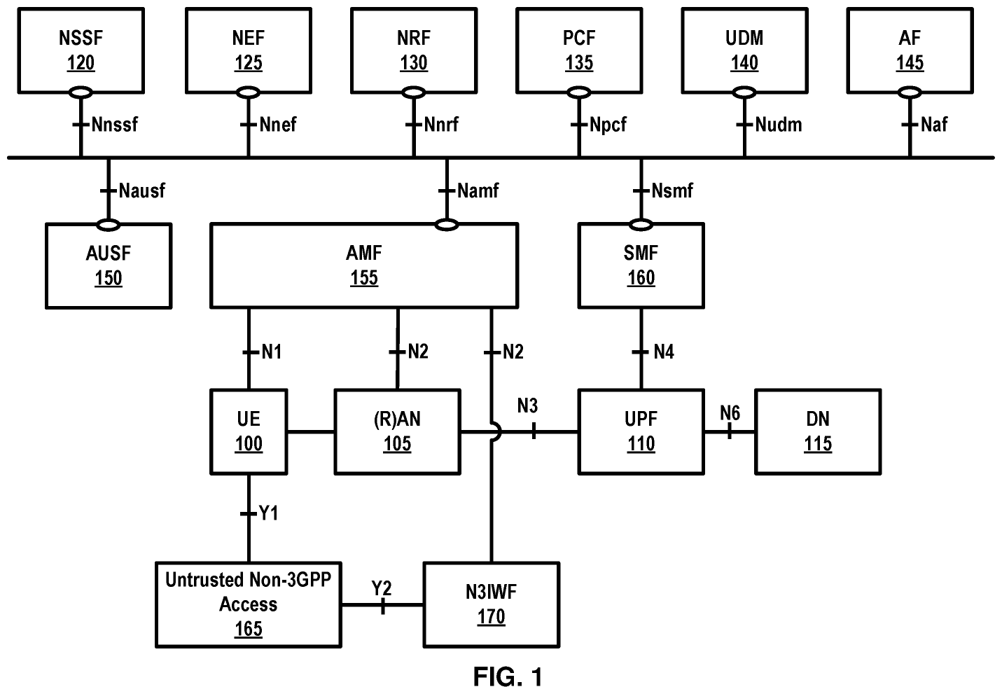

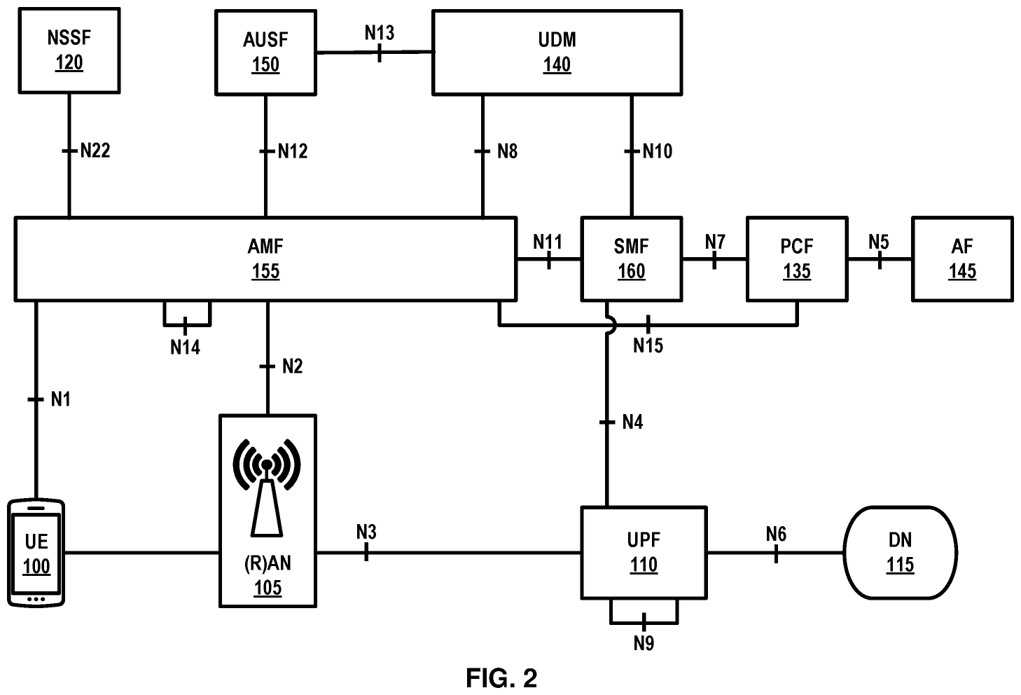

Example FIG. 1 and FIG. 2 depict a 5G system comprising of access networks and 5G core network. An example 5G access network may comprise an access network connecting to a 5G core network. An access network may comprise an NG-RAN 105 and/or non-3GPP AN 165. An example 5G core network may connect to one or more 5G access networks 5G-AN and/or NG-RANs. 5G core network may comprise functional elements or network functions as in example FIG. 1 and example FIG. 2 where interfaces may be employed for communication among the functional elements and/or network elements.

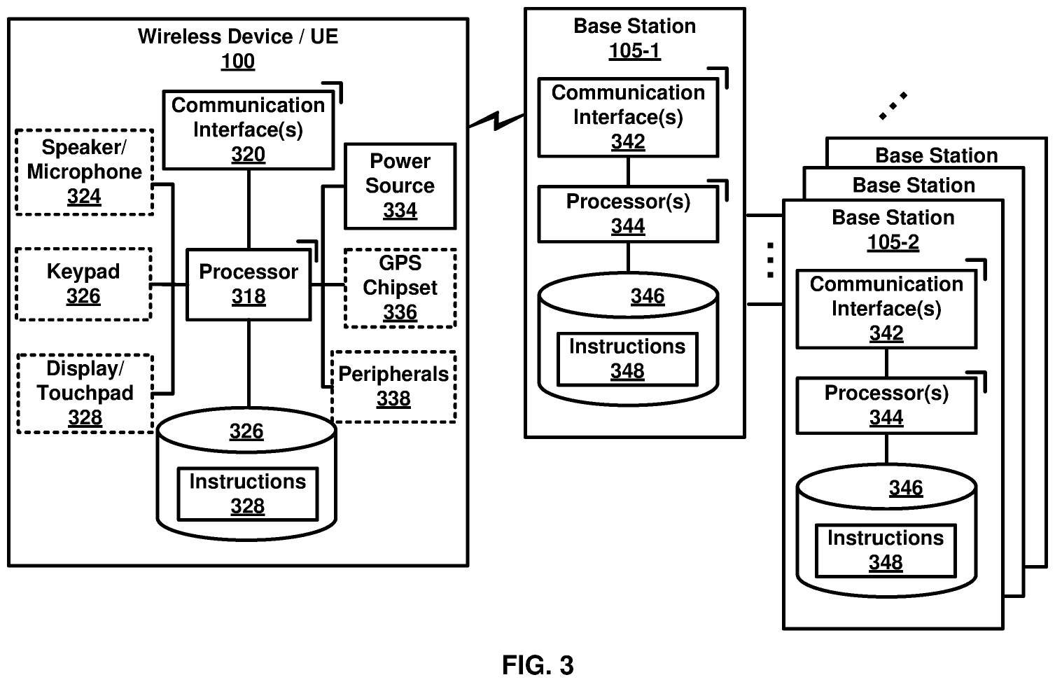

In an example, a network function may be a processing function in a network, which may have a functional behavior and/or interfaces. A network function may be implemented either as a network element on a dedicated hardware, and/or a network node as depicted in FIG. 3 and FIG. 4, or as a software instance running on a dedicated hardware and/or shared hardware, or as a virtualized function instantiated on an appropriate platform.

In an example, access and mobility management function, AMF 155, may include the following functionalities (some of the AMF 155 functionalities may be supported in a single instance of an AMF 155): termination of RAN 105 CP interface (N2), termination of NAS (N1), NAS ciphering and integrity protection, registration management, connection management, reachability management, mobility management, lawful intercept (for AMF 155 events and interface to LI system), provide transport for session management, SM messages between UE 100 and SMF 160, transparent proxy for routing SM messages, access authentication, access authorization, provide transport for SMS messages between UE 100 and SMSF, security anchor function, SEA, interaction with the AUSF 150 and the UE 100, receiving the intermediate key established as a result of the UE 100 authentication process, security context management, SCM, that receives a key from the SEA that it uses to derive access network specific keys, and/or the like.

In an example, the AMF 155 may support non-3GPP access networks through N2 interface with N3IWF 170, NAS signaling with a UE 100 over N3IWF 170, authentication of UEs connected over N3IWF 170, management of mobility, authentication, and separate security context state(s) of a UE 100 connected via non-3GPP access 165 or connected via 3GPP access 105 and non-3GPP access 165 simultaneously, support of a coordinated RM context valid over 3GPP access 105 and non 3GPP access 165, support of CM management contexts for the UE 100 for connectivity over non-3GPP access, and/or the like.

In an example, an AMF 155 region may comprise one or multiple AMF 155 sets. The AMF 155 set may comprise some AMF 155 that serve a given area and/or network slice(s). In an example, multiple AMF 155 sets may be per AMF 155 region and/or network slice(s). Application identifier may be an identifier that may be mapped to a specific application traffic detection rule. Configured NSSAI may be an NSSAI that may be provisioned in a UE 100. DN 115 access identifier (DNAI), for a DNN, may be an identifier of a user plane access to a DN 115. Initial registration may be related to a UE 100 registration in RM-DEREGISTERED 500, 520 states. N2AP UE 100 association may be a logical per UE 100 association between a 5G AN node and an AMF 155. N2AP UE-TNLA-binding may be a binding between a N2AP UE 100 association and a specific transport network layer, TNL association for a given UE 100.

In an example, session management function, SMF 160, may include one or more of the following functionalities (one or more of the SMF 160 functionalities may be supported in a single instance of a SMF 160): session management (e.g. session establishment, modify and release, including tunnel maintain between UPF 110 and AN 105 node), UE 100 IP address allocation & management (including optional authorization), selection and control of UP function(s), configuration of traffic steering at UPF 110 to route traffic to proper destination, termination of interfaces towards policy control functions, control part of policy enforcement and QoS. lawful intercept (for SM events and interface to LI System), termination of SM parts of NAS messages, downlink data notification, initiation of AN specific SM information, sent via AMF 155 over N2 to (R)AN 105, determination of SSC mode of a session, roaming functionality, handling local enforcement to apply QoS SLAB (VPLMN), charging data collection and charging interface (VPLMN), lawful intercept (in VPLMN for SM events and interface to LI System), support for interaction with external DN 115 for transport of signaling for PDU session authorization/authentication by external DN 115, and/or the like.

In an example, a user plane function, UPF 110, may include one or more of the following functionalities (some of the UPF 110 functionalities may be supported in a single instance of a UPF 110): anchor point for Intra-/Inter-RAT mobility (when applicable), external PDU session point of interconnect to DN 115, packet routing & forwarding, packet inspection and user plane part of policy rule enforcement, lawful intercept (UP collection), traffic usage reporting, uplink classifier to support routing traffic flows to a data network, branching point to support multi-homed PDU session(s), QoS handling for user plane, uplink traffic verification (SDF to QoS flow mapping), transport level packet marking in the uplink and downlink, downlink packet buffering, downlink data notification triggering, and/or the like.

In an example, the UE 100 IP address management may include allocation and release of the UE 100 IP address and/or renewal of the allocated IP address. The UE 100 may set a requested PDU type during a PDU session establishment procedure based on its IP stack capabilities and/or configuration. In an example, the SMF 160 may select PDU type of a PDU session. In an example, if the SMF 160 receives a request with PDU type set to IP, the SMF 160 may select PDU type IPv4 or IPv6 based on DNN configuration and/or operator policies. In an example, the SMF 160 may provide a cause value to the UE 100 to indicate whether the other IP version is supported on the DNN. In an example, if the SMF 160 receives a request for PDU type IPv4 or IPv6 and the requested IP version is supported by the DNN the SMF 160 may select the requested PDU type.

In an example embodiment, the 5GC elements and UE 100 may support the following mechanisms: during a PDU session establishment procedure, the SMF 160 may send the IP address to the UE 100 via SM NAS signaling. The IPv4 address allocation and/or IPv4 parameter configuration via DHCPv4 may be employed once PDU session may be established. IPv6 prefix allocation may be supported via IPv6 stateless autoconfiguration, if IPv6 is supported. In an example, 5GC network elements may support IPv6 parameter configuration via stateless DHCPv6.

The 5GC may support the allocation of a static IPv4 address and/or a static IPv6 prefix based on subscription information in a UDM 140 and/or based on the configuration on a per-subscriber, per-DNN basis.

User plane function(s) (UPF 110) may handle the user plane path of PDU sessions. A UPF 110 that provides the interface to a data network may support functionality of a PDU session anchor.

In an example, a policy control function, PCF 135, may support unified policy framework to govern network behavior, provide policy rules to control plane function(s) to enforce policy rules, implement a front end to access subscription information relevant for policy decisions in a user data repository (UDR), and/or the like.

A network exposure function, NEF 125, may provide means to securely expose the services and capabilities provided by the 3GPP network functions, translate between information exchanged with the AF 145 and information exchanged with the internal network functions, receive information from other network functions, and/or the like.

In an example, an network repository function, NRF 130 may support service discovery function that may receive NF discovery request from NF instance, provide information about the discovered NF instances (be discovered) to the NF instance, and maintain information about available NF instances and their supported services, and/or the like.

In an example, an NSSF 120 may select a set of network slice instances serving the UE 100, may determine allowed NSSAI. In an example, the NSSF 120 may determine the AMF 155 set to be employed to serve the UE 100, and/or, based on configuration, determine a list of candidate AMF 155(s) 155 by querying the NRF 130.

In an example, stored data in a UDR may include at least user subscription data, including at least subscription identifiers, security credentials, access and mobility related subscription data, session related subscription data, policy data, and/or the like.

In an example, an AUSF 150 may support authentication server function (AUSF 150).

In an example, an application function, AF 145, may interact with the 3GPP core network to provide services. In an example, based on operator deployment, application functions may be trusted by the operator to interact directly with relevant network functions. Application functions not allowed by the operator to access directly the network functions may use an external exposure framework (e.g., via the NEF 125) to interact with relevant network functions.

In an example, control plane interface between the (R)AN 105 and the 5G core may support connection of multiple different kinds of AN(s) (e.g. 3GPP RAN 105, N3IWF 170 for Un-trusted access 165) to the 5GC via a control plane protocol. In an example, an N2 AP protocol may be employed for both the 3GPP access 105 and non-3GPP access 165. In an example, control plane interface between the (R)AN 105 and the 5G core may support decoupling between AMF 155 and other functions such as SMF 160 that may need to control the services supported by AN(s) (e.g. control of the UP resources in the 105 for a PDU session).

In an example, the 5GC may provide policy information from the PCF 135 to the UE 100. In an example, the policy information may comprise: access network discovery and selection policy, UE 100 route selection policy (URSP), SSC mode selection policy (SSCMSP), network slice selection policy (NSSP), DNN selection policy, non-seamless offload policy, and/or the like.

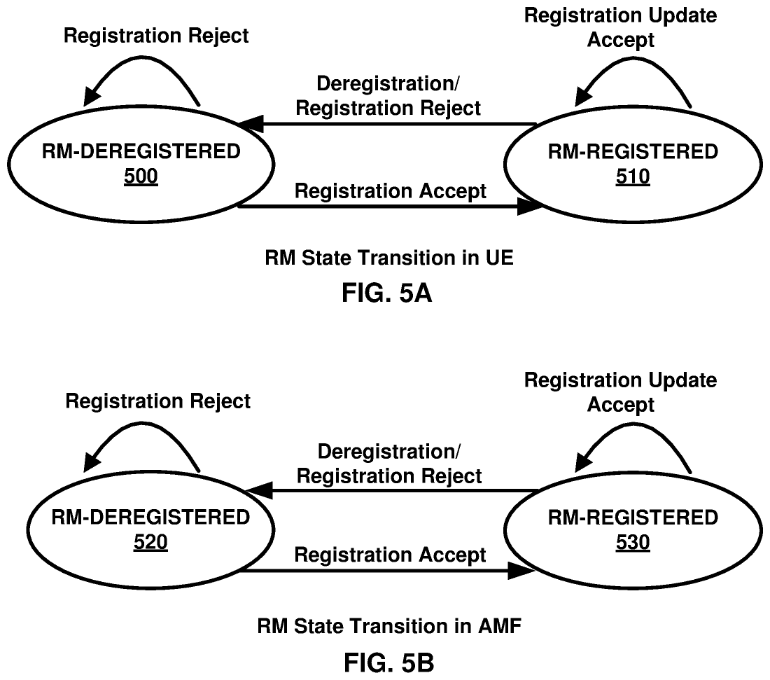

In an example, as depicted in example FIG. 5A and FIG. 5B, the registration management, RM may be employed to register or de-register a UE/user 100 with the network, and establish the user context in the network. Connection management may be employed to establish and release the signaling connection between the UE 100 and the AMF 155.

In an example, a UE 100 may register with the network to receive services that require registration. In an example, the UE 100 may update its registration with the network periodically in order to remain reachable (periodic registration update), or upon mobility (e.g., mobility registration update), or to update its capabilities or to re-negotiate protocol parameters.

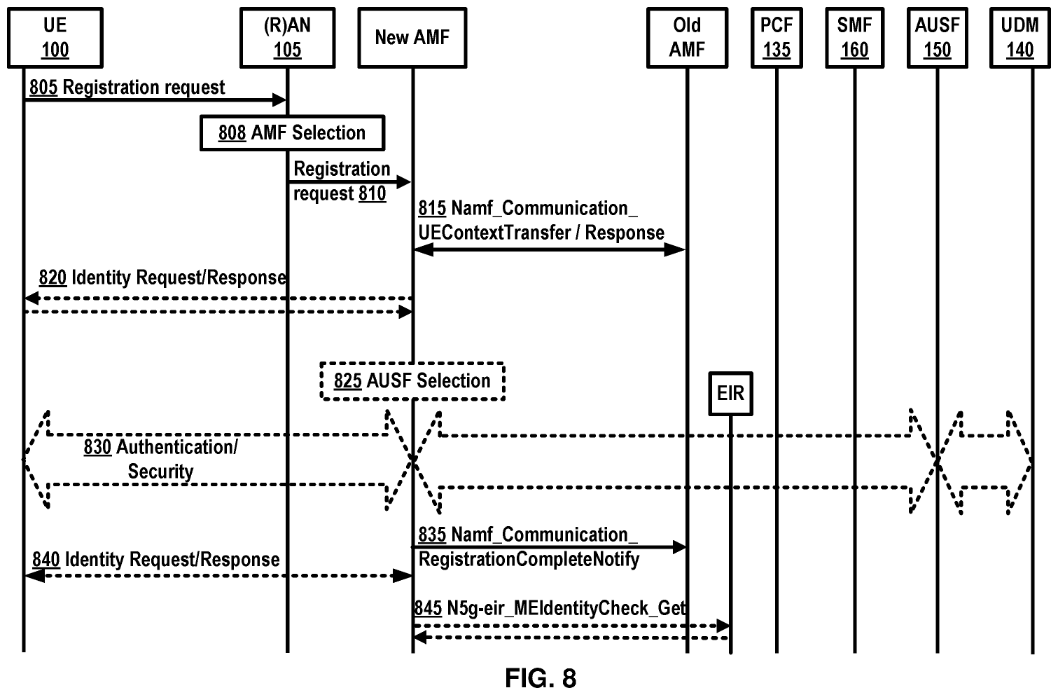

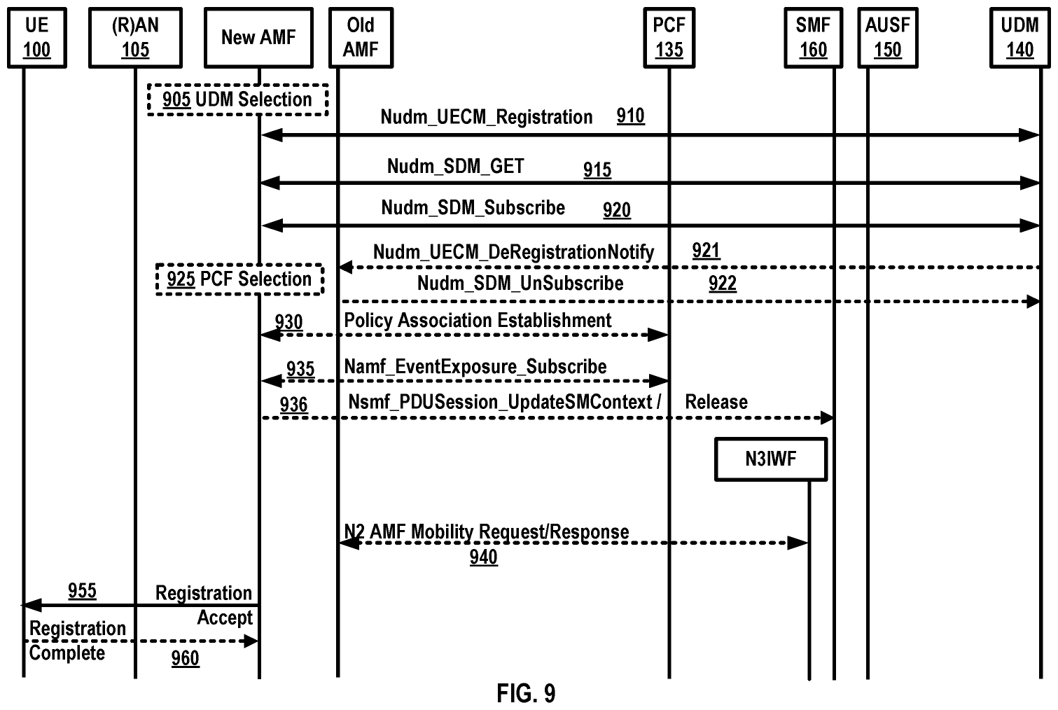

In an example, an initial registration procedure as depicted in example FIG. 8 and FIG. 9 may involve execution of network access control functions (e.g. user authentication and access authorization based on subscription profiles in UDM 140). Example FIG. 9 is a continuation of the initial registration procedure depicted in FIG. 8. As a result of the initial registration procedure, the identity of the serving AMF 155 may be registered in a UDM 140.

In an example, the registration management, RM procedures may be applicable over both 3GPP access 105 and non 3GPP access 165.

An example FIG. 5A may depict the RM states of a UE 100 as observed by the UE 100 and AMF 155. In an example embodiment, two RM states may be employed in the UE 100 and the AMF 155 that may reflect the registration status of the UE 100 in the selected PLMN: RM-DEREGISTERED 500, and RM-REGISTERED 510. In an example, in the RM DEREGISTERED state 500, the UE 100 may not be registered with the network. The UE 100 context in the AMF 155 may not hold valid location or routing information for the UE 100 so the UE 100 may not be reachable by the AMF 155. In an example, the UE 100 context may be stored in the UE 100 and the AMF 155. In an example, in the RM REGISTERED state 510, the UE 100 may be registered with the network. In the RM-REGISTERED 510 state, the UE 100 may receive services that may require registration with the network.

In an example embodiment, two RM states may be employed in AMF 155 for the UE 100 that may reflect the registration status of the UE 100 in the selected PLMN: RM-DEREGISTERED 520, and RM-REGISTERED 530.

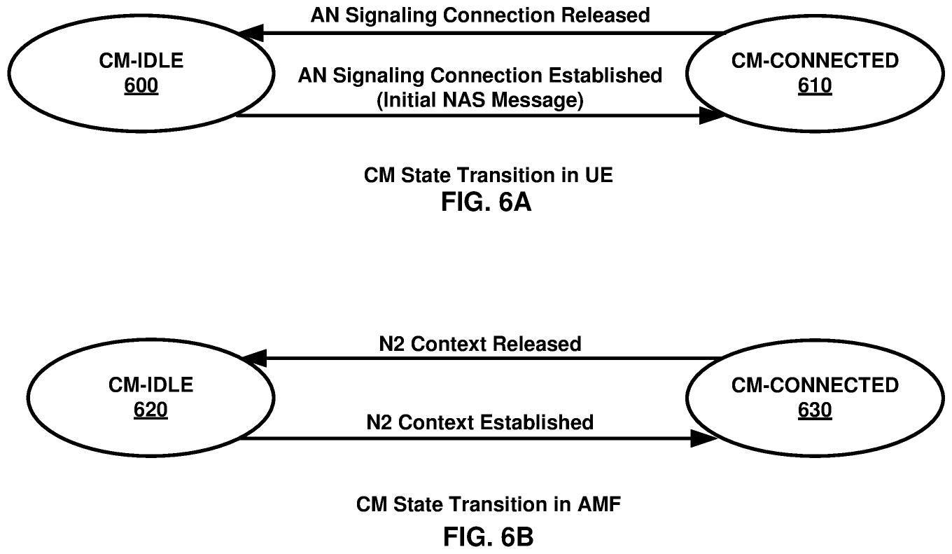

As depicted in example FIG. 6A and FIG. 6B, connection management, CM, may comprise establishing and releasing a signaling connection between a UE 100 and an AMF 155 over N1 interface. The signaling connection may be employed to enable NAS signaling exchange between the UE 100 and the core network. The signaling connection between the UE 100 and the AMF 155 may comprise both the signaling connection between the UE 100 and the (R)AN 105 (e.g. RRC connection over 3GPP access) and the N2 connection for the UE 100 between the and the AMF 155.

As depicted in example FIG. 6A and FIG. 6B, two CM states may be employed for the NAS signaling connectivity of the UE 100 with the AMF 155, CM-IDLE 600, 620 and CM-CONNECTED 610, 630. A UE 100 in CM-IDLE 600 state may be in RM-REGISTERED 510 state and may have no NAS signaling connection established with the AMF 155 over N1. The UE 100 may perform cell selection, cell reselection, PLMN selection, and/or the like. A UE 100 in CM-CONNECTED 610 state may have a NAS signaling connection with the AMF 155 over N1.

In an example embodiment two CM states may be employed for the UE 100 at the AMF 155, CM-IDLE 620 and CM-CONNECTED 630.

In an example, an RRC inactive state may apply to NG-RAN (e.g. it may apply to NR and E-UTRA connected to 5G CN). The AMF 155, based on network configuration, may provide assistance information to the NG RAN 105, to assist the NG RAN's 105 decision whether the UE 100 may be sent to RRC inactive state. When a UE 100 is CM-CONNECTED 610 with RRC inactive state, the UE 100 may resume the RRC connection due to uplink data pending, mobile initiated signaling procedure, as a response to RAN 105 paging, to notify the network that it has left the RAN 105 notification area, and/or the like.

In an example, a NAS signaling connection management may include establishing and releasing a NAS signaling connection. A NAS signaling connection establishment function may be provided by the UE 100 and the AMF 155 to establish the NAS signaling connection for the UE 100 in CM-IDLE 600 state. The procedure of releasing the NAS signaling connection may be initiated by the 5G (R)AN 105 node or the AMF 155.

In an example, reachability management of a UE 100 may detect whether the UE 100 is reachable and may provide the UE 100 location (e.g. access node) to the network to reach the UE 100. Reachability management may be done by paging the UE 100 and the UE 100 location tracking. The UE 100 location tracking may include both UE 100 registration area tracking and UE 100 reachability tracking. The UE 100 and the AMF 155 may negotiate UE 100 reachability characteristics in CM-IDLE 600, 620 state during registration and registration update procedures.

In an example, two UE 100 reachability categories may be negotiated between a UE 100 and an AMF 155 for CM-IDLE 600, 620 state. 1) UE 100 reachability allowing mobile device terminated data while the UE 100 is CM-IDLE 600 mode. 2) Mobile initiated connection only (MICO) mode. The 5GC may support a PDU connectivity service that provides exchange of PDUs between the UE 100 and a data network identified by a DNN. The PDU connectivity service may be supported via PDU sessions that are established upon request from the UE 100.

In an example, a PDU session may support one or more PDU session types. PDU sessions may be established (e.g. upon UE 100 request), modified (e.g. upon UE 100 and 5GC request) and/or released (e.g. upon UE 100 and 5GC request) using NAS SM signaling exchanged over N1 between the UE 100 and the SMF 160. Upon request from an application server (AS), the 5GC may be able to trigger a specific application in the UE 100. When receiving the trigger, the UE 100 may send it to the identified application in the UE 100. The identified application in the UE 100 may establish a PDU session to a specific DNN.

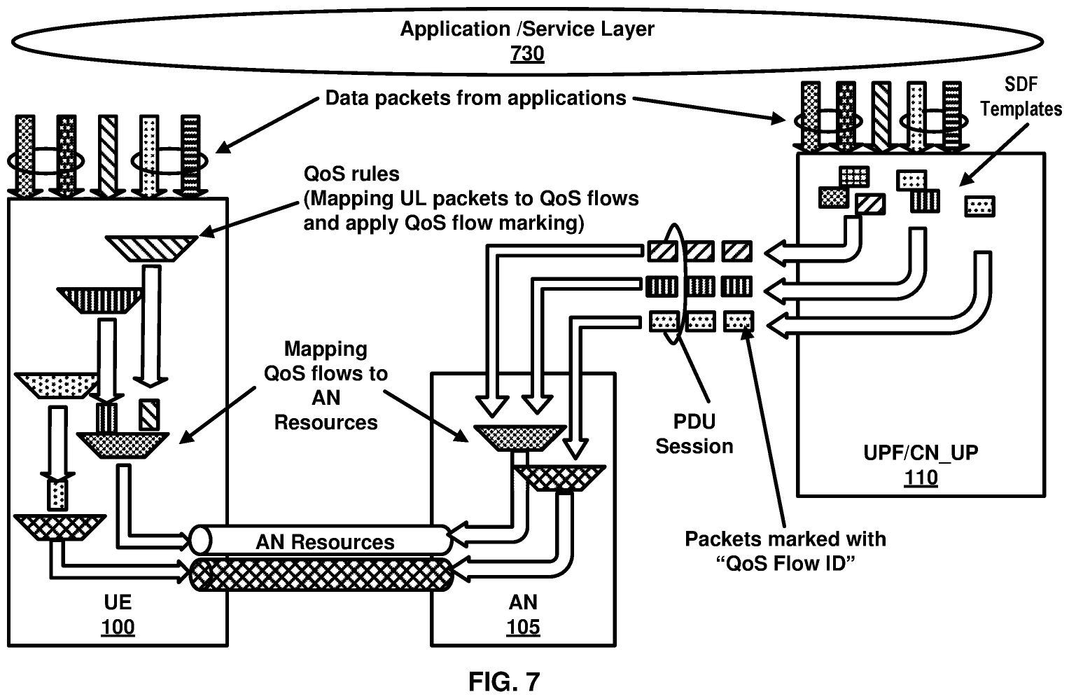

In an example, the 5G QoS model may support a QoS flow based framework as depicted in example FIG. 7. The 5G QoS model may support both QoS flows that require a guaranteed flow bit rate and QoS flows that may not require a guaranteed flow bit rate. In an example, the 5G QoS model may support reflective QoS. The QoS model may comprise flow mapping or packet marking at the UPF 110 (CN_UP) 110, AN 105 and/or the UE 100. In an example, packets may arrive from and/or destined to the application/service layer 730 of UE 100, UPF 110 (CN_UP) 110, and/or the AF 145.

In an example, the QoS flow may be a granularity of QoS differentiation in a PDU session. A QoS flow ID, QFI, may be employed to identify the QoS flow in the 5G system. In an example, user plane traffic with the same QFI within a PDU session may receive the same traffic forwarding treatment. The QFI may be carried in an encapsulation header on N3 and/or N9 (e.g. without any changes to the end-to-end packet header). In an example, the QFI may be applied to PDUs with different types of payload. The QFI may be unique within a PDU session.

In an example, the QoS parameters of a QoS flow may be provided to the (R)AN 105 as a QoS profile over N2 at PDU session establishment, QoS flow establishment, or when NG-RAN is used at every time the user plane is activated. In an example, a default QoS rule may be required for every PDU session. The SMF 160 may allocate the QFI for a QoS flow and may derive QoS parameters from the information provided by the PCF 135. In an example, the SMF 160 may provide the QFI together with the QoS profile containing the QoS parameters of a QoS flow to the (R)AN 105.

In an example, 5G QoS flow may be a granularity for QoS forwarding treatment in the 5G system. Traffic mapped to the same 5G QoS flow may receive the same forwarding treatment (e.g. scheduling policy, queue management policy, rate shaping policy, RLC configuration, and/or the like). In an example, providing different QoS forwarding treatment may require separate 5G QoS flows.

In an example, a 5G QoS indicator may be a scalar that may be employed as a reference to a specific QoS forwarding behavior (e.g. packet loss rate, packet delay budget) to be provided to a 5G QoS flow. In an example, the 5G QoS indicator may be implemented in the access network by the 5QI referencing node specific parameters that may control the QoS forwarding treatment (e.g. scheduling weights, admission thresholds, queue management thresholds, link layer protocol configuration, and/or the like.).

In an example, 5GC may support edge computing and may enable operator(s) and 3rd party services to be hosted close to the UE's access point of attachment. The 5G core network may select a UPF 110 close to the UE 100 and may execute the traffic steering from the UPF 110 to the local data network via a N6 interface. In an example, the selection and traffic steering may be based on the UE's 100 subscription data, UE 100 location, the information from application function AF 145, policy, other related traffic rules, and/or the like. In an example, the 5G core network may expose network information and capabilities to an edge computing application function. The functionality support for edge computing may include local routing where the 5G core network may select a UPF 110 to route the user traffic to the local data network, traffic steering where the 5G core network may select the traffic to be routed to the applications in the local data network, session and service continuity to enable UE 100 and application mobility, user plane selection and reselection, e.g. based on input from application function, network capability exposure where 5G core network and application function may provide information to each other via NEf 125, QoS and charging where PCF 135 may provide rules for QoS control and charging for the traffic routed to the local data network, support of local area data network where 5G core network may provide support to connect to the LADN in a certain area where the applications are deployed, and/or the like.

An example 5G system may be a 3GPP system comprising of 5G access network 105, 5G core network and a UE 100, and/or the like. Allowed NSSAI may be an NSSAI provided by a serving PLMN during e.g. a registration procedure, indicating the NSSAI allowed by the network for the UE 100 in the serving PLMN for the current registration area.

In an example, a PDU connectivity service may provide exchange of PDUs between a UE 100 and a data network. A PDU session may be an association between the UE 100 and the data network, DN 115, that may provide the PDU connectivity service. The type of association may be IP, Ethernet and/or unstructured.

Establishment of user plane connectivity to a data network via network slice instance(s) may comprise the following: performing a RM procedure to select an AMF 155 that supports the required network slices, and establishing one or more PDU session(s) to the required data network via the network slice instance(s).

In an example, the set of network slices for a UE 100 may be changed at any time while the UE 100 may be registered with the network, and may be initiated by the network, or the UE 100.

In an example, a periodic registration update may be UE 100 re-registration at expiry of a periodic registration timer. A requested NSSAI may be a NSSAI that the UE 100 may provide to the network.

In an example, a service based interface may represent how a set of services may be provided/exposed by a given NF.

In an example, a service continuity may be an uninterrupted user experience of a service, including the cases where the IP address and/or anchoring point may change. In an example, a session continuity may refer to continuity of a PDU session. For PDU session of IP type session continuity may imply that the IP address is preserved for the lifetime of the PDU session. An uplink classifier may be a UPF 110 functionality that aims at diverting uplink traffic, based on filter rules provided by the SMF 160, towards data network, DN 115.

In an example, the 5G system architecture may support data connectivity and services enabling deployments to use techniques such as e.g. network function virtualization and/or software defined networking. The 5G system architecture may leverage service-based interactions between control plane (CP) network functions where identified. In 5G system architecture, separation of the user plane (UP) functions from the control plane functions may be considered. A 5G system may enable a network function to interact with other NF(s) directly if required.

In an example, the 5G system may reduce dependencies between the access network (AN) and the core network (CN). The architecture may comprise a converged access-agnostic core network with a common AN-CN interface which may integrate different 3GPP and non-3GPP access types.

In an example, the 5G system may support a unified authentication framework, stateless NFs, where the compute resource is decoupled from the storage resource, capability exposure, and concurrent access to local and centralized services. To support low latency services and access to local data networks, UP functions may be deployed close to the access network.

In an example, the 5G system may support roaming with home routed traffic and/or local breakout traffic in the visited PLMN. An example 5G architecture may be service-based and the interaction between network functions may be represented in two ways. (1) As service-based representation (depicted in example FIG. 1), where network functions within the control plane, may enable other authorized network functions to access their services. This representation may also include point-to-point reference points where necessary. (2) Reference point representation, showing the interaction between the NF services in the network functions described by point-to-point reference point (e.g. N11) between any two network functions.

In an example, a network slice may comprise the core network control plane and user plane network functions, the 5G Radio Access Network; the N3IWF functions to the non-3GPP Access Network, and/or the like. Network slices may differ for supported features and network function implementation. The operator may deploy multiple network slice instances delivering the same features but for different groups of UEs, e.g. as they deliver a different committed service and/or because they may be dedicated to a customer. The NSSF 120 may store the mapping information between slice instance ID and NF ID (or NF address).

In an example, a UE 100 may simultaneously be served by one or more network slice instances via a 5G-AN. In an example, the UE 100 may be served by k network slices (e.g. k=8, 16, etc) at a time. An AMF 155 instance serving the UE 100 logically may belong to a network slice instance serving the UE 100.

In an example, a PDU session may belong to one specific network slice instance per PLMN. In an example, different network slice instances may not share a PDU session. Different slices may have slice-specific PDU sessions using the same DNN.

An S-NSSAI (Single Network Slice Selection Assistance information) may identify a network slice. An S-NSSAI may comprise a slice/service type (SST), which may refer to the expected network slice behavior in terms of features and services; and/or a slice differentiator (SD). A slice differentiator may be optional information that may complement the slice/service type(s) to allow further differentiation for selecting a network slice instance from potentially multiple network slice instances that comply with the indicated slice/service type. In an example, the same network slice instance may be selected employing different S-NSSAIs. The CN part of a network slice instance(s) serving a UE 100 may be selected by CN.

In an example, subscription data may include the S-NSSAI(s) of the network slices that the UE 100 subscribes to. One or more S-NSSAIs may be marked as default S-NSSAI. In an example, k S-NSSAI may be marked default S-NSSAI (e.g. k=8, 16, etc.). In an example, the UE 100 may subscribe to more than 8 S-NSSAIs.

In an example, a UE 100 may be configured by the HPLMN with a configured NSSAI per PLMN. Upon successful completion of a UE's registration procedure, the UE 100 may obtain from the AMF 155 an Allowed NSSAI for this PLMN, which may include one or more S-NSSAIs.

In an example, the Allowed NSSAI may take precedence over the configured NSSAI for a PLMN. The UE 100 may use the S-NSSAIs in the allowed NSSAI corresponding to a network slice for the subsequent network slice selection related procedures in the serving PLMN.

In an example, the establishment of user plane connectivity to a data network via a network slice instance(s) may comprise: performing a RM procedure to select an AMF 155 that may support the required network slices, establishing one or more PDU sessions to the required data network via the network slice instance(s), and/or the like.

In an example, when a UE 100 registers with a PLMN, if the UE 100 for the PLMN has a configured NSSAI or an allowed NSSAI, the UE 100 may provide to the network in RRC and NAS layer a requested NSSAI comprising the S-NSSAI(s) corresponding to the slice(s) to which the UE 100 attempts to register, a temporary user ID if one was assigned to the UE, and/or the like. The requested NSSAI may be configured-NSSAI, allowed-NSSAI, and/or the like.

In an example, when a UE 100 registers with a PLMN, if for the PLMN the UE 100 has no configured NSSAI or allowed NSSAI, the RAN 105 may route NAS signaling from/to the UE 100 to/from a default AMF 155.

In an example, the network, based on local policies, subscription changes and/or UE 100 mobility, may change the set of permitted network slice(s) to which the UE 100 is registered. In an example, the network may perform the change during a registration procedure or trigger a notification towards the UE 100 of the change of the supported network slices using an RM procedure (which may trigger a registration procedure). The network may provide the UE 100 with a new allowed NSSAI and tracking area list.

In an example, during a registration procedure in a PLMN, in case the network decides that the UE 100 should be served by a different AMF 155 based on network slice(s) aspects, the AMF 155 that first received the registration request may redirect the registration request to another AMF 155 via the RAN 105 or via direct signaling between the initial AMF 155 and the target AMF 155.

In an example, the network operator may provision the UE 100 with network slice selection policy (NSSP). The NSSP may comprise one or more NSSP rules.

In an example, if a UE 100 has one or more PDU sessions established corresponding to the a specific S-NSSAI, the UE 100 may route the user data of the application in one of the PDU sessions, unless other conditions in the UE 100 may prohibit the use of the PDU sessions. If the application provides a DNN, then the UE 100 may consider the DNN to determine which PDU session to use. In an example, if the UE 100 does not have a PDU session established with the specific S-NSSAI, the UE 100 may request a new PDU session corresponding to the S-NSSAI and with the DNN that may be provided by the application. In an example, in order for the RAN 105 to select a proper resource for supporting network slicing in the RAN 105, the RAN 105 may be aware of the network slices used by the UE 100.

In an example, an AMF 155 may select an SMF 160 in a network slice instance based on S-NSSAI, DNN and/or other information e.g. UE 100 subscription and local operator policies, and/or the like, when the UE 100 triggers the establishment of a PDU session. The selected SMF 160 may establish the PDU session based on S-NSSAI and DNN.

In an example, in order to support network-controlled privacy of slice information for the slices the UE 100 may access, when the UE 100 is aware or configured that privacy considerations may apply to NSSAI, the UE 100 may not include NSSAI in NAS signaling unless the UE 100 has a NAS security context and the UE 100 may not include NSSAI in unprotected RRC signaling.

In an example, for roaming scenarios, the network slice specific network functions in VPLMN and HPLMN may be selected based on the S-NSSAI provided by the UE 100 during PDU connection establishment. If a standardized S-NSSAI is used, selection of slice specific NF instances may be done by each PLMN based on the provided S-NSSAI. In an example, the VPLMN may map the S-NSSAI of HPLMN to a S-NSSAI of VPLMN based on roaming agreement (e.g., including mapping to a default S-NSSAI of VPLMN). In an example, the selection of slice specific NF instance in VPLMN may be done based on the S-NSSAI of VPLMN. In an example, the selection of any slice specific NF instance in HPLMN may be based on the S-NSSAI of HPLMN.

As depicted in example FIG. 8 and FIG. 9, a registration procedure may be performed by the UE 100 to get authorized to receive services, to enable mobility tracking, to enable reachability, and/or the like.

In an example, the UE 100 may send to the (R)AN 105 an AN message 805 (comprising AN parameters, RM-NAS registration request (registration type, SUCI or SUPI or 5G-GUTI, last visited TAI (if available), security parameters, requested NSSAI, mapping of requested NSSAI, UE 100 5GC capability, PDU session status, PDU session(s) to be re-activated, Follow on request, MICO mode preference, and/or the like), and/or the like). In an example, in case of NG-RAN, the parameters may include e.g. SUCI or SUPI or the 5G-GUTI, the Selected PLMN ID and requested NSSAI, and/or the like. In an example, the parameters may comprise establishment cause. The establishment cause may provide the reason for requesting the establishment of an RRC connection. In an example, the registration type may indicate if the UE 100 wants to perform an initial registration (i.e. the UE 100 is in RM-DEREGISTERED state), a mobility registration update (e.g., the UE 100 is in RM-REGISTERED state and initiates a registration procedure due to mobility), a periodic registration update (e.g., the UE 100 is in RM-REGISTERED state and may initiate a registration procedure due to the periodic registration update timer expiry) or an emergency registration (e.g., the UE 100 is in limited service state). In an example, if the UE 100 performing an initial registration (i.e., the UE 100 is in RM-DEREGISTERED state) to a PLMN for which the UE 100 does not already have a 5G-GUTI, the UE 100 may include its SUCI or SUPI in the registration request. The SUCI may be included if the home network has provisioned the public key to protect SUPI in the UE. If the UE 100 received a UE 100 configuration update command indicating that the UE 100 needs to re-register and the 5G-GUTI is invalid, the UE 100 may perform an initial registration and may include the SUPI in the registration request message. For an emergency registration, the SUPI may be included if the UE 100 does not have a valid 5G-GUTI available; the PEI may be included when the UE 100 has no SUPI and no valid 5G-GUTI. In other cases, the 5G-GUTI may be included and it may indicate the last serving AMF 155. If the UE 100 is already registered via a non-3GPP access in a PLMN different from the new PLMN (e.g., not the registered PLMN or an equivalent PLMN of the registered PLMN) of the 3GPP access, the UE 100 may not provide over the 3GPP access the 5G-GUTI allocated by the AMF 155 during the registration procedure over the non-3GPP access. If the UE 100 is already registered via a 3GPP access in a PLMN (e.g., the registered PLMN), different from the new PLMN (i.e. not the registered PLMN or an equivalent PLMN of the registered PLMN) of the non-3GPP access, the UE 100 may not provide over the non-3GPP access the 5G-GUTI allocated by the AMF 155 during the registration procedure over the 3GPP access. The UE 100 may provide the UE's usage setting based on its configuration. In case of initial registration or mobility registration update, the UE 100 may include the mapping of requested NSSAI, which may be the mapping of each S-NSSAI of the requested NSSAI to the S-NSSAIs of the configured NSSAI for the HPLMN, to ensure that the network is able to verify whether the S-NSSAI(s) in the requested NSSAI are permitted based on the subscribed S-NSSAIs. If available, the last visited TAI may be included in order to help the AMF 155 produce registration area for the UE. In an example, the security parameters may be used for authentication and integrity protection. requested NSSAI may indicate the network slice selection assistance information. The PDU session status may indicates the previously established PDU sessions in the UE. When the UE 100 is connected to the two AMF 155 belonging to different PLMN via 3GPP access and non-3GPP access then the PDU session status may indicate the established PDU session of the current PLMN in the UE. The PDU session(s) to be re-activated may be included to indicate the PDU session(s) for which the UE 100 may intend to activate UP connections. A PDU session corresponding to a LADN may not be included in the PDU session(s) to be re-activated when the UE 100 is outside the area of availability of the LADN. The follow on request may be included when the UE 100 may have pending uplink signaling and the UE 100 may not include PDU session(s) to be re-activated, or the registration type may indicate the UE 100 may want to perform an emergency registration.

In an example, if a SUPI is included or the 5G-GUTI does not indicate a valid AMF 155, the (R)AN 105, based on (R)AT and requested NSSAI, if available, may selects 808 an AMF 155. If UE 100 is in CM-CONNECTED state, the (R)AN 105 may forward the registration request message to the AMF 155 based on the N2 connection of the UE. If the (R)AN 105 may not select an appropriate AMF 155, it may forward the registration request to an AMF 155 which has been configured, in (R)AN 105, to perform AMF 155 selection 808.

In an example, the (R)AN 105 may send to the new AMF 155 an N2 message 810 (comprising: N2 parameters, RM-NAS registration request (registration type, SUPI or 5G-GUTI, last visited TAI (if available), security parameters, requested NSSAI, mapping of requested NSSAI, UE 100 5GC capability, PDU session status, PDU session(s) to be re-activated, follow on request, and MICO mode preference), and/or the like). In an example, when NG-RAN is used, the N2 parameters may comprise the selected PLMN ID, location information, cell identity and the RAT type related to the cell in which the UE 100 is camping. In an example, when NG-RAN is used, the N2 parameters may include the establishment cause.

In an example, the new AMF 155 may send to the old AMF 155 an Namf_Communication_UEContextTransfer (complete registration request) 815. In an example, if the UE's 5G-GUTI was included in the registration request and the serving AMF 155 has changed since last registration procedure, the new AMF 155 may invoke the Namf_Communication_UEContextTransfer service operation 815 on the old AMF 155 including the complete registration request IE, which may be integrity protected, to request the UE's SUPI and MM Context. The old AMF 155 may use the integrity protected complete registration request IE to verify if the context transfer service operation invocation corresponds to the UE 100 requested. In an example, the old AMF 155 may transfer the event subscriptions information by each NF consumer, for the UE, to the new AMF 155. In an example, if the UE 100 identifies itself with PEI, the SUPI request may be skipped.

In an example, the old AMF 155 may send to new AMF 155 a response 815 to Namf_Communication_UEContextTransfer (SUPI, MM context, SMF 160 information, PCF ID). In an example, the old AMF 155 may respond to the new AMF 155 for the Namf_Communication_UEContextTransfer invocation by including the UE's SUPI and MM context. In an example, if old AMF 155 holds information about established PDU sessions, the old AMF 155 may include SMF 160 information including S-NSSAI(s), SMF 160 identities and PDU session ID. In an example, if old AMF 155 holds information about active NGAP UE-TNLA bindings to N3IWF, the old AMF 155 may include information about the NGAP UE-TNLA bindings.

In an example, if the SUPI is not provided by the UE 100 nor retrieved from the old AMF 155 the identity request procedure 820 may be initiated by the AMF 155 sending an identity request message to the UE 100 requesting the SUCI.

In an example, the UE 100 may respond with an identity response message 820 including the SUCI. The UE 100 may derive the SUCI by using the provisioned public key of the HPLMN.

In an example, the AMF 155 may decide to initiate UE 100 authentication 825 by invoking an AUSF 150. The AMF 155 may select an AUSF 150 based on SUPI or SUCI. In an example, if the AMF 155 is configured to support emergency registration for unauthenticated SUPIs and the UE 100 indicated registration type emergency registration the AMF 155 may skip the authentication and security setup or the AMF 155 may accept that the authentication may fail and may continue the registration procedure.

In an example, the authentication 830 may be performed by Nudm_UEAuthenticate_Get operation. The AUSF 150 may discover a UDM 140. In case the AMF 155 provided a SUCI to AUSF 150, the AUSF 150 may return the SUPI to AMF 155 after the authentication is successful. In an example, if network slicing is used, the AMF 155 may decide if the registration request needs to be rerouted where the initial AMF 155 refers to the AMF 155. In an example, the AMF 155 may initiate NAS security functions. In an example, upon completion of NAS security function setup, the AMF 155 may initiate NGAP procedure to enable 5G-AN use it for securing procedures with the UE. In an example, the 5G-AN may store the security context and may acknowledge to the AMF 155. The 5G-AN may use the security context to protect the messages exchanged with the UE.

In an example, new AMF 155 may send to the old AMF 155 Namf_Communication_RegistrationCompleteNotify 835. If the AMF 155 has changed, the new AMF 155 may notify the old AMF 155 that the registration of the UE 100 in the new AMF 155 may be completed by invoking the Namf_Communication_RegistrationCompleteNotify service operation. If the authentication/security procedure fails, then the registration may be rejected, and the new AMF 155 may invoke the Namf_Communication_RegistrationCompleteNotify service operation with a reject indication reason code towards the old AMF 155. The old AMF 155 may continue as if the UE 100 context transfer service operation was never received. If one or more of the S-NSSAIs used in the old registration area may not be served in the target registration area, the new AMF 155 may determine which PDU session may not be supported in the new registration area. The new AMF 155 may invoke the Namf_Communication_RegistrationCompleteNotify service operation including the rejected PDU session ID and a reject cause (e.g. the S-NSSAI becomes no longer available) towards the old AMF 155. The new AMF 155 may modify the PDU session status correspondingly. The old AMF 155 may inform the corresponding SMF 160(s) to locally release the UE's SM context by invoking the Nsmf_PDUSession_ReleaseSMContext service operation.

In an example, the new AMF 155 may send to the UE 100 an identity request/response 840 (e.g., PEI). If the PEI was not provided by the UE 100 nor retrieved from the old AMF 155, the identity request procedure may be initiated by AMF 155 sending an identity request message to the UE 100 to retrieve the PEI. The PEI may be transferred encrypted unless the UE 100 performs emergency registration and may not be authenticated. For an emergency registration, the UE 100 may have included the PEI in the registration request.

In an example, the new AMF 155 may initiate ME identity check 845 by invoking the N5g-eir_EquipmentIdentityCheck_Get service operation 845.

In an example, the new AMF 155, based on the SUPI, may select 905 a UDM 140. The UDM 140 may select a UDR instance. In an example, the AMF 155 may select a UDM 140.

In an example, if the AMF 155 has changed since the last registration procedure, or if the UE 100 provides a SUPI which may not refer to a valid context in the AMF 155, or if the UE 100 registers to the same AMF 155 it has already registered to a non-3GPP access (e.g., the UE 100 is registered over a non-3GPP access and may initiate the registration procedure to add a 3GPP access), the new AMF 155 may register with the UDM 140 using Nudm_UECM_Registration 910 and may subscribe to be notified when the UDM 140 may deregister the AMF 155. The UDM 140 may store the AMF 155 identity associated to the access type and may not remove the AMF 155 identity associated to the other access type. The UDM 140 may store information provided at registration in UDR, by Nudr_UDM_Update. In an example, the AMF 155 may retrieve the access and mobility subscription data and SMF 160 selection subscription data using Nudm_SDM_Get 915. The UDM 140 may retrieve this information from UDR by Nudr_UDM_Query (access and mobility subscription data). After a successful response is received, the AMF 155 may subscribe to be notified using Nudm_SDM_Subscribe 920 when the data requested may be modified. The UDM 140 may subscribe to UDR by Nudr_UDM_Subscribe. The GPSI may be provided to the AMF 155 in the subscription data from the UDM 140 if the GPSI is available in the UE 100 subscription data. In an example, the new AMF 155 may provide the access type it serves for the UE 100 to the UDM 140 and the access type may be set to 3GPP access. The UDM 140 may store the associated access type together with the serving AMF 155 in UDR by Nudr_UDM_Update. The new AMF 155 may create an MM context for the UE 100 after getting the mobility subscription data from the UDM 140. In an example, when the UDM 140 stores the associated access type together with the serving AMF 155, the UDM 140 may initiate a Nudm_UECM_DeregistrationNotification 921 to the old AMF 155 corresponding to 3GPP access. The old AMF 155 may remove the MM context of the UE. If the serving NF removal reason indicated by the UDM 140 is initial registration, then the old AMF 155 may invoke the Namf_EventExposure_Notify service operation towards all the associated SMF 160s of the UE 100 to notify that the UE 100 is deregistered from old AMF 155. The SMF 160 may release the PDU session(s) on getting this notification. In an example, the old AMF 155 may unsubscribe with the UDM 140 for subscription data using Nudm_SDM_unsubscribe 922.

In an example, if the AMF 155 decides to initiate PCF 135 communication, e.g. the AMF 155 has not yet obtained access and mobility policy for the UE 100 or if the access and mobility policy in the AMF 155 are no longer valid, the AMF 155 may select 925 a PCF 135. If the new AMF 155 receives a PCF ID from the old AMF 155 and successfully contacts the PCF 135 identified by the PCF ID, the AMF 155 may select the (V-)PCF identified by the PCF ID. If the PCF 135 identified by the PCF ID may not be used (e.g. no response from the PCF 135) or if there is no PCF ID received from the old AMF 155, the AMF 155 may select 925 a PCF 135.

In an example, the new AMF 155 may perform a policy association establishment 930 during registration procedure. If the new AMF 155 contacts the PCF 135 identified by the (V-)PCF ID received during inter-AMF 155 mobility, the new AMF 155 may include the PCF-ID in the Npcf_AMPolicyControl Get operation. If the AMF 155 notifies the mobility restrictions (e.g. UE 100 location) to the PCF 135 for adjustment, or if the PCF 135 updates the mobility restrictions itself due to some conditions (e.g. application in use, time and date), the PCF 135 may provide the updated mobility restrictions to the AMF 155.

In an example, the PCF 135 may invoke Namf_EventExposure_Subscribe service operation 935 for UE 100 event subscription.

In an example, the AMF 155 may send to the SMF 160 a Nsmf_PDUSession_UpdateSMContext 936. In an example, the AMF 155 may invoke the Nsmf_PDUSession_UpdateSMContext if the PDU session(s) to be re-activated is included in the registration request. The AMF 155 may send Nsmf_PDUSession_UpdateSMContext request to SMF 160(s) associated with the PDU session(s) to activate user plane connections of the PDU session(s). The SMF 160 may decide to trigger e.g. the intermediate UPF 110 insertion, removal or change of PSA. In the case that the intermediate UPF 110 insertion, removal, or relocation is performed for the PDU session(s) not included in PDU session(s) to be re-activated, the procedure may be performed without N11 and N2 interactions to update the N3 user plane between (R)AN 105 and 5GC. The AMF 155 may invoke the Nsmf_PDUSession_ReleaseSMContext service operation towards the SMF 160 if any PDU session status indicates that it is released at the UE 100. The AMF 155 may invoke the Nsmf_PDUSession_ReleaseSMContext service operation towards the SMF 160 in order to release any network resources related to the PDU session.

In an example, the new AMF 155155 may send to a N3IWF an N2 AMF 155 mobility request 940. If the AMF 155 has changed, the new AMF 155 may create an NGAP UE 100 association towards the N3IWF to which the UE 100 is connected. In an example, the N3IWF may respond to the new AMF 155 with an N2 AMF 155 mobility response 940.

In an example, the new AMF 155 may send to the UE 100 a registration accept 955 (comprising: 5G-GUTI, registration area, mobility restrictions, PDU session status, allowed NSSAI, [mapping of allowed NSSAI], periodic registration update timer, LADN information and accepted MICO mode, IMS voice over PS session supported indication, emergency service support indicator, and/or the like). In an example, the AMF 155 may send the registration accept message to the UE 100 indicating that the registration request has been accepted. 5G-GUTI may be included if the AMF 155 allocates a new 5G-GUTI. If the AMF 155 allocates a new registration area, it may send the registration area to the UE 100 via registration accept message 955. If there is no registration area included in the registration accept message, the UE 100 may consider the old registration area as valid. In an example, mobility restrictions may be included in case mobility restrictions may apply for the UE 100 and registration type may not be emergency registration. The AMF 155 may indicate the established PDU sessions to the UE 100 in the PDU session status. The UE 100 may remove locally any internal resources related to PDU sessions that are not marked as established in the received PDU session status. In an example, when the UE 100 is connected to the two AMF 155 belonging to different PLMN via 3GPP access and non-3GPP access then the UE 100 may remove locally any internal resources related to the PDU session of the current PLMN that are not marked as established in received PDU session status. If the PDU session status information was in the registration request, the AMF 155 may indicate the PDU session status to the UE. The mapping of allowed NSSAI may be the mapping of each S-NSSAI of the allowed NSSAI to the S-NSSAIs of the configured NSSAI for the HPLMN. The AMF 155 may include in the registration accept message 955 the LADN information for LADNs that are available within the registration area determined by the AMF 155 for the UE. If the UE 100 included MICO mode in the request, then AMF 155 may respond whether MICO mode may be used. The AMF 155 may set the IMS voice over PS session supported Indication. In an example, in order to set the IMS voice over PS session supported indication, the AMF 155 may perform a UE/RAN radio information and compatibility request procedure to check the compatibility of the UE 100 and RAN radio capabilities related to IMS voice over PS. In an example, the emergency service support indicator may inform the UE 100 that emergency services are supported, e.g., the UE 100 may request PDU session for emergency services. In an example, the handover restriction list and UE-AMBR may be provided to NG-RAN by the AMF 155.

In an example, the UE 100 may send to the new AMF 155 a registration complete 960 message. In an example, the UE 100 may send the registration complete message 960 to the AMF 155 to acknowledge that a new 5G-GUTI may be assigned. In an example, when information about the PDU session(s) to be re-activated is not included in the registration request, the AMF 155 may release the signaling connection with the UE 100. In an example, when the follow-on request is included in the registration request, the AMF 155 may not release the signaling connection after the completion of the registration procedure. In an example, if the AMF 155 is aware that some signaling is pending in the AMF 155 or between the UE 100 and the 5GC, the AMF 155 may not release the signaling connection after the completion of the registration procedure.

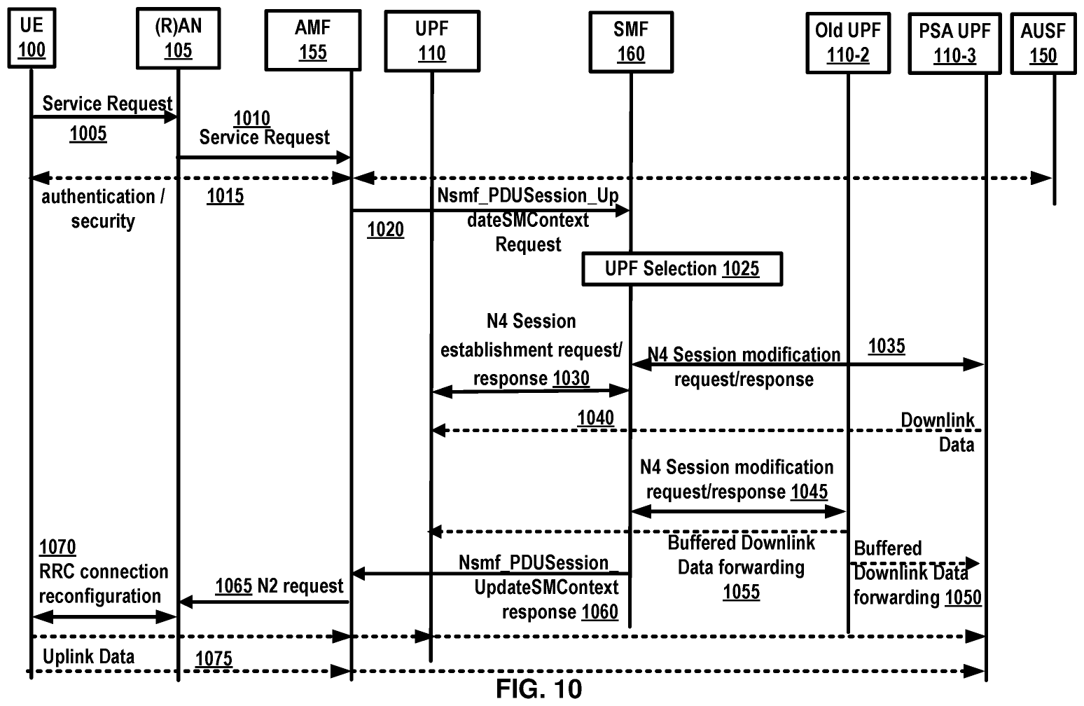

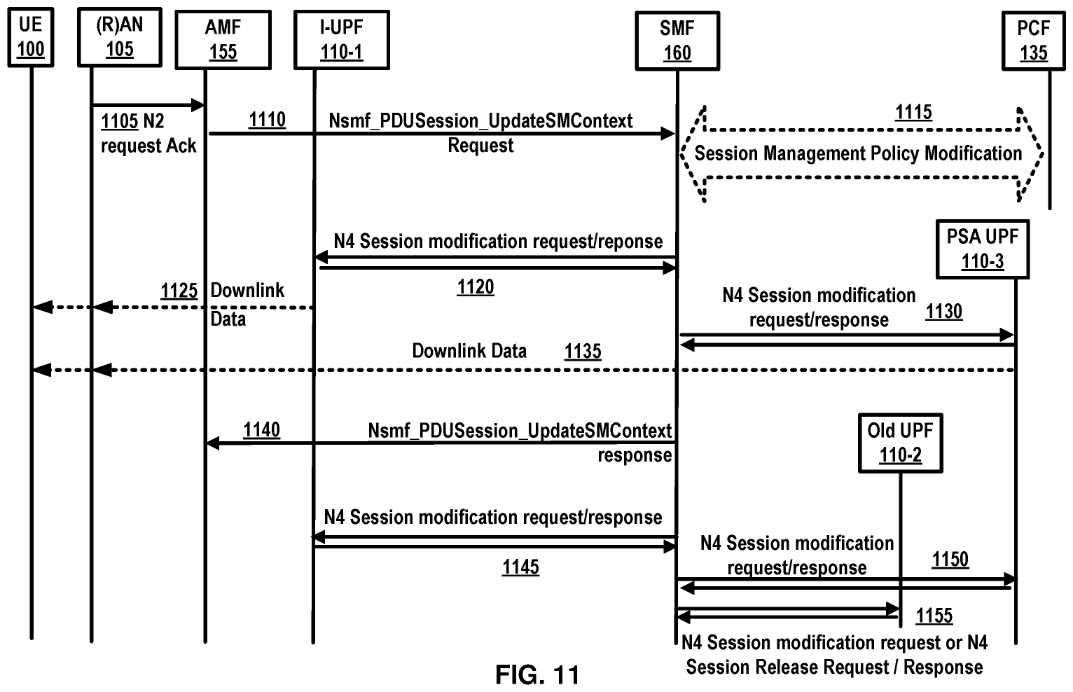

As depicted in example FIG. 10 and FIG. 11, a service request procedure e.g., a UE 100 triggered service request procedure may be used by a UE 100 in CM-IDLE state to request the establishment of a secure connection to an AMF 155. FIG. 11 is continuation of FIG. 10 depicting the service request procedure. The service request procedure may be used to activate a user plane connection for an established PDU session. The service request procedure may be triggered by the UE 100 or the 5GC, and may be used when the UE 100 is in CM-IDLE and/or in CM-CONNECTED and may allow selectively to activate user plane connections for some of the established PDU sessions.

In an example, a UE 100 in CM IDLE state may initiate the service request procedure to send uplink signaling messages, user data, and/or the like, as a response to a network paging request, and/or the like. In an example, after receiving the service request message, the AMF 155 may perform authentication. In an example, after the establishment of signaling connection to the AMF 155, the UE 100 or network may send signaling messages, e.g. PDU session establishment from the UE 100 to a SMF 160, via the AMF 155.

In an example, for any service request, the AMF 155 may respond with a service accept message to synchronize PDU session status between the UE 100 and network. The AMF 155 may respond with a service reject message to the UE 100, if the service request may not be accepted by the network. The service reject message may include an indication or cause code requesting the UE 100 to perform a registration update procedure. In an example, for service request due to user data, network may take further actions if user plane connection activation may not be successful. In an example FIG. 10 and FIG. 11, more than one UPF, e.g., old UPF 110-2 and PDU session Anchor PSA UPF 110-3 may be involved.

In an example, the UE 100 may send to a (R)AN 105 an AN message comprising AN parameters, mobility management, MM NAS service request 1005 (e.g., list of PDU sessions to be activated, list of allowed PDU sessions, security parameters, PDU session status, and/or the like), and/or the like. In an example, the UE 100 may provide the list of PDU sessions to be activated when the UE 100 may re-activate the PDU session(s). The list of allowed PDU sessions may be provided by the UE 100 when the service request may be a response of a paging or a NAS notification, and may identify the PDU sessions that may be transferred or associated to the access on which the service request may be sent. In an example, for the case of NG-RAN, the parameters may include selected PLMN ID, and an establishment cause. The establishment cause may provide the reason for requesting the establishment of an RRC connection. The UE 100 may send NAS service request message towards the AMF 155 encapsulated in an RRC message to the RAN 105.

In an example, if the service request may be triggered for user data, the UE 100 may identify, using the list of PDU sessions to be activated, the PDU session(s) for which the UP connections are to be activated in the NAS service request message. If the service request may be triggered for signaling, the UE 100 may not identify any PDU session(s). If this procedure may be triggered for paging response, and/or the UE 100 may have at the same time user data to be transferred, the UE 100 may identify the PDU session(s) whose UP connections may be activated in MM NAS service request message, by the list of PDU sessions to be activated.

In an example, if the service request over 3GPP access may be triggered in response to a paging indicating non-3GPP access, the NAS service request message may identify in the list of allowed PDU sessions the list of PDU sessions associated with the non-3GPP access that may be re-activated over 3GPP. In an example, the PDU session status may indicate the PDU sessions available in the UE 100. In an example, the UE 100 may not trigger the service request procedure for a PDU session corresponding to a LADN when the UE 100 may be outside the area of availability of the LADN. The UE 100 may not identify such PDU session(s) in the list of PDU sessions to be activated, if the service request may be triggered for other reasons.

In an example, the (R)AN 105 may send to AMF 155 an N2 Message 1010 (e.g., a service request) comprising N2 parameters, MM NAS service request, and/or the like. The AMF 155 may reject the N2 message if it may not be able to handle the service request. In an example, if NG-RAN may be used, the N2 parameters may include the 5G-GUTI, selected PLMN ID, location information, RAT type, establishment cause, and/or the like. In an example, the 5G-GUTI may be obtained in RRC procedure and the (R)AN 105 may select the AMF 155 according to the 5G-GUTI. In an example, the location information and RAT type may relate to the cell in which the UE 100 may be camping. In an example, based on the PDU session status, the AMF 155 may initiate PDU session release procedure in the network for the PDU sessions whose PDU session ID(s) may be indicated by the UE 100 as not available.

In an example, if the service request was not sent integrity protected or integrity protection verification failed, the AMF 155 may initiate a NAS authentication/security procedure 1015.

In an example, if the UE 100 triggers the service request to establish a signaling connection, upon successful establishment of the signaling connection, the UE 100 and the network may exchange NAS signaling.

In an example the AMF 155 may send to the SMF 160 a PDU session update context request 1020 e.g., Nsmf_PDUSession_UpdateSMContext request comprising PDU session ID(s), Cause(s), UE 100 location information, access type, and/or the like.

In an example, the Nsmf_PDUSession_UpdateSMContext request may be invoked by the AMF 155 if the UE 100 may identify PDU session(s) to be activated in the NAS service request message. In an example, the Nsmf_PDUSession_UpdateSMContext request may be triggered by the SMF 160 wherein the PDU session(s) identified by the UE 100 may correlate to other PDU session ID(s) than the one triggering the procedure. In an example, the Nsmf_PDUSession_UpdateSMContext request may be triggered by the SMF 160 wherein the current UE 100 location may be outside the area of validity for the N2 information provided by the SMF 160 during a network triggered service request procedure. The AMF 155 may not send the N2 information provided by the SMF 160 during the network triggered service request procedure.

In an example, the AMF 155 may determine the PDU session(s) to be activated and may send an Nsmf_PDUSession_UpdateSMContext request to SMF 160(s) associated with the PDU session(s) with cause set to indicate establishment of user plane resources for the PDU session(s).

In an example, if the procedure may be triggered in response to paging indicating non-3GPP access, and the list of allowed PDU sessions provided by the UE 100 may not include the PDU session for which the UE 100 was paged, the AMF 155 may notify the SMF 160 that the user plane for the PDU session may not be re-activated. The service request procedure may succeed without re-activating the user plane of any PDU sessions, and the AMF 155 may notify the UE 100.

In an example, if the PDU session ID may correspond to a LADN and the SMF 160 may determine that the UE 100 may be outside the area of availability of the LADN based on the UE 100 location reporting from the AMF 155, the SMF 160 may decide to (based on local policies) keep the PDU session, may reject the activation of user plane connection for the PDU session and may inform the AMF 155. In an example, if the procedure may be triggered by a network triggered service request, the SMF 160 may notify the UPF 110 that originated the data notification to discard downlink data for the PDU sessions and/or to not provide further data notification messages. The SMF 160 may respond to the AMF 155 with an appropriate reject cause and the user plane activation of PDU session may be stopped.

In an example, if the PDU session ID may correspond to a LADN and the SMF 160 may determine that the UE 100 may be outside the area of availability of the LADN based on the UE 100 location reporting from the AMF 155, the SMF 160 may decide to (based on local policies) release the PDU session. The SMF 160 may locally release the PDU session and may inform the AMF 155 that the PDU session may be released. The SMF 160 may respond to the AMF 155 with an appropriate reject cause and the user plane Activation of PDU session may be stopped.

In an example, if the UP activation of the PDU session may be accepted by the SMF 160, based on the location info received from the AMF 155, the SMF 160 may check the UPF 110 Selection 1025 Criteria (e.g., slice isolation requirements, slice coexistence requirements, UPF's 110 dynamic load, UPF's 110 relative static capacity among UPFs supporting the same DNN, UPF 110 location available at the SMF 160, UE 100 location information, Capability of the UPF 110 and the functionality required for the particular UE 100 session. In an example, an appropriate UPF 110 may be selected by matching the functionality and features required for a UE 100, DNN, PDU session type (i.e. IPv4, IPv6, ethernet type or unstructured type) and if applicable, the static IP address/prefix, SSC mode selected for the PDU session, UE 100 subscription profile in UDM 140, DNAI as included in the PCC rules, local operator policies, S-NSSAI, access technology being used by the UE 100, UPF 110 logical topology, and/or the like), and may determine to perform one or more of the following: continue using the current UPF(s); may select a new intermediate UPF 110 (or add/remove an intermediate UPF 110), if the UE 100 has moved out of the service area of the UPF 110 that was previously connecting to the (R)AN 105, while maintaining the UPF(s) acting as PDU session anchor; may trigger re-establishment of the PDU session to perform relocation/reallocation of the UPF 110 acting as PDU session anchor, e.g. the UE 100 has moved out of the service area of thechor UPF 110 which is connecting to RAN 105.

In an example, the SMF 160 may send to the UPF 110 (e.g., new intermediate UPF 110) an N4 session establishment request 1030. In an example, if the SMF 160 may select a new UPF 110 to act as intermediate UPF 110-2 for the PDU session, or if the SMF 160 may select to insert an intermediate UPF 110 for a PDU session which may not have an intermediate UPF 110-2, an N4 session establishment request 1030 message may be sent to the new UPF 110, providing packet detection, data forwarding, enforcement and reporting rules to be installed on the new intermediate UPF. The PDU session anchor addressing information (on N9) for this PDU session may be provided to the intermediate UPF 110-2.

In an example, if a new UPF 110 is selected by the SMF 160 to replace the old (intermediate) UPF 110-2, the SMF 160 may include a data forwarding indication. The data forwarding indication may indicate to the UPF 110 that a second tunnel endpoint may be reserved for buffered DL data from the old I-UPF.

In an example, the new UPF 110 (intermediate) may send to SMF 160 an N4 session establishment response message 1030. In case the UPF 110 may allocate CN tunnel info, the UPF 110 may provide DL CN tunnel info for the UPF 110 acting as PDU session anchor and UL CN tunnel info (e.g., CN N3 tunnel info) to the SMF 160. If the data forwarding indication may be received, the new (intermediate) UPF 110 acting as N3 terminating point may send DL CN tunnel info for the old (intermediate) UPF 110-2 to the SMF 160. The SMF 160 may start a timer, to release the resource in the old intermediate UPF 110-2.

In an example, if the SMF 160 may selects a new intermediate UPF 110 for the PDU session or may remove the old I-UPF 110-2, the SMF 160 may send N4 session modification request message 1035 to PDU session anchor, PSA UPF 110-3, providing the data forwarding indication and DL tunnel information from new intermediate UPF 110.

In an example, if the new intermediate UPF 110 may be added for the PDU session, the (PSA) UPF 110-3 may begin to send the DL data to the new I-UPF 110 as indicated in the DL tunnel information.

In an example, if the service request may be triggered by the network, and the SMF 160 may remove the old I-UPF 110-2 and may not replace the old I-UPF 110-2 with the new I-UPF 110, the SMF 160 may include the data forwarding indication in the request. The data forwarding indication may indicate to the (PSA) UPF 110-3 that a second tunnel endpoint may be reserved for buffered DL data from the old I-UPF 110-2. In this case, the PSA UPF 110-3 may begin to buffer the DL data it may receive at the same time from the N6 interface.

In an example, the PSA UPF 110-3 (PSA) may send to the SMF 160 an N4 session modification response 1035. In an example, if the data forwarding indication may be received, the PSA UPF 110-3 may become as N3 terminating point and may send CN DL tunnel info for the old (intermediate) UPF 110-2 to the SMF 160. The SMF 160 may start a timer, to release the resource in old intermediate UPF 110-2 if there is one.

In an example, the SMF 160 may send to the old UPF 110-2 an N4 session modification request 1045 (e.g., may comprise new UPF 110 address, new UPF 110 DL tunnel ID, and/or the like). In an example, if the service request may be triggered by the network, and/or the SMF 160 may remove the old (intermediate) UPF 110-2, the SMF 160 may send the N4 session modification request message to the old (intermediate) UPF 110-2, and may provide the DL tunnel information for the buffered DL data. If the SMF 160 may allocate new I-UPF 110, the DL tunnel information is from the new (intermediate) UPF 110 may act as N3 terminating point. If the SMF 160 may not allocate a new I-UPF 110, the DL tunnel information may be from the new UPF 110 (PSA) 110-3 acting as N3 terminating point. The SMF 160 may start a timer to monitor the forwarding tunnel. In an example, the old (intermediate) UPF 110-2 may send N4 session modification response message to the SMF 160.

In an example, if the I-UPF 110-2 may be relocated and forwarding tunnel was established to the new I-UPF 110, the old (intermediate) UPF 110-2 may forward its buffered data to the new (intermediate) UPF 110 acting as N3 terminating point. In an example, if the old I-UPF 110-2 may be removed and the new I-UPF 110 may not be assigned for the PDU session and forwarding tunnel may be established to the UPF 110 (PSA) 110-3, the old (intermediate) UPF 110-2 may forward its buffered data to the UPF 110 (PSA) 110-3 acting as N3 terminating point.

In an example, the SMF 160 may send to the AMF 155 an N11 message 1060 e.g., a Nsmf_PDUSession_UpdateSMContext response (comprising: N1 SM container (PDU session ID, PDU session re-establishment indication), N2 SM information (PDU session ID, QoS profile, CN N3 tunnel info, S-NSSAI), Cause), upon reception of the Nsmf_PDUSession_UpdateSMContext request with a cause including e.g., establishment of user plane resources. The SMF 160 may determine whether UPF 110 reallocation may be performed, based on the UE 100 location information, UPF 110 service area and operator policies. In an example, for a PDU session that the SMF 160 may determine to be served by the current UPF 110, e.g., PDU session anchor or intermediate UPF, the SMF 160 may generate N2 SM information and may send an Nsmf_PDUSession_UpdateSMContext response 1060 to the AMF 155 to establish the user plane(s). The N2 SM information may contain information that the AMF 155 may provide to the RAN 105. In an example, for a PDU session that the SMF 160 may determine as requiring a UPF 110 relocation for PDU session anchor UPF, the SMF 160 may reject the activation of UP of the PDU session by sending Nsmf_PDUSession_UpdateSMContext response that may contain N1 SM container to the UE 100 via the AMF 155. The N1 SM container may include the corresponding PDU session ID and PDU session re-establishment indication.

Upon reception of the Namf_EventExposure_Notify from the AMF 155 to the SMF 160, with an indication that the UE 100 is reachable, if the SMF 160 may have pending DL data, the SMF 160 may invoke the Namf_Communication_N1N2MessageTransfer service operation to the AMF 155 to establish the user plane(s) for the PDU sessions. In an example, the SMF 160 may resume sending DL data notifications to the AMF 155 in case of DL data.

In an example, the SMF 160 may send a message to the AMF 155 to reject the activation of UP of the PDU session by including a cause in the Nsmf_PDUSession_UpdateSMContext response if the PDU session may correspond to a LADN and the UE 100 may be outside the area of availability of the LADN, or if the AMF 155 may notify the SMF 160 that the UE 100 may be reachable for regulatory prioritized service, and the PDU session to be activated may not for a regulatory prioritized service; or if the SMF 160 may decide to perform PSA UPF 110-3 relocation for the requested PDU session.

In an example, the AMF 155 may send to the (R)AN 105 an N2 request message 1065 (e.g., N2 SM information received from SMF 160, security context, AMF 155 signaling connection ID, handover restriction list, MM NAS service accept, list of recommended cells/TAs/NG-RAN node identifiers). In an example, the RAN 105 may store the security context, AMF 155 signaling connection Id, QoS information for the QoS flows of the PDU sessions that may be activated and N3 tunnel IDs in the UE 100 RAN 105 context. In an example, the MM NAS service accept may include PDU session status in the AMF 155. If the activation of UP of a PDU session may be rejected by the SMF 160, the MM NAS service accept may include the PDU session ID and the reason why the user plane resources may not be activated (e.g. LADN not available). Local PDU session release during the session request procedure may be indicated to the UE 100 via the session Status.

In an example, if there are multiple PDU sessions that may involve multiple SMF 160s, the AMF 155 may not wait for responses from all SMF 160s before it may send N2 SM information to the UE 100. The AMF 155 may wait for all responses from the SMF 160s before it may send MM NAS service accept message to the UE 100.

In an example, the AMF 155 may include at least one N2 SM information from the SMF 160 if the procedure may be triggered for PDU session user plane activation. AMF 155 may send additional N2 SM information from SMF 160s in separate N2 message(s) (e.g. N2 tunnel setup request), if there is any. Alternatively, if multiple SMF 160s may be involved, the AMF 155 may send one N2 request message to (R)AN 105 after all the Nsmf_PDUSession_UpdateSMContext response service operations from all the SMF 160s associated with the UE 100 may be received. In such case, the N2 request message may include the N2 SM information received in each of the Nsmf_PDUSession_UpdateSMContext response and PDU session ID to enable AMF 155 to associate responses to relevant SMF 160.

In an example, if the RAN 105 (e.g., NG RAN) node may provide the list of recommended cells/TAs/NG-RAN node identifiers during the release procedure, the AMF 155 may include the information from the list in the N2 request. The RAN 105 may use this information to allocate the RAN 105 notification area when the RAN 105 may decide to enable RRC inactive state for the UE 100.

If the AMF 155 may receive an indication, from the SMF 160 during a PDU session establishment procedure that the UE 100 may be using a PDU session related to latency sensitive services, for any of the PDU sessions established for the UE 100 and the AMF 155 has received an indication from the UE 100 that may support the CM-CONNECTED with RRC inactive state, then the AMF 155 may include the UE's RRC inactive assistance information. In an example, the AMF 155 based on network configuration, may include the UE's RRC inactive assistance information.

In an example, the (R)AN 105 may send to the UE 100 a message to perform RRC connection reconfiguration 1070 with the UE 100 depending on the QoS information for all the QoS flows of the PDU sessions whose UP connections may be activated and data radio bearers. In an example, the user plane security may be established.

In an example, if the N2 request may include a MM NAS service accept message, the RAN 105 may forward the MM NAS service accept to the UE 100. The UE 100 may locally delete context of PDU sessions that may not be available in 5GC.

In an example, if the N1 SM information may be transmitted to the UE 100 and may indicate that some PDU session(s) may be re-established, the UE 100 may initiate PDU session re-establishment for the PDU session(s) that me be re-established after the service request procedure may be complete.

In an example, after the user plane radio resources may be setup, the uplink data from the UE 100 may be forwarded to the RAN 105. The RAN 105 (e.g., NG-RAN) may send the uplink data to the UPF 110 address and tunnel ID provided.

In an example, the (R)AN 105 may send to the AMF 155 an N2 request Ack 1105 (e.g., N2 SM information (comprising: AN tunnel info, list of accepted QoS flows for the PDU sessions whose UP connections are activated, list of rejected QoS flows for the PDU sessions whose UP connections are activated)). In an example, the N2 request message may include N2 SM information(s), e.g. AN tunnel info. RAN 105 may respond N2 SM information with separate N2 message (e.g. N2 tunnel setup response). In an example, if multiple N2 SM information are included in the N2 request message, the N2 request Ack may include multiple N2 SM information and information to enable the AMF 155 to associate the responses to relevant SMF 160.

In an example, the AMF 155 may send to the SMF 160 a Nsmf_PDUSession_UpdateSMContext request 1110 (N2 SM information (AN tunnel info), RAT type) per PDU session. If the AMF 155 may receive N2 SM information (one or multiple) from the RAN 105, then the AMF 155 may forward the N2 SM information to the relevant SMF 160. If the UE 100 time zone may change compared to the last reported UE 100 Time Zone then the AMF 155 may include the UE 100 time zone IE in the Nsmf_PDUSession_UpdateSMContext request message.

In an example, if dynamic PCC is deployed, the SMF 160 may initiate notification about new location information to the PCF 135 (if subscribed) by invoking an event exposure notification operation (e.g., a Nsmf_EventExposure_Notify service operation). The PCF 135 may provide updated policies by invoking a policy control update notification message 1115 (e.g., a Npcf_SMPolicyControl_UpdateNotify operation).

In an example, if the SMF 160 may select a new UPF 110 to act as intermediate UPF 110 for the PDU session, the SMF 160 may initiates an N4 session modification procedure 1120 to the new I-UPF 110 and may provide AN tunnel info. The downlink data from the new I-UPF 110 may be forwarded to RAN 105 and UE 100. In an example, the UPF 110 may send to the SMF 160, an N4 session modification response 1120. In an example, the SMF 160 may send to the AMF 155, an Nsmf_PDUSession_UpdateSMContext response 1140.

In an example, if forwarding tunnel may be established to the new I-UPF 110 and if the timer SMF 160 set for forwarding tunnel may be expired, the SMF 160 may sends N4 session modification request 1145 to new (intermediate) UPF 110 acting as N3 terminating point to release the forwarding tunnel. In an example, the new (intermediate) UPF 110 may send to the SMF 160 an N4 session modification response 1145. In an example, the SMF 160 may send to the PSA UPF 110-3 an N4 session modification request 1150, or N4 session release request. In an example, if the SMF 160 may continue using the old UPF 110-2, the SMF 160 may send an N4 session modification request 1155, providing AN tunnel info. In an example, if the SMF 160 may select a new UPF 110 to act as intermediate UPF 110, and the old UPF 110-2 may not be PSA UPF 110-3, the SMF 160 may initiate resource release, after timer expires, by sending an N4 session release request (release cause) to the old intermediate UPF 110-2.

In an example, the old intermediate UPF 110-2 may send to the SMF 160 an N4 session modification response or N4 session release response 1155. The old UPF 110-2 may acknowledge with the N4 session modification response or N4 session release response message to confirm the modification or release of resources. The AMF 155 may invoke the Namf_EventExposure_Notify service operation to notify the mobility related events, after this procedure may complete, towards the NFs that may have subscribed for the events. In an example, the AMF 155 may invoke the Namf_EventExposure_Notify towards the SMF 160 if the SMF 160 had subscribed for UE 100 moving into or out of area of interest and if the UE's current location may indicate that it may be moving into or moving outside of the area of interest subscribed, or if the SMF 160 had subscribed for LADN DNN and if the UE 100 may be moving into or outside of an area where the LADN is available, or if the UE 100 may be in MICO mode and the AMF 155 had notified an SMF 160 of the UE 100 being unreachable and that SMF 160 may not send DL data notifications to the AMF 155, and the AMF 155 may informs the SMF 160 that the UE 100 is reachable, or if the SMF 160 had subscribed for UE 100 reachability status, then the AMF 155 may notify the UE 100 reachability.

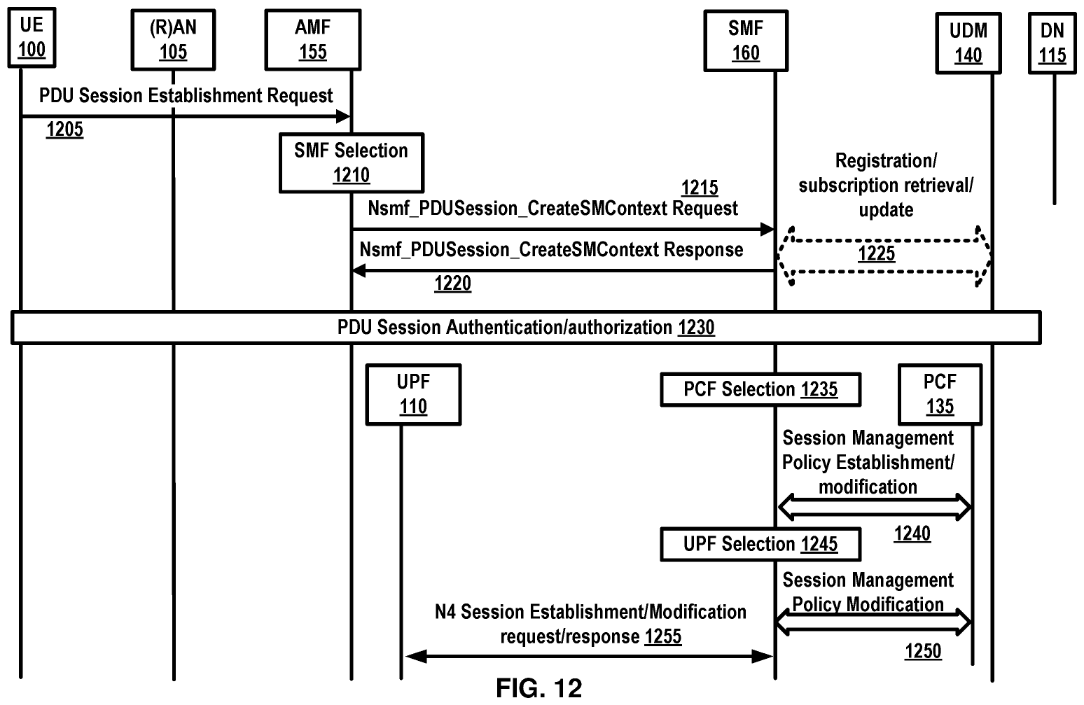

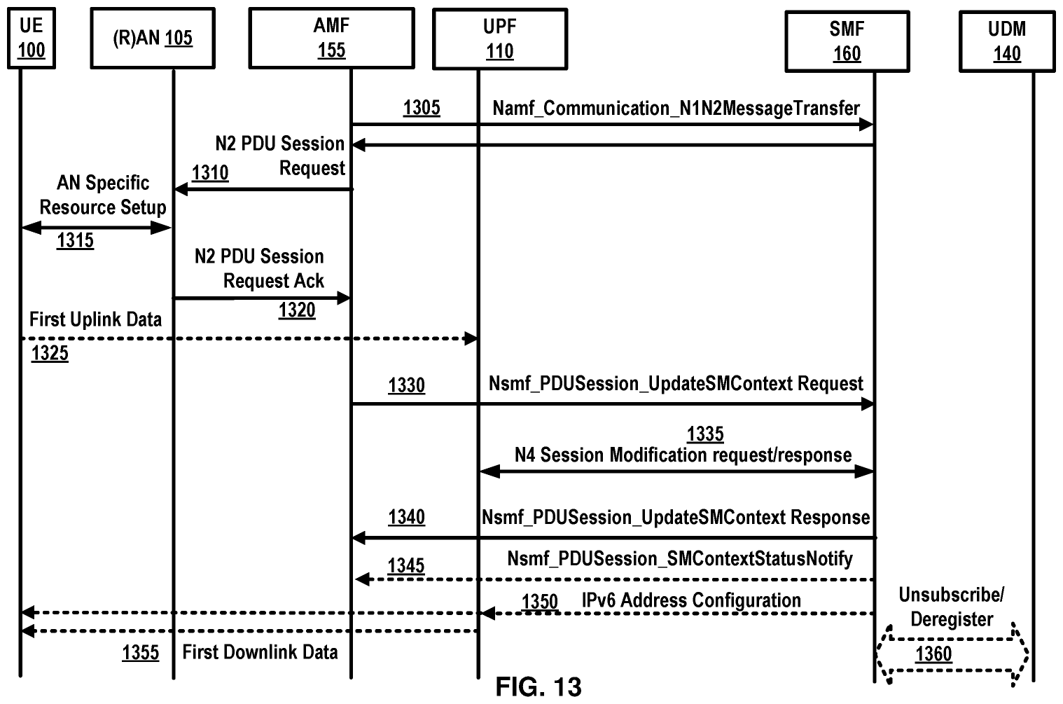

An example PDU session establishment procedure depicted in FIG. 12 and FIG. 13. In an example embodiment, when the PDU session establishment procedure may be employed, the UE 100 may send to the AMF 155 a NAS Message 1205 (or a SM NAS message) comprising NSSAI, S-NSSAI (e.g., requested S-NSSAI, allowed S-NSSAI, subscribed S-NSSAI, and/or the like), DNN, PDU session ID, request type, old PDU session ID, N1 SM container (PDU session establishment request), and/or the like. In an example, the UE 100, in order to establish a new PDU session, may generate a new PDU session ID. In an example, when emergency service may be required and an emergency PDU session may not already be established, the UE 100 may initiate the UE 100 requested PDU session establishment procedure with a request type indicating emergency request. In an example, the UE 100 may initiate the UE 100 requested PDU session establishment procedure by the transmission of the NAS message containing a PDU session establishment request within the N1 SM container. The PDU session establishment request may include a PDU type, SSC mode, protocol configuration options, and/or the like. In an example, the request type may indicate initial request if the PDU session establishment is a request to establish the new PDU session and may indicate existing PDU session if the request refers to an existing PDU session between 3GPP access and non-3GPP access or to an existing PDN connection in EPC. In an example, the request type may indicate emergency request if the PDU session establishment may be a request to establish a PDU session for emergency services. The request type may indicate existing emergency PDU session if the request refers to an existing PDU session for emergency services between 3GPP access and non-3GPP access. In an example, the NAS message sent by the UE 100 may be encapsulated by the in a N2 message towards the AMF 155 that may include user location information and access technology type information. In an example, the PDU session establishment request message may contain SM PDU DN request container containing information for the PDU session authorization by the external DN. In an example, if the procedure may be triggered for SSC mode 3 operation, the UE 100 may include the old PDU session ID which may indicate the PDU session ID of the on-going PDU session to be released, in the NAS message. The old PDU session ID may be an optional parameter which may be included in this case. In an example, the AMF 155 may receive from the the NAS message (e.g., NAS SM message) together with user location information (e.g. cell ID in case of the RAN 105). In an example, the UE 100 may not trigger a PDU session establishment for a PDU session corresponding to a LADN when the UE 100 is outside the area of availability of the LADN.

In an example, the AMF 155 may determine that the NAS message or the SM NAS message may correspond to the request for the new PDU session based on that request type indicates initial request and that the PDU session ID may not be used for any existing PDU session(s) of the UE 100. If the NAS message does not contain an S-NSSAI, the AMF 155 may determine a default S-NSSAI for the requested PDU session either according to the UE 100 subscription, if it may contain only one default S-NSSAI, or based on operator policy. In an example, the AMF 155 may perform SMF 160 selection 1210 and select an SMF 160. If the request type may indicate initial request or the request may be due to handover from EPS, the AMF 155 may store an association of the S-NSSAI, the PDU session ID and a SMF 160 ID. In an example, if the request type is initial request and if the old PDU session ID indicating the existing PDU session may be contained in the message, the AMF 155 may select the SMF 160 and may store an association of the new PDU session ID and the selected SMF 160 ID.

In an example, the AMF 155 may send to the SMF 160, an N11 message 1215, e.g., Nsmf_PDUSession_CreateSMContext request (comprising: SUPI or PEI, DNN, S-NSSAI, PDU session ID, AMF 155 ID, request type, N1 SM container (PDU session establishment request), user location information, access type, PEI, GPSI), or Nsmf_PDUSession_UpdateSMContext request (SUPI, DNN, S-NSSAI, PDU session ID, AMF 155 ID, request type, N1 SM container (PDU session establishment request), user location information, access type, RAT type, PEI). In an example, if the AMF 155 may not have an association with the SMF 160 for the PDU session ID provided by the UE 100 (e.g when request type indicates initial request), the AMF 155 may invoke the Nsmf_PDUSession_CreateSMContext request, but if the AMF 155 already has an association with an SMF 160 for the PDU session ID provided by the UE 100 (e.g when request type indicates existing PDU session), the AMF 155 may invoke the Nsmf_PDUSession_UpdateSMContext request. In an example, the AMF 155 ID may be the UE's GUAMI which uniquely identifies the AMF 155 serving the UE 100. The AMF 155 may forward the PDU session ID together with the N1 SM container containing the PDU session establishment request received from the UE 100. The AMF 155 may provide the PEI instead of the SUPI when the UE 100 has registered for emergency services without providing the SUPI. In case the UE 100 has registered for emergency services but has not been authenticated, the AMF 155 may indicate that the SUPI has not been authenticated.

In an example, if the request type may indicate neither emergency request nor existing emergency PDU session and, if the SMF 160 has not yet registered and subscription data may not be available, the SMF 160 may register with the UDM 140, and may retrieve subscription data 1225 and subscribes to be notified when subscription data may be modified. In an example, if the request type may indicate existing PDU session or existing emergency PDU session, the SMF 160 may determine that the request may be due to handover between 3GPP access and non-3GPP access or due to handover from EPS. The SMF 160 may identify the existing PDU session based on the PDU session ID. The SMF 160 may not create a new SM context but instead may update the existing SM context and may provide the representation of the updated SM context to the AMF 155 in the response. if the request type may be initial request and if the old PDU session ID may be included in Nsmf_PDUSession_CreateSMContext request, the SMF 160 may identify the existing PDU session to be released based on the old PDU session ID.

In an example, the SMF 160 may send to the AMF 155, the N11 message response 1220, e.g., either a PDU session create/update response, Nsmf_PDUSession_CreateSMContext response 1220 (cause, SM context ID or N1 SM container (PDU session reject(cause))) or an Nsmf_PDUSession_UpdateSMContext response.

In an example, if the SMF 160 may perform secondary authorization/authentication 1230 during the establishment of the PDU session by a DN-AAA server, the SMF 160 may select a UPF 110 and may trigger a PDU session establishment authentication/authorization.

In an example, if the request type may indicate initial request, the SMF 160 may select an SSC mode for the PDU session. The SMF 160 may select one or more UPFs as needed. In case of PDU type IPv4 or IPv6, the SMF 160 may allocate an IP address/prefix for the PDU session. In case of PDU type IPv6, the SMF 160 may allocate an interface identifier to the UE 100 for the UE 100 to build its link-local address. For Unstructured PDU type the SMF 160 may allocate an IPv6 prefix for the PDU session and N6 point-to-point tunneling (based on UDP/IPv6).

In an example, if dynamic PCC is deployed, the may SMF 160 performs PCF 135 selection 1235. If the request type indicates existing PDU session or existing emergency PDU session, the SMF 160 may use the PCF 135 already selected for the PDU session. If dynamic PCC is not deployed, the SMF 160 may apply local policy.

In an example, the SMF 160 may perform a session management policy establishment procedure 1240 to establish a PDU session with the PCF 135 and may get the default PCC Rules for the PDU session. The GPSI may be included if available at the SMF 160. If the request type in 1215 indicates existing PDU session, the SMF 160 may notify an event previously subscribed by the PCF 135 by a session management policy modification procedure and the PCF 135 may update policy information in the SMF 160. The PCF 135 may provide authorized session-AMBR and the authorized 5QI and ARP to SMF 160. The PCF 135 may subscribe to the IP allocation/release event in the SMF 160 (and may subscribe other events).

In an example, the PCF 135, based on the emergency DNN, may set the ARP of the PCC rules to a value that may be reserved for emergency services.

In an example, if the request type in 1215 indicates initial request, the SMF 160 may select an SSC mode for the PDU session. The SMF 160 may select 1245 one or more UPFs as needed. In case of PDU type IPv4 or IPv6, the SMF 160 may allocate an IP address/prefix for the PDU session. In case of PDU type IPv6, the SMF 160 may allocate an interface identifier to the UE 100 for the UE 100 to build its link-local address. For unstructured PDU type the SMF 160 may allocate an IPv6 prefix for the PDU session and N6 point-to-point tunneling (e.g., based on UDP/IPv6). In an example, for Ethernet PDU type PDU session, neither a MAC nor an IP address may be allocated by the SMF 160 to the UE 100 for this PDU session.

In an example, if the request type in 1215 is existing PDU session, the SMF 160 may maintain the same IP address/prefix that may be allocated to the UE 100 in the source network.

In an example, if the request type in 1215 indicates existing PDU session referring to an existing PDU session moved between 3GPP access and non-3GPP access, the SMF 160 may maintain the SSC mode of the PDU session, e.g., the current PDU session Anchor and IP address. In an example, the SMF 160 may trigger e.g. new intermediate UPF 110 insertion or allocation of a new UPF 110. In an example, if the request type indicates emergency request, the SMF 160 may select 1245 the UPF 110 and may select SSC mode 1.

In an example, the SMF 160 may perform a session management policy modification 1250 procedure to report some event to the PCF 135 that has previously subscribed. If request type is initial request and dynamic PCC is deployed and PDU type is IPv4 or IPv6, the SMF 160 may notify the PCF 135 (that has previously subscribed) with the allocated UE 100 IP address/prefix.

In an example, the PCF 135 may provide updated policies to the SMF 160. The PCF 135 may provide authorized session-AMBR and the authorized 5QI and ARP to the SMF 160.

In an example, if request type indicates initial request, the SMF 160 may initiate an N4 session establishment procedure 1255 with the selected UPF 110. The SMF 160 may initiate an N4 session modification procedure with the selected UPF 110. In an example, the SMF 160 may send an N4 session establishment/modification request 1255 to the UPF 110 and may provide packet detection, enforcement, reporting rules, and/or the like to be installed on the UPF 110 for this PDU session. If CN tunnel info is allocated by the SMF 160, the CN tunnel info may be provided to the UPF 110. If the selective user plane deactivation is required for this PDU session, the SMF 160 may determine the Inactivity Timer and may provide it to the UPF 110. In an example, the UPF 110 may acknowledges by sending an N4 session establishment/modification response 1255. If CN tunnel info is allocated by the UPF, the CN tunnel info may be provided to SMF 160. In an example, if multiple UPFs are selected for the PDU session, the SMF 160 may initiate N4 session establishment/modification procedure 1255 with each UPF 110 of the PDU session.

In an example, the SMF 160 may send to the AMF 155 an Namf_Communication_N1N2MessageTransfer 1305 message (comprising PDU session ID, access type, N2 SM information (PDU session ID, QFI(s), QoS profile(s), CN tunnel info, S-NSSAI, session-AMBR, PDU session type, and/or the like), N1 SM container (PDU session establishment accept (QoS Rule(s), selected SSC mode, S-NSSAI, allocated IPv4 address, interface identifier, session-AMBR, selected PDU session type, and/or the like))). In case of multiple UPFs are used for the PDU session, the CN tunnel info may comprise tunnel information related with the UPF 110 that terminates N3. In an example, the N2 SM information may carry information that the AMF 155 may forward to the (R)AN 105 (e.g., the CN tunnel info corresponding to the core network address of the N3 tunnel corresponding to the PDU session, one or multiple QoS profiles and the corresponding QFIs may be provided to the (R)AN 105, the PDU session ID may be used by AN signaling with the UE 100 to indicate to the UE 100 the association between AN resources and a PDU session for the UE100, and/or the like). In an example, a PDU session may be associated to an S-NSSAI and a DNN. In an example, the N1 SM container may contain the PDU session establishment accept that the AMF 155 may provide to the UE 100. In an example, multiple QoS rules and QoS profiles may be included in the PDU session establishment accept within the N1 SM and in the N2 SM information. In an example, the Namf_Communication_N1N2MessageTransfer 1305 may further comprise the PDU session ID and information allowing the AMF 155 to know which access towards the UE 100 to use.

In an example, the AMF 155 may send to the (R)AN 105 an N2 PDU session request 1310 (comprising N2 SM information, NAS message (PDU session ID, N1 SM container (PDU session establishment accept, and/or the like))). In an example, the AMF 155 may send the NAS message 1310 that may comprise PDU session ID and PDU session establishment accept targeted to the UE 100 and the N2 SM information received from the SMF 160 within the N2 PDU session request 1310 to the (R)AN 105.

In an example, the (R)AN 105 may issue AN specific signaling exchange 1315 with the UE 100 that may be related with the information received from SMF 160. In an example, in case of a 3GPP RAN 105, an RRC connection reconfiguration procedure may take place with the UE 100 to establish the necessary RAN 105 resources related to the QoS Rules for the PDU session request 1310. In an example, (R)AN 105 may allocate (R)AN 105 N3 tunnel information for the PDU session. In case of dual connectivity, the master RAN 105 node may assign some (zero or more) QFIs to be setup to a master RAN 105 node and others to the secondary RAN 105 node. The tunnel info may comprise a tunnel endpoint for each involved RAN 105 node, and the QFIs assigned to each tunnel endpoint. A QFI may be assigned to either the master RAN 105 node or the secondary RAN 105 node. In an example, (R)AN 105 may forward the NAS message 1310 (PDU session ID, N1 SM container (PDU session establishment accept)) to the UE 100. The (R)AN 105 may provide the NAS message to the UE 100 if the necessary RAN 105 resources are established and the allocation of (R)AN 105 tunnel information are successful.

In an example, the N2 PDU session response 1320 may comprise a PDU session ID, cause, N2 SM information (PDU session ID, AN tunnel info, list of accepted/rejected QFI(s)), and/or the like. In an example, the tunnel info may correspond to the access network address of the N3 tunnel corresponding to the PDU session.

In an example, the AMF 155 may forward the N2 SM information received from (R)AN 105 to the SMF 160 via a Nsmf_PDUSession_UpdateSMContext request 1330 (comprising: N2 SM information, request type, and/or the like). In an example, if the list of rejected QFI(s) is included in N2 SM information, the SMF 160 may release the rejected QFI(s) associated QoS profiles.

In an example, the SMF 160 may initiate an N4 session modification procedure 1335 with the UPF110. The SMF 160 may provide AN tunnel info to the UPF 110 as well as the corresponding forwarding rules. In an example, the UPF 110 may provide an N4 session modification response 1335 to the SMF 160160.

In an example, the SMF 160 may send to the AMF 155 an Nsmf_PDUSession_UpdateSMContext response 1340 (Cause). In an example, the SMF 160 may subscribe to the UE 100 mobility event notification from the AMF 155 (e.g. location reporting, UE 100 moving into or out of area of interest), after this step by invoking Namf_EventExposure_Subscribe service operation. For LADN, the SMF 160 may subscribe to the UE 100 moving into or out of LADN service area event notification by providing the LADN DNN as an indicator for the area of interest. The AMF 155 may forward relevant events subscribed by the SMF 160.

In an example, the SMF 160 may send to the AMF 155, a Nsmf_PDUSession_SMContextStatusNotify (release) 1345. In an example, if during the procedure, any time the PDU session establishment is not successful, the SMF 160 may inform the AMF 155 by invoking Nsmf_PDUSession_SMContextStatusNotify(release) 1345. The SMF 160 may releases any N4 session(s) created, any PDU session address if allocated (e.g IP address) and may release the association with the PCF 135.

In an example, in case of PDU type IPv6, the SMF 160 may generate an IPv6 Router Advertisement 1350 and may send it to the UE 100 via N4 and the UPF 110.

In an example, if the PDU session may not be established, the SMF 160 may unsubscribe 1360 to the modifications of session management subscription data for the corresponding (SUPI, DNN, S-NSSAI), using Nudm_SDM_Unsubscribe (SUPI, DNN, S-NSSAI), if the SMF 160 is no more handling a PDU session of the UE 100 for this (DNN, S-NSSAI). In an example, if the PDU session may not be established, the SMF 160 may deregister 1360 for the given PDU session using Nudm_UECM_Deregistration (SUPI, DNN, PDU session ID).

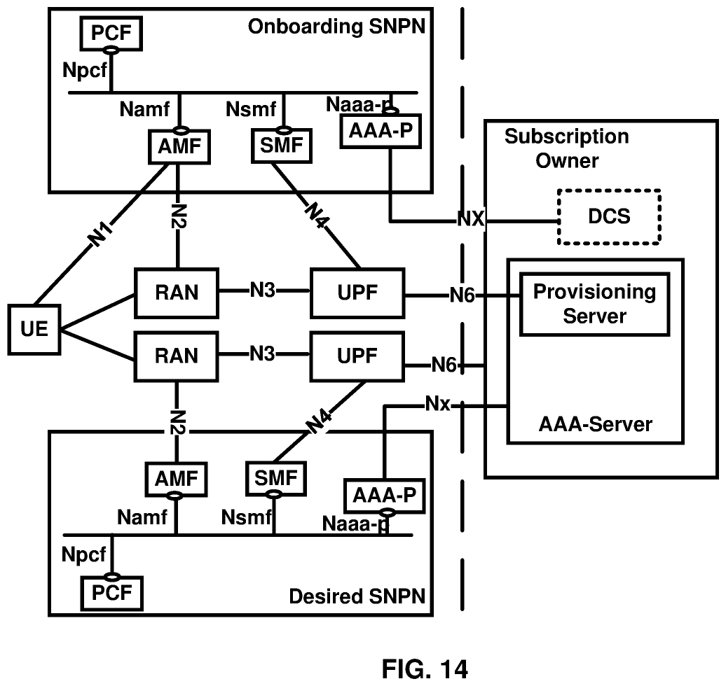

FIG. 14 illustrates another example of a mobile communication network in which embodiments of the present disclosure may be implemented. The mobile communication network depicted in FIG. 14 includes a wireless device 1410, a base station 1420, a physical core network deployment of one or more network functions 1430 (henceforth “CN deployment 1430”), and a physical core network deployment of one or more network functions 1440 (henceforth “CN deployment 1440”). The deployment 1430 and the deployment 1440 may be elements of a core network.

The wireless device 1410 may communicate with the base station 1420 over an air interface 1470. The communication direction from the wireless device 1410 to the base station 1420 over the air interface is known as uplink, and the communication direction from the base station 1420 to the wireless device 1410 over the air interface 1470 is known as downlink. Downlink transmissions may be separated from uplink transmissions using FDD, TDD, and/or some combination of the two duplexing techniques. FIG. 14 shows a single wireless device 1410 and a single base station 1420, but it will be understood that the wireless device 1410 may communicate with any number of base stations or other access network components over the air interface 1470, and that the base station 1420 may communicate with any number of wireless devices over the air interface 1470.

The wireless device 1410 may comprise a processing system 1411 and a memory 1412. The memory 1412 may comprise one or more computer-readable media, for example, one or more non-transitory computer readable media. The memory 1412 may include instructions 1413. The processing system 1411 may process and/or execute the instructions 1413. Processing and/or execution of the instructions 1413 may cause the processing system 1411 to perform one or more functions or activities. The memory 1412 may include data (not shown). One of the functions or activities performed by the processing system 1411 may be to store data in the memory 1412 and/or retrieve previously-stored data from the memory 1412. In an example, downlink data received from the base station 1420 may be stored in the memory 1412, and uplink data for transmission to the base station 1420 may be retrieved from the memory 1412. The wireless device 1410 may communicate with the base station 1420 using a transmission processing system 1414 and a reception processing system 1415. The wireless device 1410 may comprise one or more antennas 1416 to access the air interface 1470. Although not shown in FIG. 14, the transmission processing system 1414 and/or the reception processing system 1415 may be coupled to a dedicated memory that is analogous to but separate from the memory 1412, and comprises instructions that may be processed and/or executed to carry out one or more of their respective functionalities.

The wireless device 1410 may comprise one or more other elements 1419. The one or more other elements 1419 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1410 may receive user input data from and/or provide user output data to the one or more one or more other elements 1419. The one or more other elements 1419 may comprise a power source. The wireless device 1410 may receive power from the power source and may be configured to distribute the power to the other components in the wireless device 1410. The power source may comprise one or more sources of power, for example, a battery, a solar cell, a fuel cell, or any combination thereof.

The wireless device 1410 may transmit data to the base station 1420 via the air interface 1470. To perform the transmission, the processing system 1411 may implement layer 3 and layer 2 open systems interconnection (OSI) functionality to process the data for uplink transmission. Layer 3 may include a radio resource control layer (RRC). Layer 14 may include a service data application protocol layer (SDAP), a packet data convergence protocol layer (PDCP), a radio link control layer (RLC), and a media access control layer (MAC). The data may be provided to the transmission processing system 1414, which may implement layer 1 OSI functionality. Layer 1 may include a physical layer (PHY). The wireless device 1410 may transmit the data over the air interface 1470 using one or more antennas 1416. For scenarios where the one or more antennas 1416 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The wireless device 1410 may receive downlink data from the base station 1420 over the air interface 1470. The downlink data may be received via the one or more antennas 1416. The reception processing system 1415 may implement layer 1 OSI functionality on the received downlink data and may provide the data to the processing system 1411. The processing system 1411 may implement layer 2 and layer 3 OSI functionality to process the received downlink data. The base station 1420 may comprise elements analogous to the elements of the wireless device 1410. The base station 1420 may comprise a processing system 1421 and a memory 1422. The memory 1422 may comprise one or more computer-readable media, for example, one or more non-transitory computer readable media. The memory 1422 may include instructions 1423. The processing system 1421 may process and/or execute the instructions 1423. Processing and/or execution of the instructions 1423 may cause the processing system 1421 to perform one or more functions or activities. The memory 1422 may include data (not shown). One of the functions or activities performed by the processing system 1421 may be to store data in the memory 1422 and/or retrieve previously-stored data from the memory 1422. The base station 1420 may communicate with the wireless device 1410 using a transmission processing system 1424 and a reception processing system 1425. The base station 1420 may comprise one or more antennas 1426 to access the air interface 1470. The processing system 1421 may implement layer 14 and layer 3 OSI functionality. The transmission processing system 1424 and the reception processing system 1425 may implement layer 1 OSI functionality to perform transmission of downlink data and reception of uplink data, respectively.

The base station 1420 may comprise an interface system 1427. The interface system 1427 may communicate with one or more elements of the core network via an interface 1480. The interface 1480 may be wired and/or wireless and the interface system 1427 may include one or more components suitable for communicating via the interface 1480. In FIG. 14, the interface 1480 connects the base station 1420 to a single CN deployment 1430, but it will be understood that the wireless device 1410 may communicate with any number of CN deployments over the interface 1480, and that the CN deployment 1430 may communicate with any number of base stations over the interface 1480. The base station 1420 may comprise one or more other elements 1429 analogous to one or more of the one or more other elements 1419.

The CN deployment 1430 may comprise one or more network functions (NFs). For example, the CN deployment 1430 may comprise an AMF and/or a UPF analogous to the AMF and UPF depicted in FIG. 1. The CN deployment 1430 may comprise elements analogous to the elements of the wireless device 1410 and the base station 1420, as described above. The CN deployment 1430 may comprise a processing system 1431 and a memory 1432. The memory 1432 may comprise one or more computer-readable media, for example, one or more non-transitory computer readable media. The memory 1432 may include instructions 1433. The processing system 1431 may process and/or execute the instructions 1433. Processing and/or execution of the instructions 1433 may cause the processing system 1431 to perform one or more functions or activities. The memory 1432 may include data (not shown). One of the functions or activities performed by the processing system 1431 may be to store data in the memory 1432 and/or retrieve previously-stored data from the memory 1432. The CN deployment 1430 may access the interface 1480 using an interface system 1437. The CN deployment 1430 may also use the interface system 1437 to access an interface 1490. The CN deployment 1430 may use the interface 1490 to communicate with one or more data networks (analogous to, for example, the DN(s) depicted in FIG. 1 and/or one or more other CN deployments, including the CN deployment 1440 depicted in FIG. 14. The CN deployment 1430 may comprise one or more other elements 1439.

The CN deployment 1440 may comprise elements analogous to the elements of the CN deployment 1430, as described above. The CN deployment 1440 may comprise a processing system 1441 and a memory 1442. The memory 1442 may comprise one or more computer-readable media, for example, one or more non-transitory computer readable media. The memory 1442 may include instructions 1443. The processing system 1441 may process and/or execute the instructions 1443. Processing and/or execution of the instructions 1443 may cause the processing system 1441 to perform one or more functions or activities. The memory 1442 may include data (not shown). One of the functions or activities performed by the processing system 1441 may be to store data in the memory 1442 and/or retrieve previously-stored data from the memory 1442. The CN deployment 1440 may access the interface 1490 using an interface system 1447. The CN deployment 1440 may comprise one or more other elements.

The processing system 1411, the processing system 1421, the processing system 1431, and/or the processing system 1441 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1411, the processing system 1421, the processing system 1431, and/or the processing system 1441 may perform signal coding/processing, data processing, power control, input/output processing, and/or any other functionality that may enable the wireless device 1410, base station 1420, CN deployment 1430, and/or CN deployment 1440 to operate in a mobile communications system.

Each CN deployment may comprise one or more network functions. Depending on the context in which the term is used, a network function (NF) may refer to a particular set of functionalities and/or one or more physical elements configured to perform those functionalities (e.g., a processing system and memory comprising instructions that, when executed by the processing system, cause the processing system to perform the functionalities). There are many different types of NF and each type of NF may be associated with a different set of functionalities. Different NFs may be flexibly deployed at different locations (for example, in different physical core network deployments) or in a same location (for example, co-located in the same physical core network deployment). Moreover, physical CN deployment are not limited to implementation of NFs. For example, a particular physical CN deployment may further include a base station or portions therefor and/or a data network or portions thereof. Accordingly, one or more NFs implemented on a particular physical core network deployment may be co-located with one or more non-core elements, including elements of an access network or data network.

Many cellular networks may deployed as a PLMN or NPN (SNPN). A UE may access services of a PLMN via an SNPN. A UE may access services of a SNPN via a PLMN.

In an example embodiment, default UE credentials may be information that the UE have before the actual onboarding procedure to make it uniquely identifiable and verifiably secure. A Default Credential Server (DCS) may be a server that can authenticate a UE with default UE credentials or provide means to another entity to do it. A non public network (NPN) may be a private network deployed for an organization, specific application, and/or the like. NPN credentials or SNPN credentials may be information that the UE uses for authentication to access a NPN or a SNPN. (S)NPN credentials may be 3GPP credentials or non-3GPP credentials. An onboarding network (ON) may provide initial registration and/or access to the UE for UE Onboarding. A provisioning server may be a server that provisions the authenticated/authorized UE with the subscription data and optionally other configuration information. Subscription Owner (SO) may be an entity that stores and as result of the UE onboarding procedures provide the subscription data and optionally other configuration information via a provisioning server (PS) to the UE. UE onboarding may comprise provisioning of information, to a UE and within the network, required for the UE to get authorized access and connectivity to an NPN. A unique UE identifier may identify the UE in the network and the DCS and may be assigned and configured by the DCS. The unique UE identifier may be unique within the DCS and may take the form of (or comprise) a network access identifier (NAI) using the NAI RFC 7542.

In an example embodiment as depicted in FIG. 14, a UE may access an ON. The ON may be a separate network. The ON may be a SNPN as depicted in FIG. 14. The ON may be PLMN, PNI-NPN, and/or the like. A desired network (as depicted in FIG. 14: desired SNPN) may be a SNPN, NPN or a PLMN. FIG. 14 depicts UE onboarding and remote provisioning, in particular for UE's subscription to standalone non-public networks. The UEs without subscription to the desired SNPN may temporarily register to a 5G network that supports UE onboarding and to establish a restricted PDU Session for reception of a newly assigned subscription for the desired SNPN from the network entity for provisioning.

In an example, a SNPN may be deployed to support audio/video applications (includes television and radio studios, live news-gathering, sports events, music festivals, medical operating, lecture hall, press center, trade fair, company/TV evening) for Program Making and Special Events (PMSE) equipment, which has no user interfaces (screens and keyboards) or physical ports (network ports, USB ports, and card slots), such as microphones, speakers, headphones, cameras, recorders, mixers, consoles. The PMSE equipment may be provisioned/updated during UE onboarding at the onboarding 5G Network. A AAA Server may act as the provisioning server and provisions the UE with a newly assigned subscription (non-3GPP identities e.g. non-IMSI and credentials) for the desired SNPN. If the onboarding 5G network is PLMN or PNI-NPN, the UE may have a subscription and credentials to the PLMN for the UE to be uniquely identifiable and verifiably secure during onboarding and remote provisioning. If the onboarding 5G network is SNPN, the UE may have default UE credentials e.g., provided by a manufacturer, for the UE to be uniquely identifiable and verifiably secure during onboarding and remote provisioning.

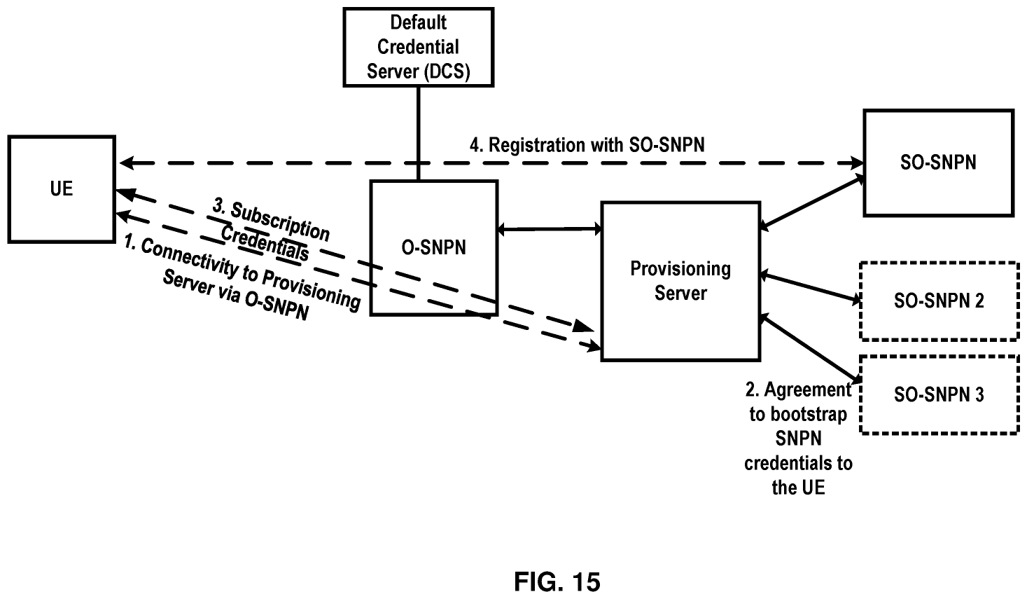

In an example embodiment, an onboarding network may be a SNPN (O-SNPN) as depicted in FIG. 15. In an example embodiment as depicted in FIG. 15 a procedure may allow a UE, which is not initially provisioned with subscription credentials to access an ON e.g., an onboarding SNPN (O-SNPN) and to obtain subscription credentials and configuration for an subscription owner SNPN (SO-SNPN) which may be the same as or different from the O-SNPN. In an example, the UE may select the O-SNPN based on information broadcasted by the O-SNPN and may register to it for onboarding service to obtain connectivity to the provisioning server. If the UE is not configured with network selection parameters for O-SNPN, the O-SNPN may be manually selected, or the UE may randomly select a network that is available and supports onboarding functionalities. If the UE fails to complete the remote provisioning through the selected O-SNPN (e.g., the UE fails the authentication by the DCS), the UE may select another O-SNPN to try the process again. During the registration procedure the O-SNPN may authenticate the UE with the default credential server (DCS) to determine whether the UE is a genuine device subject to onboarding and authorized to access a provisioning server via a configuration PDU session. Upon establishment of connectivity to the provisioning server, the UE may be provisioned with the subscription credentials for the SO-SNPN (i.e. SNPN that will own the UE's subscription) and additional configuration data. The UE may de-register from the O-SNPN, and may perform a network selection, and may register the SO-SNPN using the provisioned subscription credentials and configuration data.

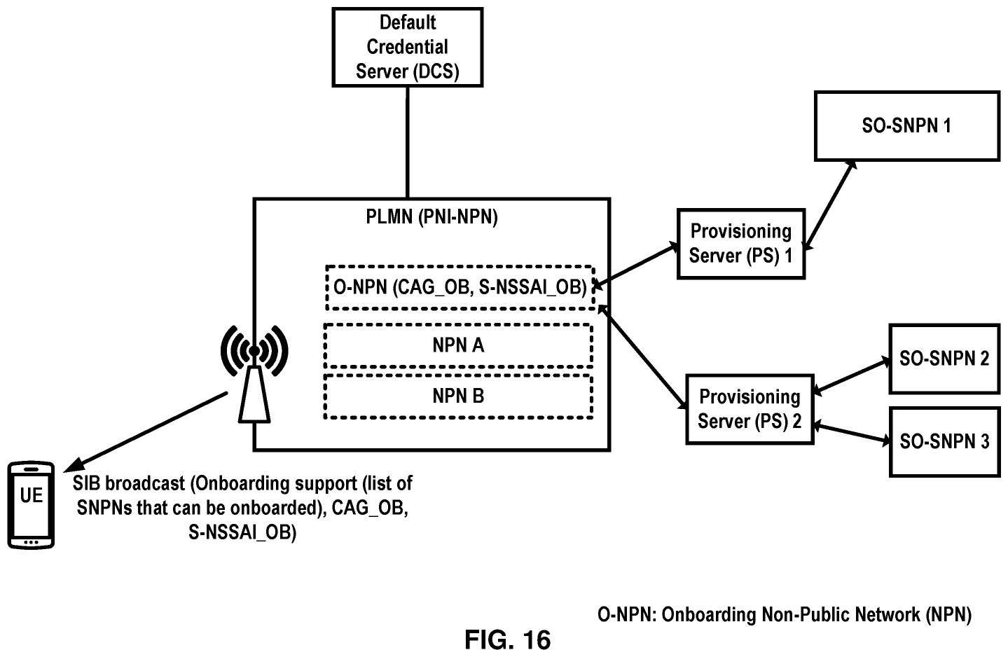

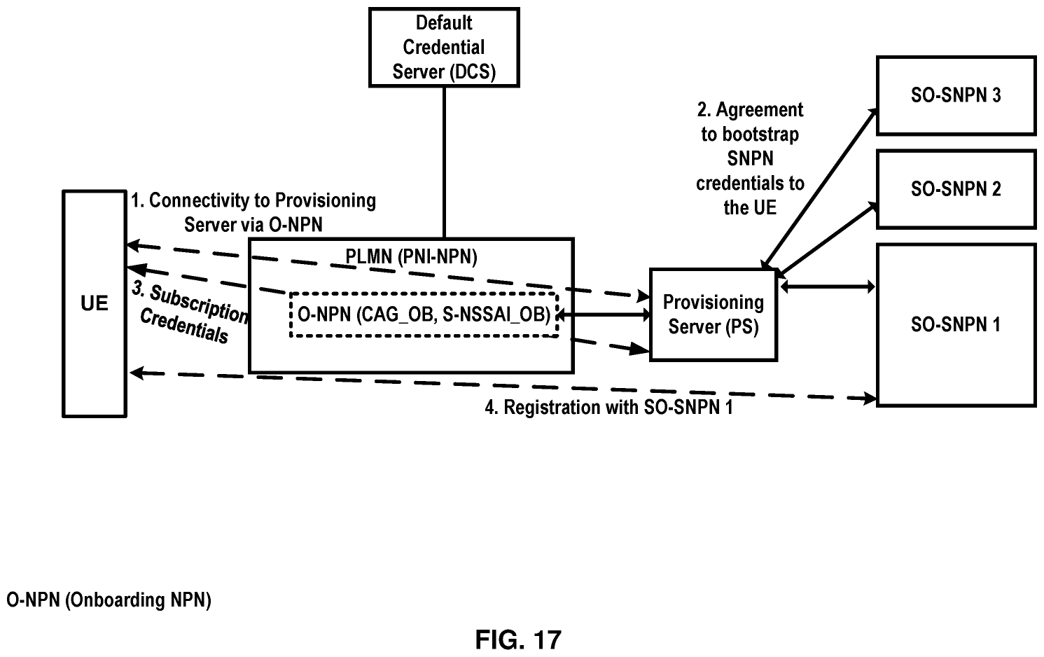

In an example embodiment as depicted in FIG. 16 and FIG. 17, the onboarding network may be an NPN (O-NPN) integrated in a PLMN, SNPN, or another network. The O-NPN may be identified and accessed by a UE by a specific network ID (NID), CAG ID, S-NSSAI, DNN, a combination of PLMN ID and NID, and/or the like. One or more provisioning servers may have an agreement with one or more desired SNPNs (SO-SNPNs).

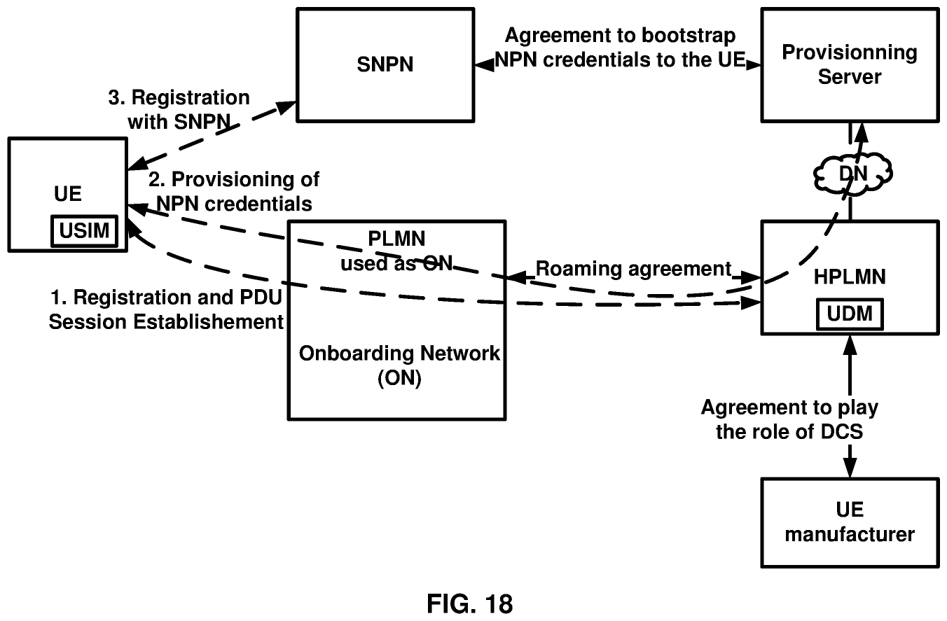

In an example embodiment as depicted in FIG. 18, a PLMN may be employed for onboarding of a UE. The UE may be configured with default credentials in a universal subscriber identity module (USIM) to attach to any PLMN in which the UE can register with the default credentials, e.g., an Onboarding Network (ON). This enables UEs to be provisioned with necessary network credentials and configuration for the SNPN that will own the UE's subscription. The UE may be manufactured with default credentials that consist in a USIM profile that may be used for UE onboarding. The USIM profile may be issued by any PLMN operator the manufacturer has an agreement with. The PLMN that issued the USIM profile is referred to as HPLMN in FIG. 18. The UDM (or HSS) of the HPLMN plays the role of default credential server (DCS) and the provisioning server (PS) is in a DN that the HPLMN provides access to. As part of the agreement between the UE manufacturer and the HPLMN, the UE subscription in the HPLMN may allow access to a DN that provides connectivity to the PS. Any PLMN available at the location where the UE is when performing UE onboarding may be used as ON, as long as it has an agreement with the HPLMN. At power-up, the UE may not have information for SNPN selection and therefore performs normal PLMN selection, registers and establishes a PDU Session using normal procedures. The UE subscription corresponding to the USIM profile contains a default Subscribed S-NSSAI and a default DNN that are appropriate to reach the PS; consequently a PDU Session that provides access to the PS may be established without the UE having to indicate any NSSAI or DNN information. The UE may connect to the PS through the established PDU session for onboarding. The HPLMN may provides a GPSI of the UE subscription to the PS e.g., using header enrichment. Upon establishment of connectivity to the PS, the UE may be provisioned with NPN credentials (for the SNPN that will own the UE's subscription) and additional configuration data. Then the UE may deregister from the PLMN and, using the information acquired during UE onboarding, performs a new network selection and registers using the provisioned NPN credentials with the SNPN owning the UE's subscription.

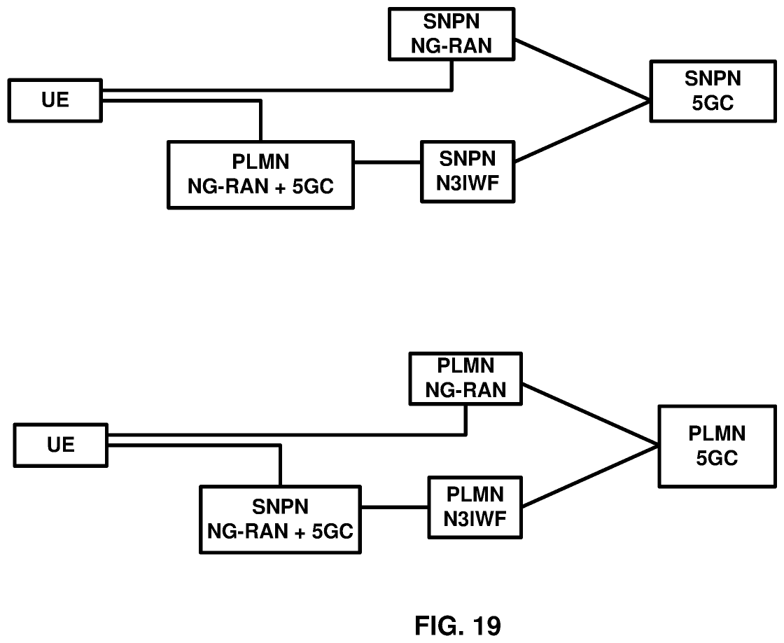

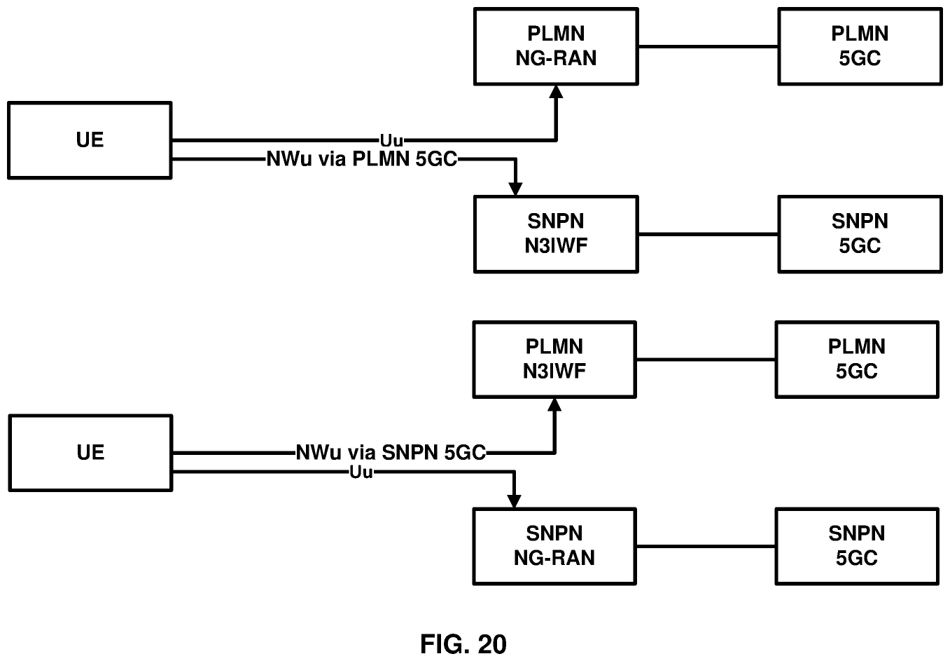

In an example embodiment as depicted in FIG. 19 and FIG. 20, an N3IWF or an interworking function may be employed for connectivity of two or more networks. A UE may access services of a PLMN via an SNPN. A UE may access services of a SNPN via a PLMN. A UE may access services of a SNPN via another SNPN. FIG. 19 depicts a scenario where the UPF PSA of a PDU session is in SNPN. A dual radio UE may employ one radio to register under the SNPN NG-RAN, and the other radio to register under the SNPN N3IWF via the PLMN NG-RAN and 5GC. From SNPN 5GC point of view, the UE may be registered under both 3GPP access and non-3GPP access. FIG. 19 depicts the example of a dual radio UE. FIG. 20 depicts the example of a single radio UE.

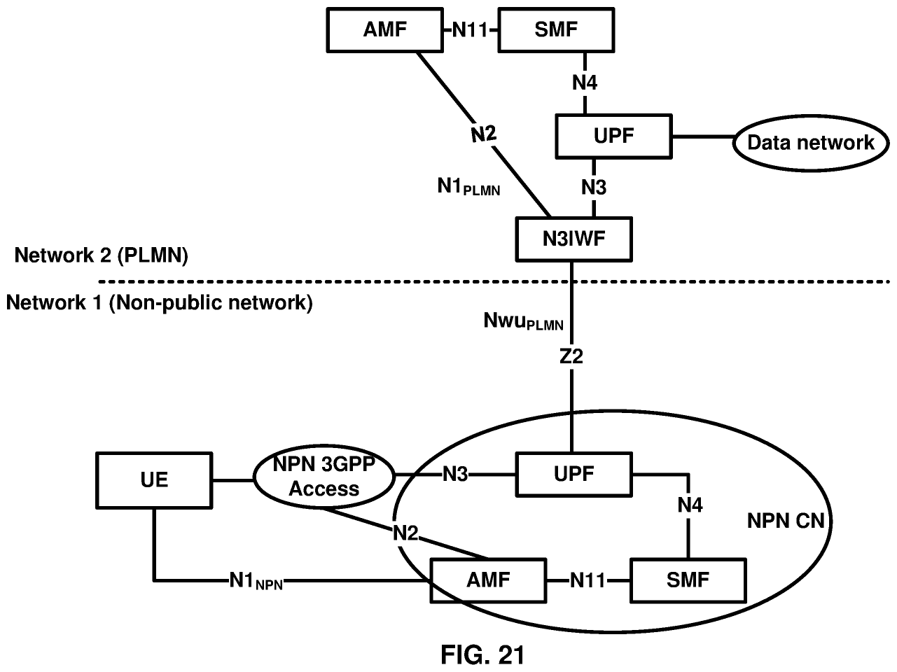

In an example embodiment as depicted in FIG. 21, a UE may access to a second network (PLMN) services via a first network (e.g., non-public network). The UE may first obtain IP connectivity by registering with the non-public network. Then the UE may obtain connectivity to the 5GC in the PLMN via an interworking function (e.g., a proxy, N3IWF, and/or the like). The Non-public network may deploy a 3GPP RAT, though it may not be considered a public PLMN. The UE may perform PLMN selection as part of the N3IWF discovery.

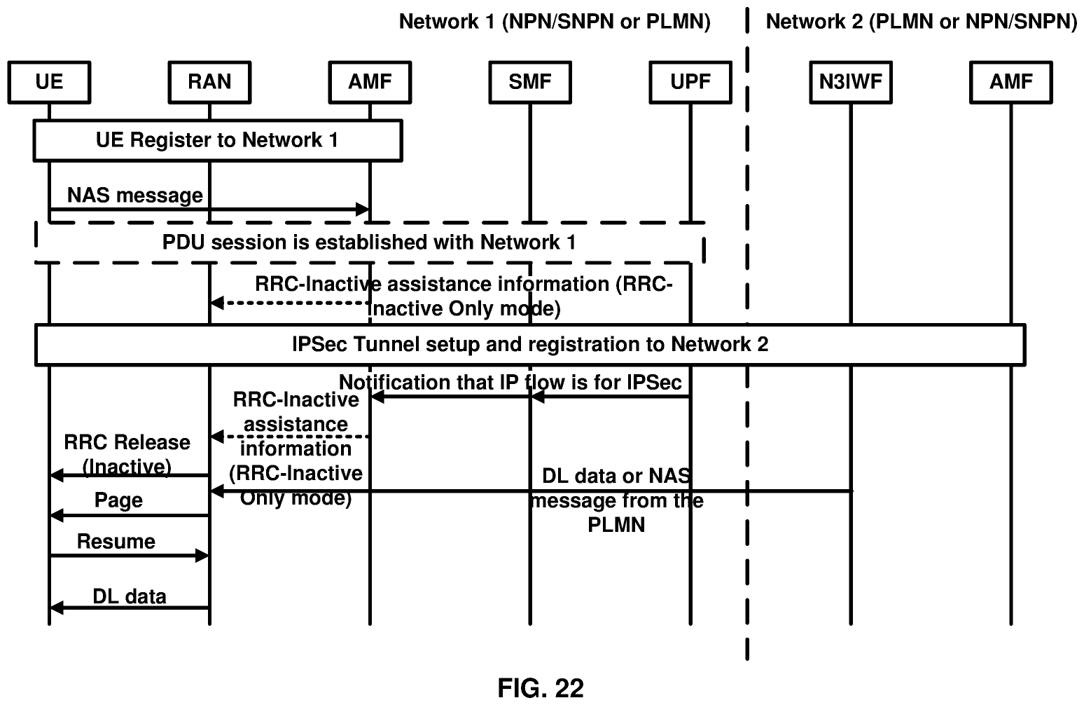

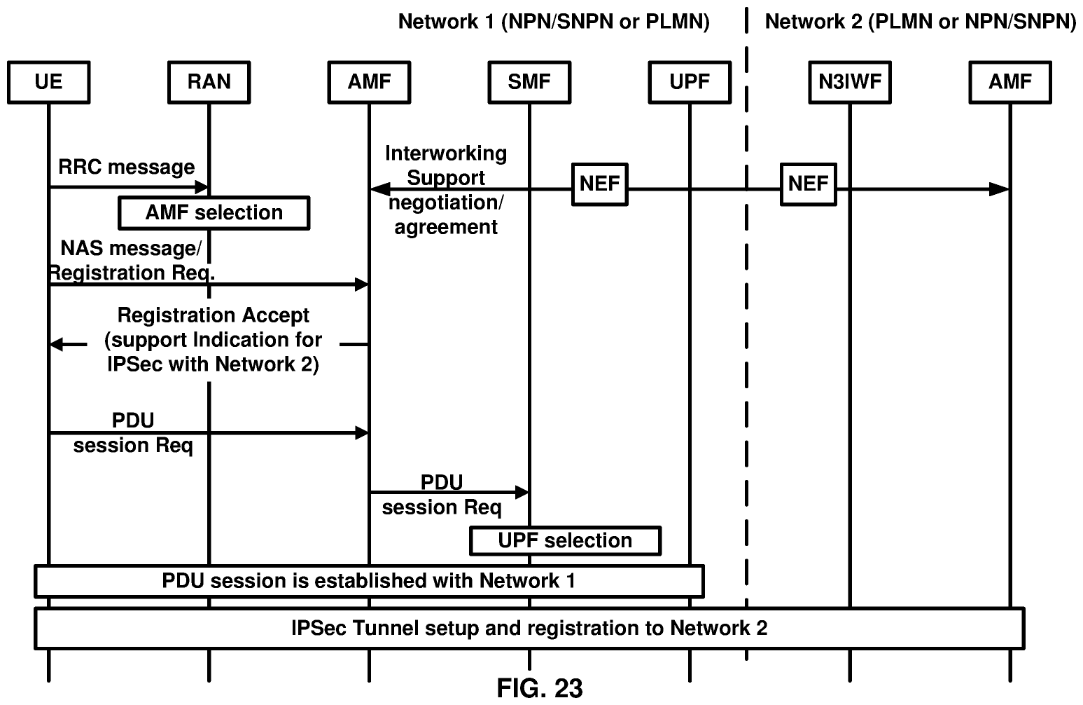

In an example embodiment as depicted in FIG. 22 and FIG. 23, a UE may access network 2 via network 1. In an example, the UE may have two subscription e.g., one PLMN (aka “PLMN UE” for PLMN parts of the UE) and one SNPN (aka “SNPN UE” for SNPN parts of the UE) subscription. The scenarios described may employ PLMN and SNPN, but same principles may apply between SNPNs, if allowed.

In an example embodiment as depicted in FIG. 22 and FIG. 23, The UE may be either in connected state or in a power save state in the serving network (network 1) and still get service from the other network. The UE may be always in CM connected state in both networks and that the IPsec tunnel between the UE and N3IWF over Nwu may be always maintained. It may involve that the UE send IPsec keep alive messages. In an example, in order for the UE to maintain an IPSec tunnel to network 2, a PDU session in network 1 may be required. As depicted in FIG. 22, and FIG. 23, the UE may register to the network 1 (e.g., NPN). The UE may request service in order to setup an IPsec tunnel to the N3IWF. The service request may need to indicate the specific service (connection to the PLMN/network 2). The PDU session may be setup in network 1. The AMF may include in the RRC inactive assistance information that this UE may only be released to RRC Inactive and may send the RRC inactive assistance information to the RAN. This behavior in the AMF may be triggered by 1) either based on the UE indication in the NAS message (SR or PDU session establishment), or 2) informed by the SMF/UPF. The SMF/UPF, when the SMF/UPF detect that the target address for the IPSec tunnel is a known N3IWF of a PLMN (in this case the RRC Inactive Assistance IE may need to be updated if already sent). UE sets up the IPSec tunnel and registers to the PLMN (network 2). Due to inactivity in the network 1 (NPN) the RAN may release the UE to RRC Inactive mode. RAN may receive DL data or NAS message from the PLMN (network 2) to the UE. The RAN node may page the UE. The UE may resume the RRC-Connection. The DL data or NAS message may be sent to the UE.

Existing technologies may support access of a wireless device to a network via another network. The wireless device may register with a first network. The wireless device may use the first network to attempt access to a second network. The access to the first network may be associated with onboarding (e.g., obtaining credentials for access to the second network) and/or underlay (e.g., using the first network, an underlay network, to access the second network, an overlay network, via an interworking function of the second network). After registering with the first network and/or establishing a session with the first network, the wireless device and/or the first network (or an entity thereof) may determine that the first network does not support access to the second network. For example, the first network may not support onboarding to the second network and/or underlay of the second network. The wireless device may fail to gain access to the second network. The wireless device may deregister from the first network and re-attempt access to the second network via yet another network. This may lead to waste of resources and increase in signaling overhead.

In example embodiments, a wireless device may send, to a first network (e.g., a mobility management function of the first network), a registration request. The first network may send, to the wireless device, a registration accept message. The registration accept message may indicate that the first network provides access support for a second network. For example, the registration accept message may indicate that the first network provides onboarding support and/or underlay support for access to the second network. The wireless device may send, to the first network and based on the indication of access support, a request to establish a session with the first network. Following this procedure, the wireless device may improve the probability that the wireless device will gain access to the second network via the first network, thereby conserving resources and decreasing signaling overhead.

In existing technologies, a wireless device may be required to perform onboarding procedure using an onboarding network (ON) to access a provisioning server. A wireless device may be required to perform onboarding procedure using an onboarding network (ON) to access a provisioning server. The provisioning server may provide credentials to the UE to access a SNPN (or another network that belongs to an organization). During initial access and registration to the ON, the wireless device may successfully register to the network. The network may not support onboarding. When the wireless device performs a PDU session establishment procedure for onboarding, the PDU session establishment request may not be accepted when the network does not support onboarding.

Example embodiments comprise implementation of signaling from the network to the wireless device to indicate support for onboarding when a registration request is accepted. The wireless device may be able to request a PDU session for onboarding when the wireless device is configured with onboarding parameters and when the network supports onboarding. The network (AMF, RAN, and/or the like) may provide an indication to the wireless device that onboarding is supported. The indication may be an onboarding support indication information element (IE) during a registration accept message. The registration accept message may comprise an access category (e.g., operator defined access category, or a standardized access category) dedicated to the onboarding. When upper layers of the wireless device determine to access the network for onboarding, the access category may be employed to determine an RRC establishment cause. The access category may be employed as an indication in RRC messages to indicate a request for onboarding. The access category may be employed as an indication in NAS messages to indicate a request for onboarding.

Existing technologies may support access of the wireless device to a second network via a first network. When the first network is employed to access the second network e.g., via an interworking node (N3IWF) of the second network, the first network may act as an underlying network to enable the wireless device to connect to the N3IWF. During initial access and registration to the first network, if the first network does not indicate to the wireless device whether the underlying network capability e.g., for network 2, the SNPN, and/or the like is supported or not supported, the wireless device may not successfully establish a PDU session for an IPSec connection to the N3IWF and the procedure of connecting and accessing the overlay network or the second network (via N3IWF) may fail. Access of the wireless device to network 2 via network 1 may incur additional signaling due to the wireless device being required to select another network or AMF that supports the underlying network capability.

In an example embodiment, an AMF of a first network may receive (via NEF or an interworking function, exposure function, and/or the like) from an AMF of a second network an interworking support request or an interworking support indication. In an example, the base station may receive a configuration message from the AMF of the first network indicating underlying network capability for the second network SNPN. The AMF of the first network may receive (via NEF or an interworking function, exposure function, and/or the like) from the AMF of a second network, an onboarding support request/indication. The configuration message may comprise the onboarding support indication, SNPN ID, the underlying network capability (support) indication, and/or the like. The first network may determine based on an element of the configuration message, the interworking support request, onboarding support request, and/or the like to indicate support for onboarding, underlying network capability, and/or the like via a registration accept message.

Example embodiments comprise implementation of signaling from the wireless device to the base station wherein the first network may indicate to the wireless device via a registration accept message that the network may support underlying network capability (underlying network access) e.g., for network 2, the SNPN, and/or the like. The registration accept message may an identifier of network 2, the SNPN, and/or the like for which the underlying network capability may be supported. In an example embodiment, the underlying network capability may be SNPN interworking support, SNPN signaling proxy support, SNPN overlay or underlay support, and/or the like.

Example embodiments may comprise receiving by a base station of the first network, the configuration message, the underlying support indication, onboarding indication, and/or the like. The base station may send or broadcast system information to one or more wireless devices. The base station may broadcast system information block, SIB, SIB1, and/or the like. The SIB1 massage or an element (IE) of the SIB1 may comprise onboarding support indication (flag), onboarding support information e.g., via a specific CAG, S-NSSAI, DNN, and/or the like. The SIB1 may comprise one or more CAG IDs, S-NSSAIs, DNNs, and/or the like that wireless device may employ for onboarding. The SIB1 may comprise an IE indicating that access to the ON may be restricted to a certain time period such as expiry time. For example, upon initial access of the wireless device to the network for onboarding, a timer may start (e.g., by the first network) and upon elapsing the time=time period, access of the wireless device may be barred or denied.

Example embodiments may comprise transmission of onboarding capability support indication of a first network, onboarding capability support indication of the first network for a second network, support indication for accessing a provisioning server for providing credentials for the UE to access the second network, indication of support for underlying network behavior to enable the UE access the second network via a PDU session of the first network based on an IPSec tunnel to an N3IWF of the second network, and/or the like by the first network to the UE. The transmission may be via RRC messages, NAS messages, MM-NAS, SM-NAS, registration accept message, and/or the like. In an example embodiment, the indication (e.g., onboarding capability support indication of a first network, onboarding capability support indication of the first network for a second network, support indication for accessing a provisioning server for providing credentials for the UE to access the second network, indication of support for underlying network behavior to enable the UE access the second network via a PDU session of the first network based on an IPSec tunnel to an N3IWF of the second network, and/or the like) may be employed by the UE to determine whether to access the network and establish a PDU session for onboarding or underlying network access. The transmission may further comprise transmission of parameters that may be employed by the UE to determine parameters during registration request procedure, PDU session establishment procedure, service request procedure, and/or the like.

In an example, FIG. 23 may depict an example registration and access procedure of a UE to the first network (network 1) in accordance with embodiments of the present disclosure. In an example, the UE may send a registration request message or a NAS message to the AMF via a base station of the first network. Upon completion of the registration procedure, the AMF may send a registration accept message to the UE that may comprise a support indication for IPSec with the second network, an underlying network capability support indication, one or more network IDs (e.g., SNPN ID). The one or more network IDs may indicate that the network may support underlying network capability for the one or more networks e.g., SNPN. The one or more network IDs may indicate that the network supports onboarding for the one or more networks. The registration accept message may comprise a CAG ID, S-NSSAI, and/or the like that may be employed for underlying network capability support, or IPSec tunnel to the second network. The UE may employ an element of the registration accept message to send a PDU session establishment request message. The PDU session establishment request message may comprise the CAG ID for underlying network access to the second network via the first network, the S-NSSAI for underlying network access to the second network via the first network, and/or the like. Upon establishment of the PDU session for underlying network access, the UE may establish or configure a connection, IPSec tunnel, and/or the like to an interworking function (N3IWF) of the second network. In an example, during the PDU session establishment procedure the SMF of the first network may select a UPF that can be connected to or have a logical/physical connectivity to the N3IWF of the second network. The SMF may select the UPF that may support underlying network capability.

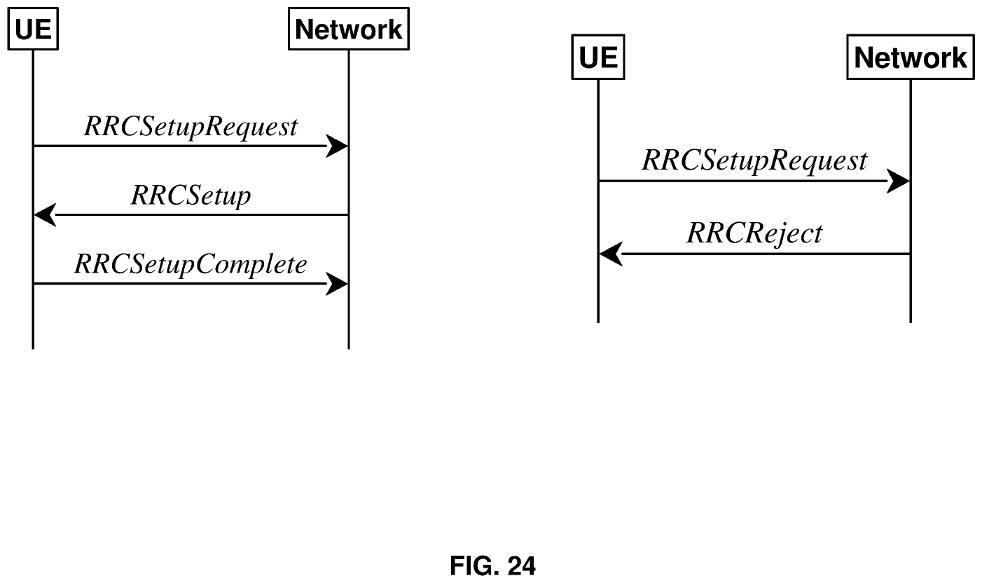

FIG. 24 illustrates a diagram comprising a wireless device, a network (e.g., RAN node). FIG. 24 depicts an example RRC connection procedure. RRC connection procedure may comprise sending an RRC setup request message upon completion of random access procedures. The purpose of this procedure is to establish an RRC connection. RRC connection establishment involves SRB1 establishment. The procedure may also be employed to transfer the initial NAS dedicated information/message from the UE to the network.

The network applies the procedure e.g., as follows: When establishing an RRC connection; When UE is resuming or re-establishing an RRC connection, and the network is not able to retrieve or verify the UE context. In this case, the UE may receive RRCSetup and responds with RRCSetupComplete. The UE may initiate the RRC connection establishment procedure when upper layers request establishment of an RRC connection while the UE is in RRC_IDLE and it has acquired essential system information, or for sidelink communication.

The UE may determine that system information is valid and up to date. The UE may determine that access to the network is not barred, the UE may send an RRCSetupRequest message. The UE may receive an RRC setup message from the network. The UE may receive an RRC reject message by the network.

In an example embodiment as depicted in FIG. 24, the wireless device (UE) may attempt to access to the network. The attempt to access the network may comprise an RRC connection establishment procedure, a service request procedure, RRC resume procedure, and/or the like. The RRC connection establishment may be employed to establish an RRC connection. RRC connection establishment may comprise establishment of a signaling radio bearer e.g., SRB1 establishment. The procedure may be employed to transfer the initial NAS dedicated information/message from the UE to the network. The network may apply the procedure when establishing an RRC connection, when UE is resuming or re-establishing an RRC connection, and the network is not able to retrieve or verify the UE context, and/or the like. In an example, the UE may receive RRCSetup and may respond with RRCSetupComplete message. The RRC connection establishment may comprise reception of an RRC reject message by the wireless device (UE) from the network.

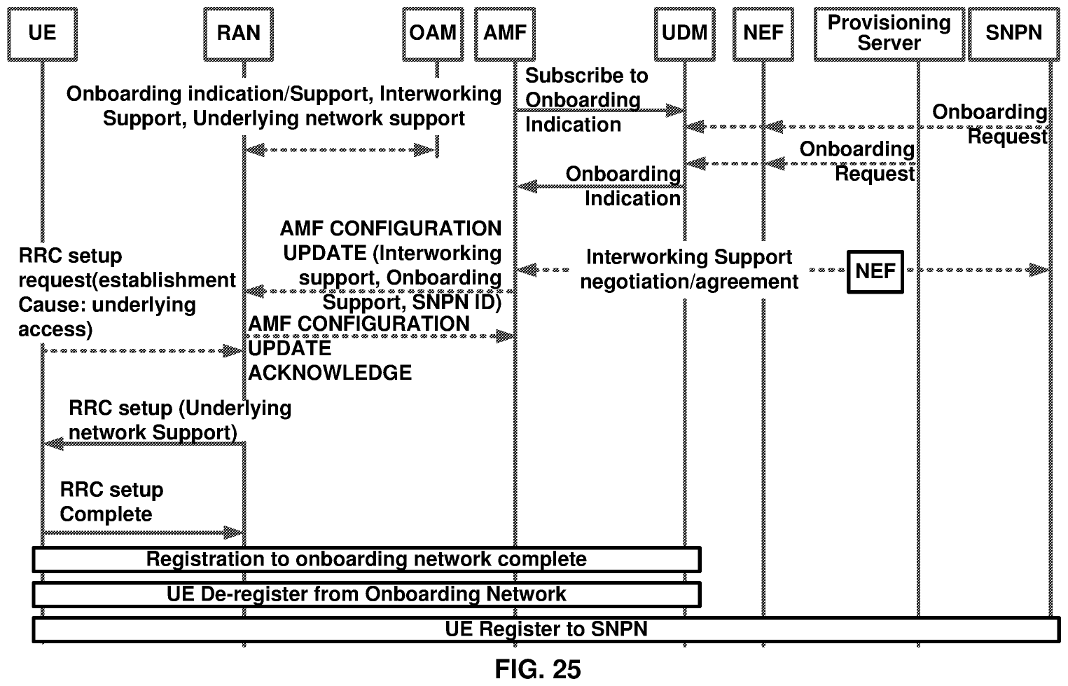

In an example embodiment as depicted in FIG. 25, a UE may send to a base station (RAN node, NG-RAN, gNB, and/or the like) of a first network, a radio resource control (RRC) message comprising a standalone non-public network identifier (SNPN ID) of a second network. The RRC message may be an RRC setup request message (message 3 of RRC). The RRC message may comprise a cause value e.g., RRC establishment cause. The cause may be underlying access. The cause may indicate that access to the first network may be for establishment of an IPSec tunnel or connection to the second network via the N3IWF of the second network. The RRC message may be an RRC setup complete message. The RRC message may be an RRC setup request message. The RRC message may comprise a SNPN ID of the second network. In an example, the base station or the AMF of the first network may receive an onboarding indication or an interworking support request/indication from a network node or element of the second network (e.g., via NEF). In an example, the base station may determine that underlying access to the second network is supported and may send an RRC setup message. In an example, the base station may determine that underlying access to the second network is not supported and may send an RRC reject message. In an example, the base station may determine that onboarding to the second network with SNPN ID is supported and may send an RRC setup message. In an example, the base station may determine that onboarding to the second network with SNPN ID is not supported and may send an RRC reject message. In an example, the RRC message may be a registration request message. The base station may send an N2 message to the AMF of the first network. Upon completion of the procedure (e.g., registration procedure) the UE may receive a response message from the AMF e.g., a registration accept message that may comprise an indication that onboarding is supported (e.g., for the SNPN ID), underlying network capability (access) is supported (e.g., for the SNPN ID), and/or the like. In an example, the UE may receive from the AMF of the first network, a first message indicating acceptance of registration with the first network. The first message may be a registration acceptance message. In an example, the UE may send to the AMF of the first network a second message to establish a packet data unit (PDU) session. The second message may be a PDU session establishment request message, a NAS message, and/or the like. The PDU session establishment request may comprise an onboarding indication, an underlying network PDU session type, request type indicating that the PDU session request is for IPSec connection/tunnel with the second network or the N3IWF of the second network, and/or the like. The PDU session establishment request may comprise a PDU session type indicating an onboarding PDU session. The PDU session establishment request may comprise a request type indicating onboarding (request type=onboarding).

In an example embodiment, the RRC message may comprise the SNPN ID. In an example the RRC message may comprise an onboarding indication. The RRC message may be an RRC setup complete message (message 5). In an example, the RRC message may be an RRC setup request message (message 3). In an example, the RRC setup request message may comprise an RRC establishment cause indicating underlying network access, underlying network capability, IPSec access to an N3IWF, the SNPN ID, and/or the like.

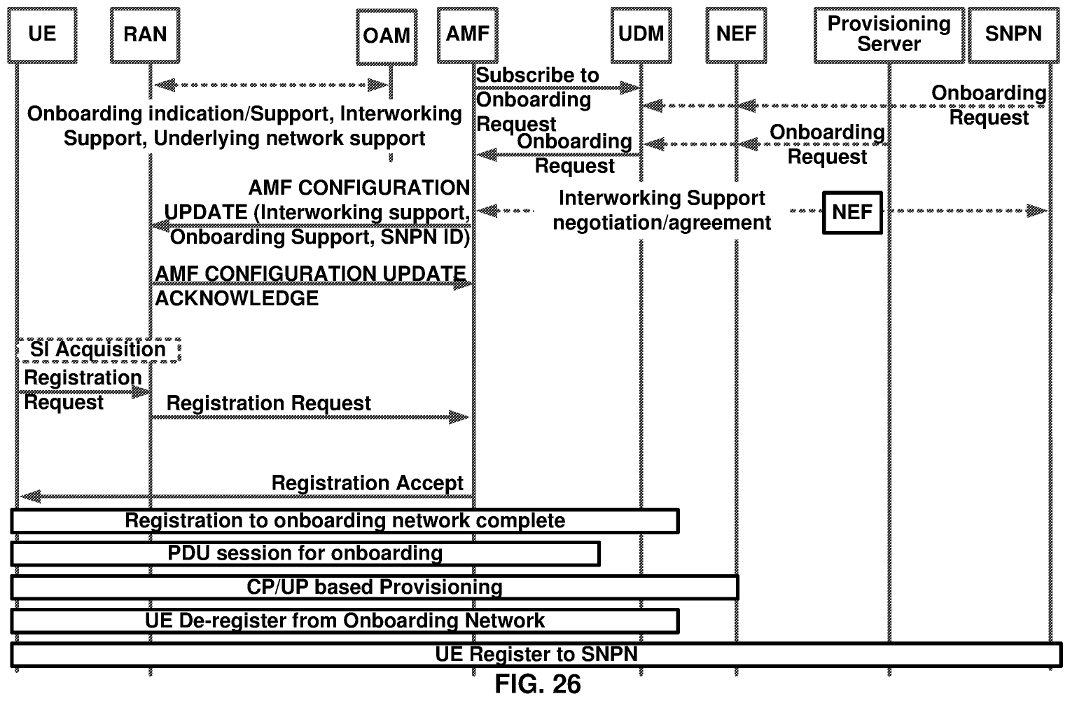

In an example embodiment as depicted in FIG. 25 and FIG. 26, the AMF, which the UE camp on, may subscribe to a UDM about Onboarding information. The provisioning server can be triggered to initiate the onboarding procedures by some events. The provisioning server may send the onboarding request to NEF, which includes the onboarding information (the GPSI of the target UE, subscription credentials to access SNPN, DNN/NSSAI used to access SNPN), and optional Triggering Events. The onboarding information may be protected by a default UE credential which is also pre-configured in the UE (USIM). The UE may determine which default UE credentials are applied for protection (optionally via SNPN identity or default UE credential identity). The NEF may relay the onboarding request to the UDM which stores the target UE's subscription based on the GPSI. The AMF may subscribe the triggering events to the serving AMF for the target UEs via Nudm_SDM_Notification message. The UDM may send the onboarding response to the NEF and then the NEF may transfer to provisioning server. In an example, when the AMF receives a notification of onboarding from the UDM indicating onboarding support for the SNPN, the AMF may send an AMF configuration update message to the RAN nodes.

In an example embodiment as depicted in FIG. 26, the AMF may receive onboarding indication or notification from the network (UDM). In an example, the AMF may receive an interworking support indication from a network element of the second network (SNPN). The indication may be a result of a negotiation procedure wherein the SNPN may request an establishment of a proxy for the AMF of the second network (SNPN) in the AMF of the first network. Upon successful setup of the proxy, the AMF of the first network may indicate to the ARN node of the first network that underlying network capability (access) for the second network is supported. The AMF may send the AMF configuration update message to the base station that may comprise the underlying network capability, interworking support with the second network, and/or the like. In an example, the base station (RAN) may receive an onboarding support indication from an OAM (OA&M) network element, NWDAF network element, and/or the like of the network. In an example, the base station upon receiving the onboarding support indication or onboarding support indication for one or more SNPNs, the base station may broadcast system information. The base station may broadcast SIB such as SIB1. The system information may indicate that the network or the RAN node, base station or one or more cell of the RAN node may support onboarding. In an example, the SIB1 may comprise an indication that underlying network capability may be supported. In an example, the underlying network capability may be supported via a CAG ID for underlying network access, via a S-NSSAI for underlying network access, and/or the like. The SIB1 may comprise the CAG ID, S-NSSAI, and/or the like for underlying network access. The CAG may restrict underlying access or onboarding access via one or more cells. The S-NSSAI may be employed to determine a UPF or network resources for access to the second network, onboarding, and/or the like. The UPF may be assigned or determined based on the S-NSSAI and the UPF may have connectivity with the N3IWF of the second network (SNPN).

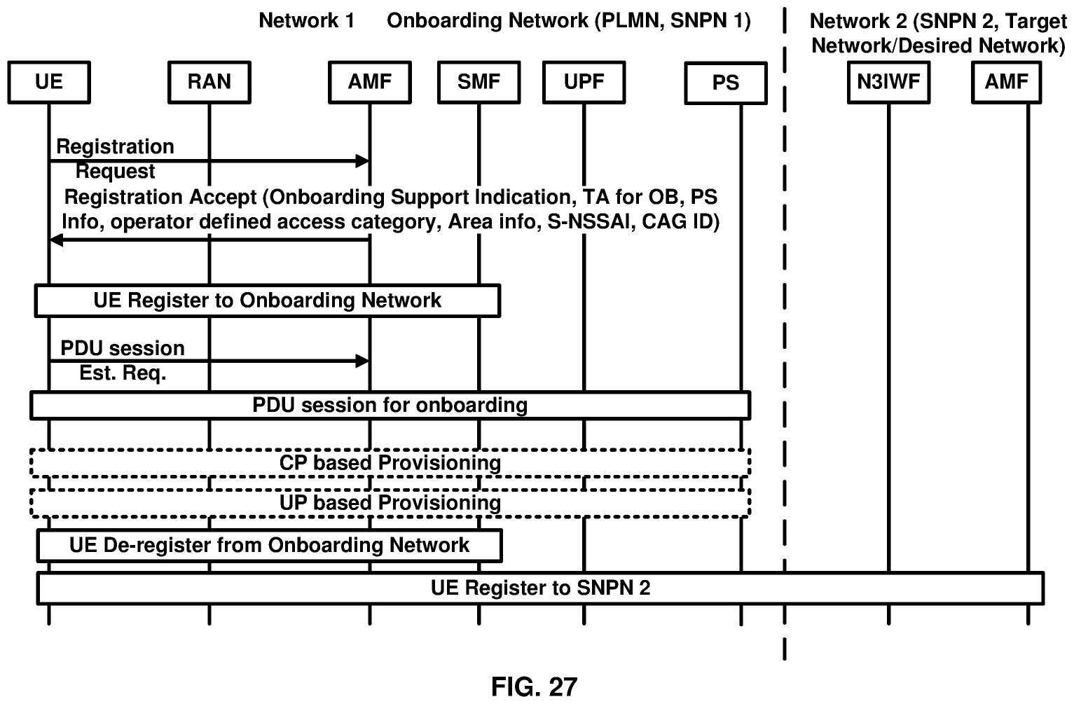

FIG. 27 illustrates a call flow of a procedure for a registration request procedure performed for a wireless device (UE) in accordance with embodiments of the present disclosure. In an example embodiment, the UE may send to a base station of the first network, a registration request message. In an example, the UE may receive an AMF (of the first network), a registration accept message. The registration accept message may comprise an onboarding support indication for a second network (a SNPN 2). The registration accept message may comprise an operator defined access category or an access category. The access category may be employed by the UE to determine an element of a NAS message, determining an establishment cause for onboarding access requests, and/or the like. The registration accept message may comprise a provisioning server (PS) information, PS address, and/or the like. The provisioning server may be the PS that has an agreement with the SNPN 2 for onboarding and provisioning of UEs and to provide credentials to the UEs to access the SNPN 2. The registration accept message may comprise tracking area information for onboarding of the UE. The registration accept message may comprise location information or area information for onboarding of the UE where the UE is allowed to perform onboarding. The registration accept message may comprise a CAG ID, S-NSSAI, DNN, and/or the like dedicated to onboarding. For example, the first network may allow access via a specific CAG ID for onboarding. The network may allocate certain network resources and assign a S-NSSAI for onboarding. In an example, the UE may send to the AMF and based on the onboarding support indication, a message to establish a packet data unit (PDU) session. The message may comprise an indication that the PDU session is for onboarding of the UE for the second network or the SNPN 2. In an example embodiment, the AMF of the first network may receive from a UDM, a first message indicating that the first network supports onboarding for the second network (e.g., the SNPN 2). The AMF may receive from the UE, the registration request message. The AMF may send to the UE and in response to the registration request message, the registration accept message indicating that the first network supports onboarding for the second network.

FIG. 27 illustrates a call flow of a procedure for a registration request procedure performed for a wireless device (UE) in accordance with embodiments of the present disclosure. The registration request procedure may be for an onboarding network. Upon successful registration to the onboarding network (ON), the UE may perform a PDU session establishment procedure. The PDU session establishment procedure may be for onboarding of the UE. The UE may access a PS via the PDU session (e.g., onboarding PDU session) to receive credentials for a target network, desired network, a SNPN, SNPN 2, and/or the like. The PDU session may be employed for provisioning of parameters and credentials to the UE for accessing and registering to the SNPN. The provisioning may be over a user plane or a control plane of the PDU session. Upon successful provisioning, the UE may deregister from the ON, and register to the SNPN based on the received parameters and credentials. An example of a registration procedure is depicted in FIG. 8 and FIG. 9.

In an example as depicted in FIG. 27, during the registration procedure, the UE may send to a RAN node (base station) a registration request message. The registration request message may be or may comprise an AN message. In an example embodiment, the registration request message may be the RRC setup complete message. The registration request message may comprise an identifier of a second network (e.g., a SNPN ID, second network ID, and/or the like). In an example, the second network may be a target network, desired network, a SNPN, and/or the like. The registration request message (or the AN message) may comprise AN parameters, registration request (registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [UE Policy Container (the list of PSIs, indication of UE support for ANDSP and the operating system identifier)] and [UE Radio Capability ID], PEI). In the case of NG-RAN, the AN parameters may comprise 5G-S-TMSI or GUAMI, the Selected PLMN ID (or PLMN ID and NID) and Requested NSSAI, the AN parameters may comprise Establishment cause. The Establishment cause may provide the reason for requesting the establishment of an RRC connection. Whether and how the UE includes the Requested NSSAI as part of the AN parameters may be dependent on the value of the Access Stratum Connection Establishment NSSAI Inclusion Mode parameter.

In an example the registration accept message may comprise 5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [rejected S-NSSAIs], [Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [Truncated 5G-S-TMSI Configuration]).

In an example, the operator-defined access category definitions may comprise IEs that indicate a definition and mapping information for an access category and criteria for selecting the access category. The criteria may comprise DNN type, OS id+OS App Id type, S-NSSAI type, LADN, Area information (valid for onboarding), Request type: Onboarding, Provisioning Server Access for onboarding, tracking area, and/or the like. The upper layers of the UE may determine an access category based on one or more criteria/criterion. In an example the supported network behavior may indicate a network behavior such as onboarding or access to an overlay network, acting as an underlay network, and/or the like.

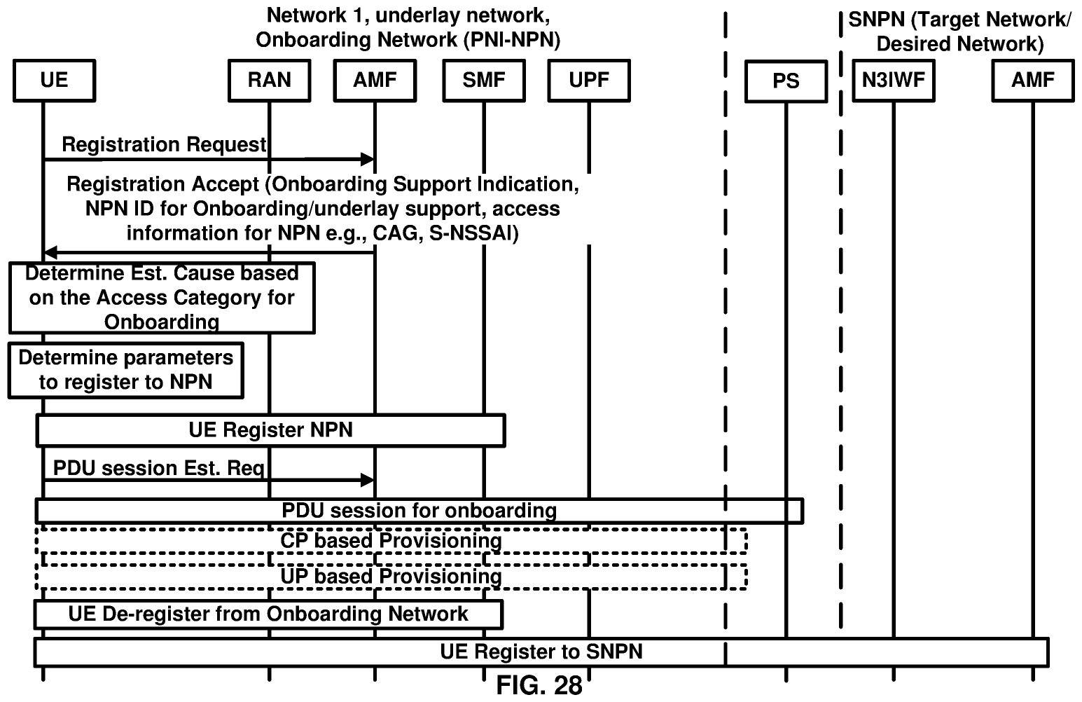

FIG. 28 illustrates an example of the registration procedure in accordance with embodiments of the present disclosure. In example FIG. 28, the first network may implement the onboarding network or the underlying network part with a PNI-NPN wherein an NPN network may be integrated in the network. The NPN part of the network may be identified with a NID, NPN ID, a combination of PLMN ID (Network 1 ID) and the NID, and/or the like. Access to the integrated NPN may be restricted via a certain CAG and/or S-NSSAI. The UE may receive a registration accept message in response to sending a registration request message. The registration accept message may comprise onboarding support indication, undelay network capability, CAG information to access the integrated NPN for onboarding or underlay network support, S-NSSAI information to access the integrated NPN for onboarding or underlay network support, NPN ID or NPN information to access the integrated NPN for onboarding or underlay network support. The IE of the registration accept message may comprise an indication for IPSec (tunnel) connectivity to the SNPN based on the configuration. In an example, the registration accept message may be a UE configuration update UCU message. UCU may comprise a URSP. The URSP may comprise onboarding support indication, undelay network capability, CAG information to access the integrated NPN for onboarding or underlay network support, S-NSSAI information to access the integrated NPN for onboarding or underlay network support, NPN ID or NPN information to access the integrated NPN for onboarding or underlay network support, and/or the like. The URSP may comprise an address of the N3IWF for the second network.

In an example, the network may determine, discover, select an AMF that may support connectivity of the UE to the second network via the IPSec tunnel/connection. The selected AMF may employ or may be configured with a proxy of an AMF of the second network, or an interworking function (N3IWF) of the second network (SNPN).

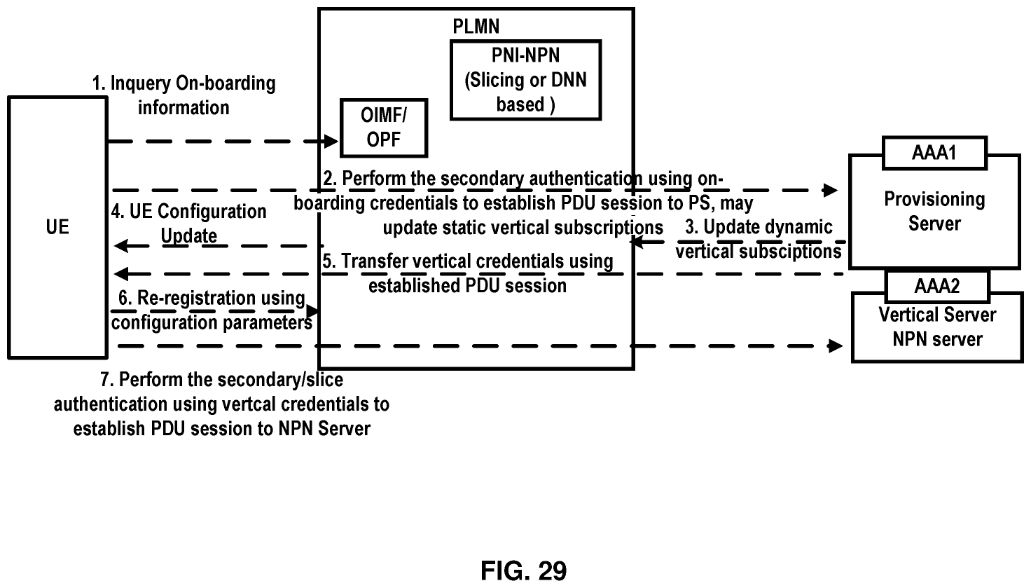

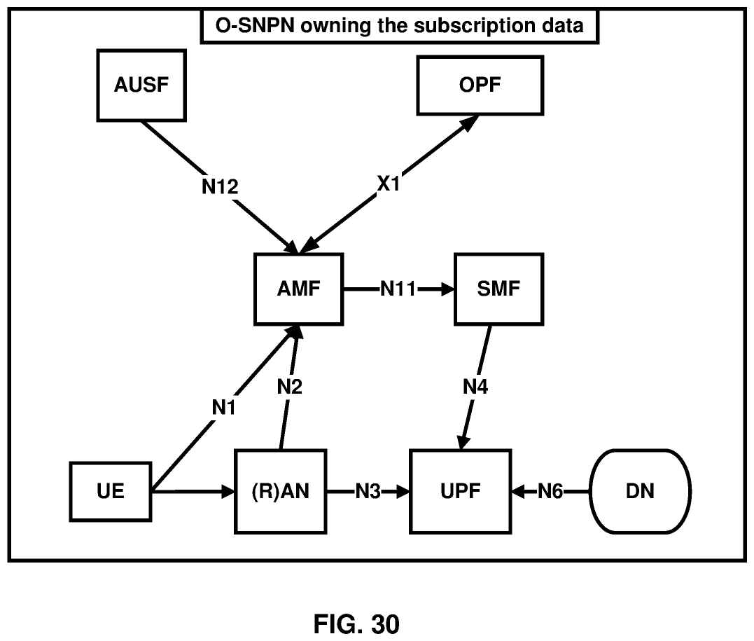

In an example embodiment a configuration as depicted in FIG. 29 and FIG. 30 may enable UEs to get network connectivity so that it can be provisioned with necessary information for access to a PNI-NPN and vertical networks attached to the PNI-NPN. The UE is provisioned with the public subscription/credentials of UE side for accessing to PLMN. The UE may be provisioned with the on-boarding credentials for secondary authentication to grant access to Provisioning Server. The on-boarding credentials may be provisioned during manufacturing process, or may be input by the user. The UE may be provisioned with vertical credentials for secondary/slice authentication to grant access to the vertical network attached to a PNI-NPN. The UE may be provisioned with UE configuration (e.g. Mobility Restriction, URSP, etc.) for CAG selection or DNN/NSSAI selection. The PLMN may be pre-configured with public subscription/credentials of network side which include at least the minimum set of contents which common public UE owns, e.g., UE identifiers and associated security credential, optionally support indication and valid period for the on-boarding registration. The PLMN may be pre-configured with static vertical configurations (e.g. subscription owner (SO) DNN, SO NSSAI) which may comprise part of subscriptions of UEs allowed for on-boarding and accessing to the vertical DN via the PNI-NPN. Vertical enterprises may sign agreement with PLMN for static vertical subscriptions assignment. The PLMN may be pre-configured with Provisioning Server Routing Information (e.g. PS DNN, PS NSSAI, allowed PS and/or PS AAA address list, port ID, SMF selection subscription data, allowed number of PDU Session for provisioning per UE and QoS) which may be used to trigger the on-boarding authentication and establish connectivity to the expected Provisioning Server. An OIMF (On-boarding Information Mapping Function) may be pre-configured with mapping information of PNI-NPN ID (e.g., CAG ID) and Provisioning Server Routing Information. PS AAA may be provisioned with the onboarding credentials to authenticate the UE for on-boarding. The on-boarding credentials may be provisioned via out-of-band way, e.g., via application. Provisioning Server may be provisioned with the dynamic vertical configurations (e.g. updated CAG information, updated QoS) based on UE granularity, which can constitute part of subscriptions of UEs allowed for on-boarding and accessing to the vertical DN via the PNI-NPN. Provisioning Server may be provisioned with the vertical credentials (e.g. N3GPP credential) for updating NPN credentials of UEs that are allowed for onboarding. As depicted in FIG. 30, a configuration comprising an Onboarding and Provisioning Function (OPF) may enable the UEs without the subscription data to access to the Onboarding SNPN (O-SNPN) to obtain the full provisioning data from the home network owning the UE's subscription data. So that the provisioned UE can normally access to the desired network services. The presence of the Onboarding and Provisioning Function (OPF), which stores both the default configuration and provisioning data for the UE, and to provide onboarding authentication and authorization between UE and OPF. The OPF may be located inside of O-SNPN, or outside of O-SNPN.

In an example, A UE may enquire onboarding information. The UE may register to the PLMN using the public subscription/credentials and primary authentication may be performed. The UE either manually or automatically discovers and selects the PNI-NPN ID for UE on-boarding (e.g. CAG ID) based on the broadcast information. Then the UE may request the OIMF for the Provisioning Server Routing Information (e.g. PS DNN, PS NSSAI, allowed PS and/or PS AAA address list, port ID) using PNI-NPN ID via NAS message. If support indication for the onboarding registration is included in the public subscription, the PLMN may provide the UE with the restricted registration and PDU Session for limited services based on the valid period in the public subscription, and extra restriction information involved in Provisioning Server Routing Information (e.g. SMF selection subscription data, and allowed number of PDU Session for provisioning per UE, allowed PS address list and QoS). In an example, the registration request message, the RRC message, the RRC setup complete message, and/or the like may comprise an OIMF ID, OPF ID, SNPN ID, an indication that the request may be for an OIMF/OPF, and/or the like.

In an example, the UE may select the slice or DNN to access PS according to Provisioning Server Routing Information. The UE may re-register to the PLMN using selected slice. The UE may perform onboarding authentication via 5GC with PS AAA using the onboarding credentials, potentially reusing the secondary authentication procedure, which triggered by SMF, to realize the onboarding authentication. When the UE has been successfully authenticated, the PLMN subscription may be updated, including static vertical subscriptions and dynamic vertical credentials. The static vertical subscription (e.g. SO DNN, SO NSSAI) may be preconfigured in PLMN based on the agreement between PLMN and vertical. By using the on-boarding authentication, the 5GC can be aware of authentication result. If the authentication is successful, the 5GC authorizes the UE, and updates UE's subscriptions according to pre-configured static vertical subscriptions. The dynamic vertical subscription (e.g. updated CAG information, updated QoS) may be the information that Vertical intends to revise to UE's subscription. The PLMN may reject the update of dynamic vertical subscriptions. If the provisioning is successful, the provisioning server may transfer the UE's dynamic vertical subscriptions (e.g. updated CAG information, updated QoS) to the PLMN via NEF, and the PLMN may update UE's subscriptions for dynamic vertical subscriptions. The PS may provision the UE configuration parameters to the PLMN and vertical credentials to UE. When UE configurations are updated, the PLMN may update UE configurations to the UE by triggering the UE Configuration Update procedure. Upon successful onboarding authentication, the UE may be authorized to establish the PDU session to access the PS and the PS may provision the vertical credentials to the UE by the established user plane path and via the PDU session. The UE may reuse existing N3GPP credential management protocol with the PS. For example, to reuse CMPv2 protocol to ask CA for signing a vertical's certificate. The credential may be stored in either the UE (ME) or UICC. The UE may access the NPN using UE configuration parameters and vertical credentials. After the provisioning procedure, the UE may perform re-registration procedures using UE configuration to reselect CAG ID, slice and DNN, and may establish a PDU session with suitable QoS. When the UE requests to access the vertical server, the PLMN may trigger secondary/slice authentication, the UE uses vertical credentials to process the authentication. Upon a successful procedure the UE may initiate regular services to the vertical network via the PNI-NPN. During the procedure, if the secondary authentication fails and/or a valid period expires, the PLMN may trigger a network-initiated de-registration.

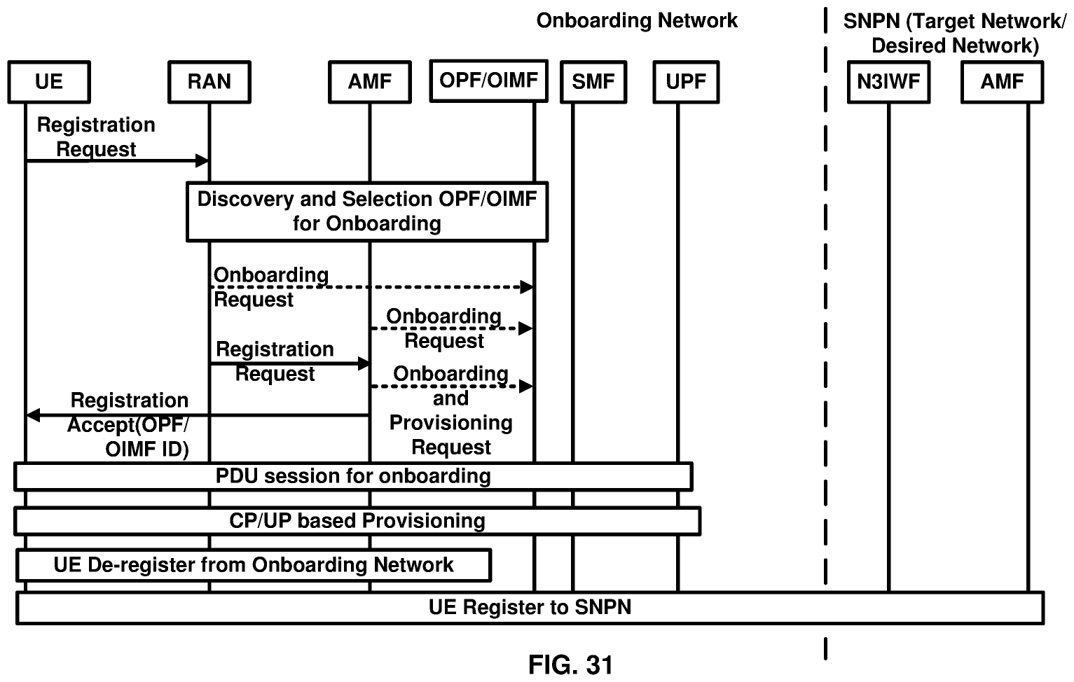

FIG. 31 illustrates a call flow of a procedure for registration and access to an ON performed for a wireless device (UE) in accordance with embodiments of the present disclosure. The UE may send a registration request procedure to a RAN node. The registration request procedure may be an RRC message, RRC setup complete message, and/or the like. The registration request message may comprise a SNPN ID, a target network ID, and/or the like. The registration request message may comprise an onboarding indication. The registration request message may comprise an identifier of an OPF (OPF ID), OIMF ID, and or the like. In an example, the SNPN ID, onboarding indication, OPF ID, OIMF ID, and/or the like may be included in the NAS message container of the registration request message. In an example, the SNPN ID, onboarding indication, OPF ID, OIMF ID, and/or the like may be included in the RRC setup complete message. In an example, the UE may register to the ON. In an example, the network (the AMF, RAN node, and/or the like) may determine that the OPF ID or the OIMF ID may not be valid, or missing from the registration request message. The network (AMF or RAN) may send a registration accept message with an indication that onboarding may be supported. In an example, the registration accept message may comprise the OPF ID, OIMF ID, and/or the like. The UE may send a (re-) registration request message comprising the new OPF ID, or the new OIMF ID.

The UE may send a PDU session establishment request message, a service request message, and/or the like. In an example, the UE may send a NAS message to the AMF (MM-NAS) via the RAN node. The NAS message may be sent from the UE to the SMF (e.g., SM-NAS). In an example, the NAS message may be the PDU session establishment request message, the service request message, the registration request message, and/or the like. In an example, the NAS message may comprise the OPF ID, OIMF ID, target SNPN ID, and/or the like.

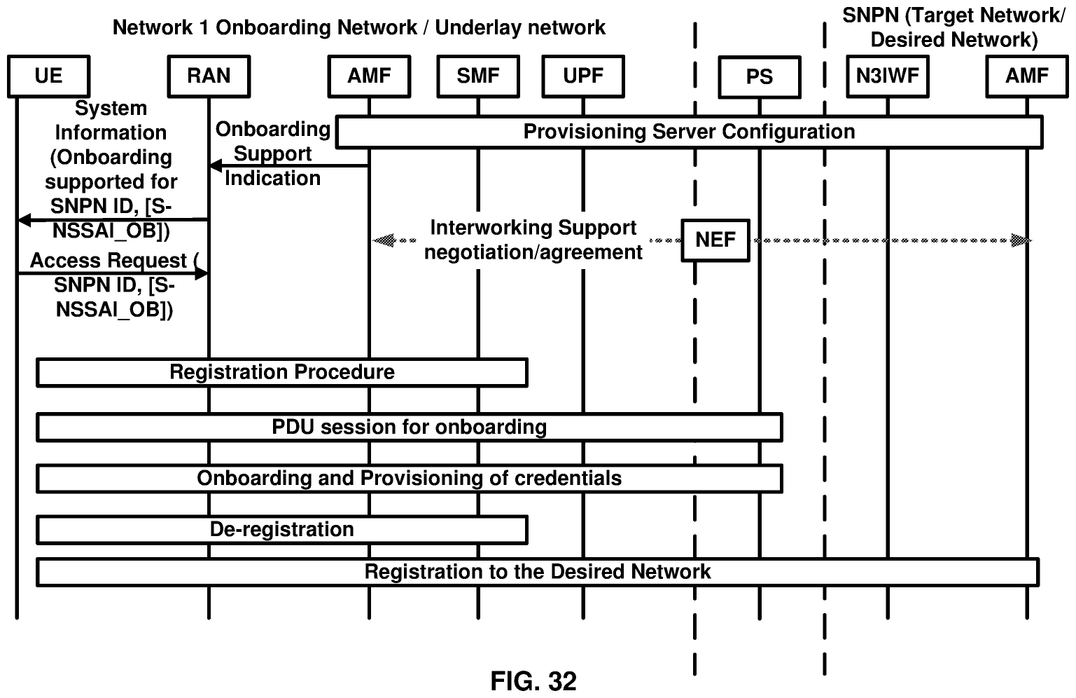

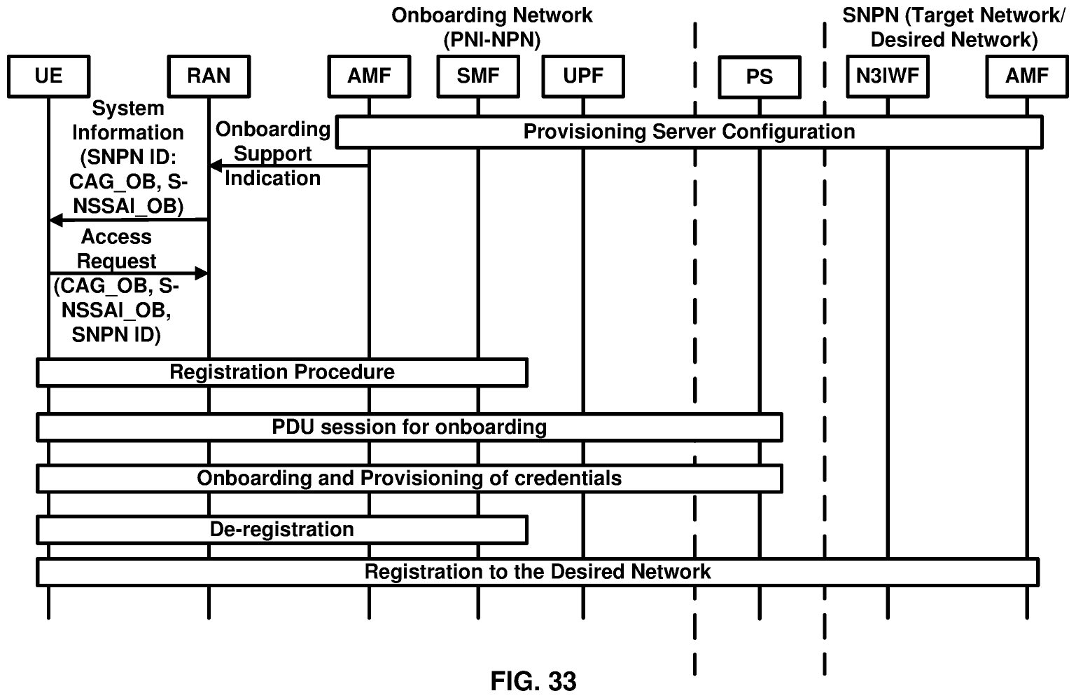

FIG. 32 and FIG. 33 illustrate a call flow of a system information acquisition performed by the network in accordance with embodiments of the present disclosure. In an example, the RAN node or the AMF of the first network may receive configuration or indication of onboarding support or request from a UDM or PS or a second network. In an example, the RAN node or the AMF of the first network may receive the interworking support indication from a network node of the second network (target network) indicating an underlying network support towards the second network. The AMF may send a configuration update message to the RAN node. The RAN node may receive an indication for onboarding support of underlying network support from an OA&M network node. In an example, the RAN node may send a SIB message or broadcast system information via SIB1.

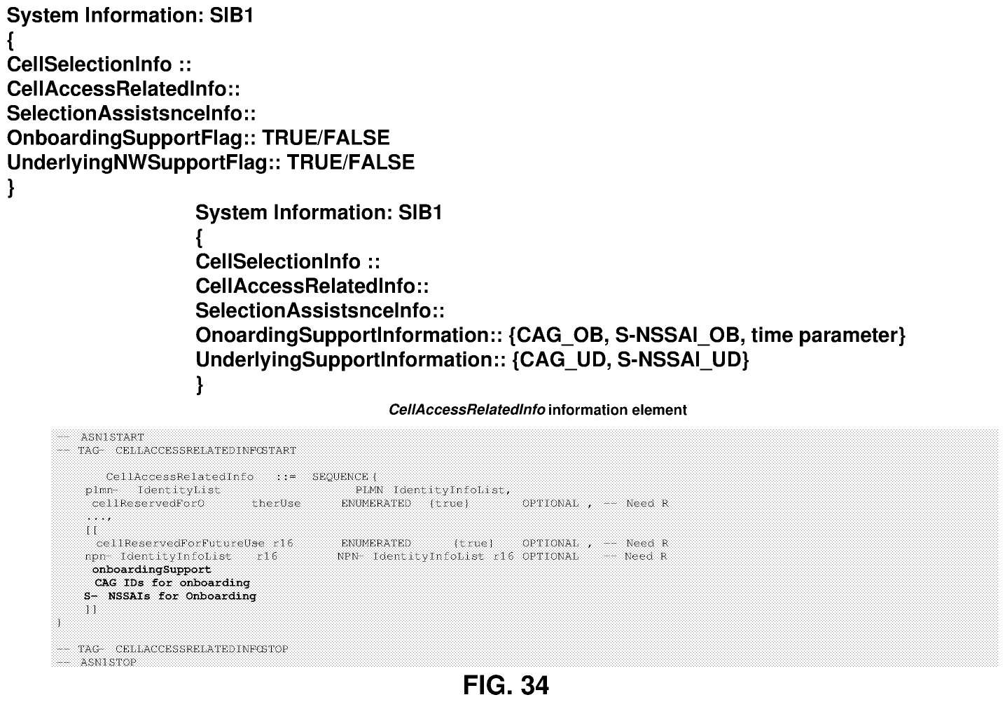

In an example as depicted in FIG. 34, SIB1 may comprise an onboarding support indication flag indicating whether or not onboarding is supported by the network (e.g., the RAN node, cells of the RAN node, the AMF, and/or the like). The SIB1 may comprise onboarding support information that may comprise a CAG ID that can be employed for onboarding, a S-NSSAI that can be employed for onboarding. In an example, time parameter may indicate that onboarding access is restricted to certain time period.

In an example as depicted in FIG. 34, SIB1 may comprise an underlying network support indication flag indicating whether or not the underlying network capability is supported by the network (e.g., the RAN node, cells of the RAN node, the AMF, UPF and/or the like). The SIB1 may comprise underlying network support information that may comprise a CAG ID that can be employed to access the NPN that provides access to the overlay network via the N3IWF, a S-NSSAI that can be employed for accessing the overlay network via a UPF that has connectivity with the N3IWF of the overlay network.

In an example embodiment, SIB1 may be employed by the UE for cell selection when the UE determines to access the first network for onboarding or for accessing as undelay network towards the second network.

In an example embodiment, the registration accept message may comprise mobility restriction information for onboarding or mobility restriction information for underlying network capability. Mobility restrictions for onboarding or underlying network access may restrict mobility handling or service access of the UE when the UE employs the network for onboarding or underlying network capability to access the second network. The mobility restriction functionality may be provided by the UE (for mobility restriction categories provided to the UE), the radio access network and the core network. mobility restrictions may apply to 3GPP access and wireline access, and/or to non-3GPP accesses. Service Area restrictions and handling of Forbidden Areas (for onboarding or underlying network access) for CM-IDLE state and, for CM-CONNECTED state when in RRC Inactive state may be executed by the UE based on information received from the core network. mobility restrictions for CM-CONNECTED state when in RRC-Connected state are executed by the radio access network and the core network. In CM-CONNECTED state, the core network may provide mobility restrictions to the radio access network within mobility restriction list. Mobility restrictions may comprise radio access technology (RAT) restriction, forbidden area, service area restrictions, core network type restriction and closed access group information. RAT restriction for onboarding or underlying network access may define the 3GPP radio access technology(ies), a UE is not allowed to access in a PLMN or the first network that is employed for onboarding or underlying network capability. In a restricted RAT the UE based on subscription may not be permitted access to the network for this PLMN (or the first network). For CM-CONNECTED state, when radio access network determines target RAT and target PLMN during Handover procedure, it may take per PLMN RAT restriction into consideration. The RAT restriction for onboarding or underlying network access may be enforced in the network, and not provided to the UE. In an example, in a forbidden area, the UE, based on subscription, may not be permitted to initiate any communication with the network for this PLMN or the first network. The UE behaviour in terms of cell selection, RAT selection and PLMN selection may depend on the network response that informs the UE of forbidden area. A forbidden area for onboarding or underlying network access may apply either to 3GPP access or to non-3GPP access. service area restriction may define areas in which the UE may or may not initiate communication with the network as follows:

Allowed Area for onboarding or underlying network access: In an Allowed Area, the UE may be permitted to initiate communication with the network as allowed by the subscription.

Non-Allowed Area for onboarding or underlying network access: In a Non-Allowed Area a UE may be service area restricted based on subscription. The UE and the network may or may not be allowed to initiate Service Request or SM signalling (except for PS Data Off status change reporting) to obtain user services (both in CM-IDLE and in CM-CONNECTED states).

Core Network type restriction for onboarding or underlying network access may determine/defines whether the UE is allowed to connect to 5GC only, EPC only, both 5GC and EPC for this PLMN or the first network. The Core Network type restriction when received may apply in the PLMN either to both 3GPP and non-3GPP Access Types or to non-3GPP Access Type only.

Closed Access Group information of onboarding or underlying network access may be employed for Public Network Integrated NPNs (PNI-NPN). PNI-NPNs are NPNs made available via PLMNs e.g. by means of dedicated DNNs, or by one (or more) Network Slice instances allocated for the NPN. The existing network slicing functionalities may apply. When a PNI-NPN is made available via a PLMN (the first network), then the UE may have a subscription for the PLMN in order to access PNI-NPN. As network slicing does not enable the possibility to prevent UEs from trying to access the network in areas where the UE is not allowed to use the Network Slice allocated for the NPN, Closed Access Groups may optionally be used to apply access control. A Closed Access Group may identify a group of subscribers who are permitted to access one or more CAG cells associated to the CAG. CAG may be employed for the PNI-NPNs to prevent UE(s), which are not allowed to access the NPN via the associated cell(s), from automatically selecting and accessing the associated CAG cell(s). CAG may be used for access control e.g. authorization at cell selection and configured in the subscription as part of the Mobility Restrictions e.g., independent from any S-NSSAI.

In an example, for a given UE, the core network may determine the mobility restrictions for onboarding or underlying network access based on UE subscription information, UE location and/or local policy (e.g. if the HPLMN has not deployed 5GC, HPLMN ID of the UE and the operator's policy are used in the VPLMN for determining the Core Network type restriction). The mobility restriction may change due to e.g. UE's subscription, location change and local policy. The service area restrictions or the non-allowed area may in addition be fine-tuned by the PCF e.g., based on UE location, PEI and network policies. Service area restrictions may be updated during a registration procedure or UE configuration update procedure. If the network sends service area restrictions to the UE, the network sends only either an allowed area, or a non-allowed area, but not both at the same time, to the UE. If the UE has received an allowed area from the network, any tracking area TA not part of the allowed area may be considered by the UE as non-allowed. If the UE has received a non-allowed area from the network, any TA not part of the Non-Allowed Area may be considered by the UE as allowed. If the UE has not received any Service Area Restrictions, any TA in the PLMN may be considered as allowed.

In an example embodiment, the presence of the underlying network capability in the registration accept message or a downlink NAS message (e.g., from AMF or SMF) may indicate that the network supports underlying network capability and the UE may access the target network SNPN (overlay network) via the first network (underlying network) and the PDU session of the first network may be employed to establish a connection to the second network via an interworking function such as the N3IWF. The presence of the target SNPN ID in the RRC message, or the NAS message may indicate that underlying network capability is required. An IPSec tunnel or an IPSec connection may be employed (e.g., based on IPSec tunnel or IPSec transport). Such capability or the underlying network capability may be SNPN interworking support, SNPN signaling proxy support, SNPN overlay or underlay support, and/or the like.

In an example embodiment, onboarding support of the network may be determined when a CP function such as the AMF, SMF, and/or the like receive a request from a NEF or OA&M or a configuration entity that the network may support onboarding.

In an example embodiment, onboarding support of the network may be determined when a CP function such as the AMF, SMF, and/or the like receive a request from a NEF or OA&M or a configuration entity that the network may support onboarding.

In an example, the capability indicating SNPN interworking support, SNPN signaling proxy support, SNPN overlay or underlay support, and/or the like, may indicate that the AMF of the underlay network (network 1) may establish a proxy for the AMF or signaling state or status of the UE in the overlay network. The capability may indicate that the AMF of the underlying network may be able to establish connectivity or receive external exposure of notification to or from the overlay network, and/or the like. The capability may indicate that the underlay network may be able configure an IPSec connection to the overlay network via the interworking function (N3IWF). The IPSec connection may be between the UE and the N3IWF of the overlay network, or between the UPF of the underlying network and the N3IWF of the overlay network.

In an example embodiment, provisioning may comprise preparing or equipping a wireless device, a network or a network node (or network element) to perform a service by providing one or more parameters to the network or the network node. Provisioning may cause initiation, configuration, activation or deployment of a process or service on the network node. In response to provisioning, the network node may perform an action, activate, deploy a service, or enforce a policy or rule when the network is provisioned with the one or more parameters. In an example, provisioning may be performed via a configuration message. In an example, provisioning may comprise sending a configuration message, modification message, setup message, and/or the like to the network node to enable or activate the network node to perform an operation as required. Provisioning may be performed by employing an application programming interface API, direct messaging, or service based interaction. For example, an access and mobility management function AMF may deploy an access and mobility control policy, which includes provisioning of a UE Policy to the UE and provisioning a radio access technology RAT frequency selection priority RFSP index to a radio access network RAN.

In an example, provisioning of policy and charging rules may comprise sending a message by a first network node to a second network node, a policy or rule (such as charging rule or policy) based on a subscription of a user, wireless device, service type, PDU session type, QoS flow, and/or the like. The second network node may implement the rule or policy based on an element of the message. For example, a policy and charging control function PCF may provision policy rules over an interface (e.g., N7) to a session management function SMF for the enforcement or implementation of policy and charging control in the SMF and a user plane function UPF.

In an example, provisioning of packet detection and forwarding rules may comprise providing configuration parameters for activation of a packet detection and forwarding on a user plane function. A control plane function (network node) may provision packet detection and forwarding rules to a user plane function UPF. In response to the provisioning, the UPF may activate or initiate detection and forwarding of data packets based on the rules.

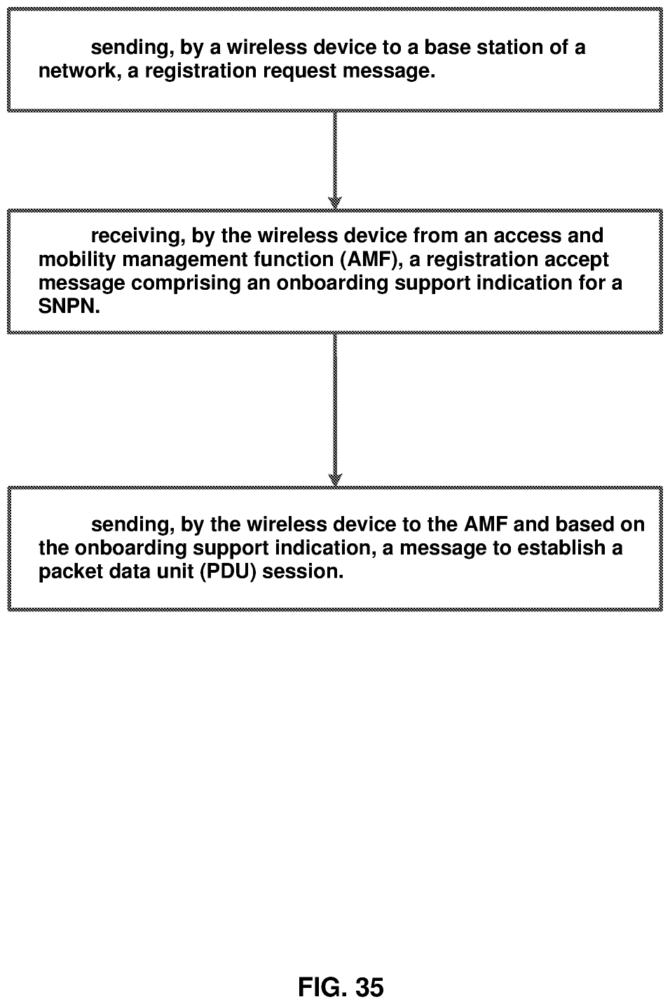

In an example embodiment as depicted in FIG. 35, a wireless device may send to a base station of a network, a registration request message. The wireless device may receive from an access and mobility management function (AMF), a registration accept message comprising an onboarding support indication for a SNPN. The wireless device may send to the AMF and based on the onboarding support indication, a message to establish a packet data unit (PDU) session.

In an example, the registration accept message may comprise a closed access group identifier (CAG ID) associated with onboarding, an address of a provisioning server (PS), a single network slice selection assistance information (S-NSSAI) associated with onboarding, a data network name (DNN) associated with onboarding, and/or the like. In an example, the registration accept message may comprise a registration area associated with onboarding, a mobility restriction associated with onboarding, and/or the like. In an example, the mobility restriction may comprise radio access technology restriction, forbidden area, service area restriction comprising allowed area and non-allowed area, core network type restriction, closed access group information, and/or the like. In an example, the registration accept message may comprise an operator defined access category associated with onboarding. In an example, the registration accept message may comprise an address of a provisioning server for onboarding of the wireless device, provisioning server information, and/or the like. In an example, the provisioning server may be associated with onboarding for SNPN. In an example, the network, the Ran node, the AMF, and/or the like may determine that onboarding support is required. The determining may be based on an identifier of the wireless device. The network may determine that underlying network capability support is required. The determining may be based on an identifier of the wireless device. In an example, the wireless device may send to a PS via the PDU session (onboarding PDU session), an onboarding request message. The PDU session may be for onboarding of the wireless device to access the SNPN, the second network, and/or the like. In an example, the wireless device may send to a PS a provisioning request for credentials to access a second network. In an example, the wireless device may receive from the PS, credentials for access to the second network. In an example, the wireless device may send to the second network, a registration request message comprising the credentials. The wireless device may receive from the second network a registration accept message. The wireless device may send to the second network, a PDU session request message. The wireless device may receive from the second network, a PDU session accept message. In an example, the PDU session may be for access of the wireless device to an N3IWF of a second network (e.g., the SNPN, the SNPN2). In an example, the registration accept message may comprise an underlying network capability support indication. The underlying network capability may comprise SNPN interworking support, SNPN signaling proxy support, SNPN overlay or underlay support, and/or the like. In an example, the registration accept message may comprise a closed access group identifier (CAG ID) associated with the underlying network capability to access an N3IWF of a second network, a single network slice selection assistance information (S-NSSAI) associated with the underlying network capability to access an N3IWF of a second network, a data network name (DNN) associated with the underlying network capability to access an N3IWF of a second network, a registration area associated with the underlying network capability to access an N3IWF of a second network, a mobility restriction associated with the underlying network capability to access an N3IWF of a second network, and/or the like. In an example, the wireless device may send to the first network, a PDU session establishment request message indicating that the PDU session is for an IPSec tunnel/connection to an N3IWF of the second network. In an example, the wireless device may receive from the first network, a PDU session accept message. The wireless device may send to an interworking network node (N3IWF) of the second network an IPSec connection request via the PDU session for IPSec.

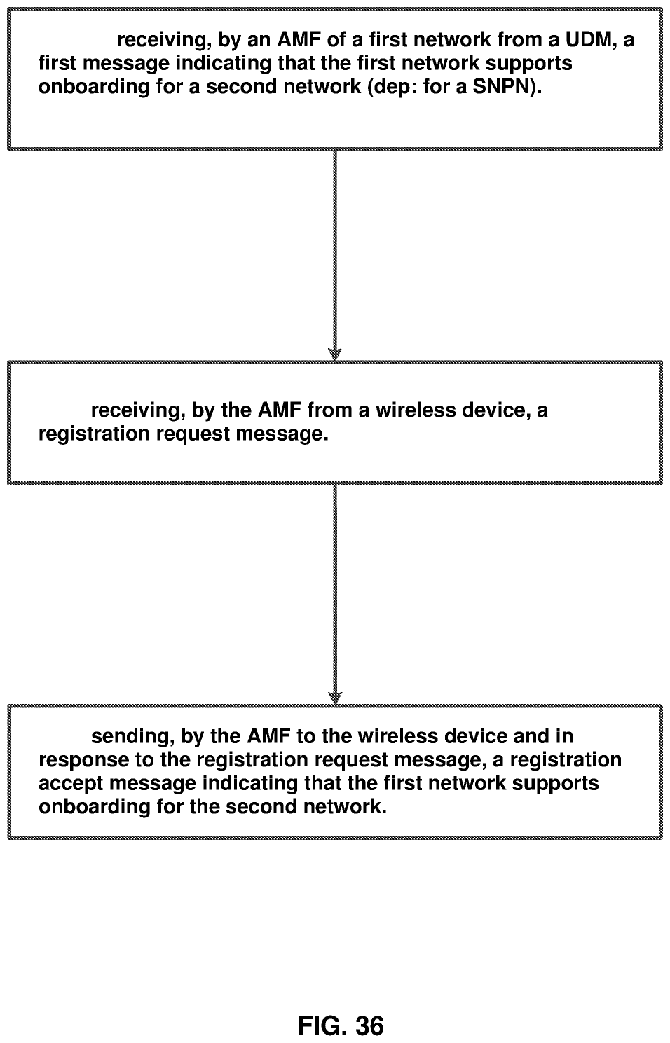

In an example embodiment as depicted in FIG. 36, an AMF of a first network may receive from a UDM, a first message indicating that the first network supports onboarding for a second network (e.g., for a SNPN). In an example, the AMF may receive from a wireless device, a registration request message. The AMF may send to the wireless device and in response to the registration request message, a registration accept message indicating that the first network supports onboarding for the second network. In an example, the AMF may send to the wireless device and in response to the registration request message, a registration accept message indicating that the first network supports underlying network capability for access to the second network.

In an example, the AMF may receive from the wireless device a PDU session establishment request for onboarding. In an example, the AMF may receive from the wireless device a PDU session establishment request for underlying network access to a second network. In an example, the PDU session establishment request message, the registration request message, an onboarding request message, and/or the like may comprise an SNPN ID. In an example, the first network may be a PLMN or a SNPN. In an example, the second network may be a PLMN or a SNPN. In an example, a base station may receive from the access and mobility management function, a configuration message comprising an onboarding support indication, an underlying network capability support indication, and/or the like. In an example, the registration request message may be an RRC message. The RRC message may comprise a closed access group identifier (CAG ID) associated with onboarding.

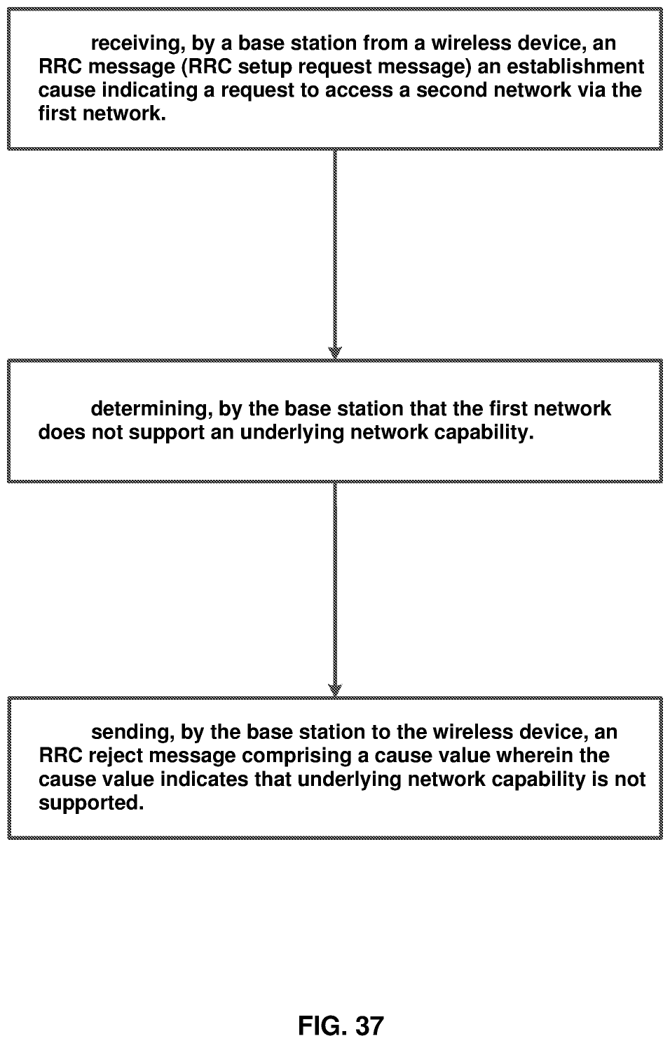

In an example embodiment as depicted in FIG. 37, a base station may receive from a wireless device, an RRC message that may comprise an establishment cause. The establishment cause may indicate a request to access a second network via the first network. The base station may determine that the first network does not support an underlying network capability. The base station may send to the wireless device, an RRC reject message comprising a cause value. The cause value may indicate that underlying network capability is not supported. In an example, the RRC message may be an RRC setup request message.

In an example embodiment, a base station may receive from a wireless device, an RRC message that may comprise an establishment cause. The establishment cause may indicate a request for onboarding and (remote) provisioning of credentials for a second network. The base station may determine that the first network does not support the onboarding and (remote) provisioning. The base station may send to the wireless device, an RRC reject message comprising a cause value. The cause value may indicate that onboarding and (remote) provisioning of credentials for the second network is not supported. In an example, the RRC message may be an RRC setup request message.

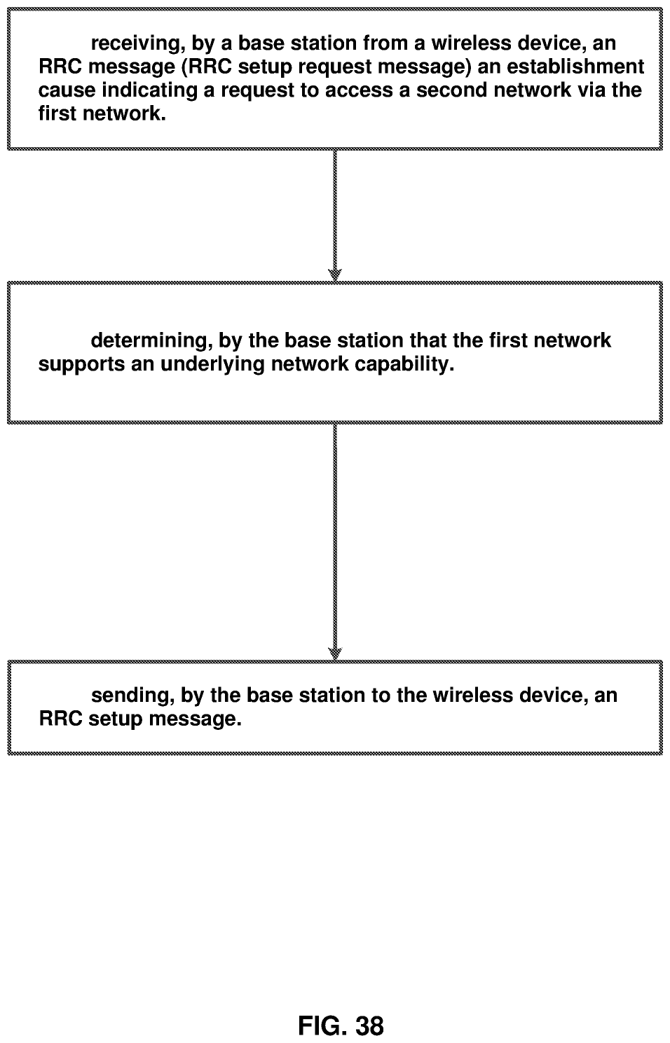

In an example embodiment as depicted in FIG. 38, a base station may receive from a wireless device, an RRC message (e.g., an RRC setup request message). The RRC message may comprise an establishment cause indicating a request to access a second network via the first network (e.g., underlying network access). The base station may determine that the first network supports an underlying network capability. The base station may send to the wireless device, an RRC setup message.

According to various embodiments, one or more devices such as, for example, a wireless device, off-network wireless device, a base station, a core network device, and/or the like, may be employed in a system. One or more of the devices may be configured to perform particular operations or actions by virtue of having software, firmware, hardware, or a combination of them installed on the one or more of the devices, that in operation causes or cause the one or more devices to perform the actions. One or more computer programs can be configured to perform particular operations or actions by virtue of including instructions that, when executed by data processing apparatus, cause the apparatus to perform the actions. Embodiments of example actions are illustrated in the accompanying figures and specification. Features from various embodiments may be combined to create yet further embodiments.

In this specification, “a” and “an” and similar phrases are to be interpreted as “at least one” and “one or more.” In this specification, the term “may” is to be interpreted as “may, for example.” In other words, the term “may” is indicative that the phrase following the term “may” is an example of one of a multitude of suitable possibilities that may, or may not, be employed to one or more of the various Examples. If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}.

In this specification, various Examples are disclosed. Limitations, features, and/or elements from the disclosed example Examples may be combined to create further Examples within the scope of the disclosure. In this specification, parameters (Information elements: IEs) may comprise one or more objects, and one of those objects may comprise one or more other objects. For example, if parameter (IE) N comprises parameter (IE) M, and parameter (IE) M comprises parameter (IE) K, and parameter (IE) K comprises parameter (information element) J, then, for example, N comprises K, and N comprises J. In an example, when one or more messages comprise a plurality of parameters, it implies that a parameter in the plurality of parameters is in at least one of the one or more messages, but does not have to be in one of the one or more messages. Many of the elements described in the disclosed Examples may be implemented as modules. A module is defined here as an isolatable element that performs a defined function and has a defined interface to other elements. The modules described in this disclosure may be implemented in hardware, software in combination with hardware, firmware, wetware (e.g. hardware with a biological element) or a combination thereof, some of which are behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally, it may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module. The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever. While various examples have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative Examples. Thus, the present Examples should not be limited by any of the above described exemplary Examples. In particular, it should be noted that, for example purposes, the above explanation has focused on the example(s) using 5G AN. However, one skilled in the art will recognize that Examples of the invention may be implemented in a system comprising one or more legacy systems or LTE. The disclosed methods and systems may be implemented in wireless or wireline systems. The features of various Examples presented in this invention may be combined. One or many features (method or system) of one Example may be implemented in other Examples. A limited number of example combinations are shown to indicate to one skilled in the art the possibility of features that may be combined in various Examples to create enhanced transmission and reception systems and methods. In addition, it should be understood that any figures which highlight the functionality and advantages, are presented for example purposes. The disclosed architecture is sufficiently flexible and configurable, such that it may be utilized in ways other than that shown. For example, the actions listed in any flowchart may be re-ordered or optionally used in some examples. Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way. Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A method comprising:
sending, by a wireless device to a base station of a first network, a registration request;
receiving, by the wireless device from a mobility management function of the first network, a registration accept message indicating that the first network provides underlay support for a second network; and
sending, by the wireless device to the mobility management function of the first network and based on the indication of underlay support, a request to establish a session with the first network.

2. The method of claim 1, wherein the first network is an underlay network, and the second network is an overlay network.

3. The method of claim 1, wherein:
the first network is one or more of:
an onboarding network;
a first public land mobile network;
a first non-public network; and
a first standalone non-public network; and
the second network is one or more of:
a second public land mobile network;
a second non-public network; and
a second standalone non-public network.

4. The method of claim 1, wherein the registration accept message indicates that the first network provides onboarding support for the second network.

5. The method of claim 1, further comprising:
sending, by the wireless device to the second network, a second registration request message comprising credentials to access the second network;
receiving, by the wireless device from the second network, a second registration accept message;
sending, by the wireless device to the second network, a request to establish a session with the second network; and
receiving, by the wireless device from the second network, a session accept message.

6. The method of claim 1, wherein the registration request comprises an identifier of the second network.

7. The method of claim 1, wherein the registration accept message comprises one or more of:
a closed access group identifier (CAG ID) associated with an underlying network capability to access an interworking function of the second network;
a single network slice selection assistance information (S-NSSAI) associated with the underlying network capability to access the interworking function of the second network;
a data network name (DNN) associated with the underlying network capability to access the interworking function of the second network;
a registration area associated with the underlying network capability to access the interworking function of the second network; and
a mobility restriction associated with the underlying network capability to access the interworking function of the second network.

8. The method of claim 7, further comprising:
sending, by the wireless device to the first network, a session establishment request message indicating that the session is for an Internet Protocol Security (IPSec) tunnel connection to the interworking function of the second network;
receiving, by the wireless device from the first network, a session accept message; and
sending, by the wireless device to an interworking function of the second network, an Internet Protocol Security (IPSec) tunnel connection request via the session, wherein the interworking function is a non-3GPP interworking function (N3IWF).

9. A wireless device comprising:
one or more processors; and
memory storing instructions that, when executed by the one or more processors, cause the wireless device to:
send, to a base station of a first network, a registration request;
receive, from a mobility management function of the first network, a registration accept message indicating that the first network provides underlay support for a second network; and
send, to the mobility management function of the first network and based on the indication of underlay support, a request to establish a session with the first network.

10. The wireless device of claim 9, wherein the first network is an underlay network, and the second network is an overlay network.

11. The wireless device of claim 9, wherein:
the first network is one or more of:
an onboarding network;
a first public land mobile network;
a first non-public network; and
a first standalone non-public network; and
the second network is one or more of:
a second public land mobile network;
a second non-public network; and
a second standalone non-public network.

12. The wireless device of claim 9, wherein the registration accept message indicates that the first network provides onboarding support for the second network.

13. The wireless device of claim 9, wherein the instructions further cause the wireless device to:
send, to the second network, a second registration request message comprising credentials to access the second network;
receive, from the second network, a second registration accept message;
send, to the second network, a request to establish a session with the second network; and
receive, from the second network, a session accept message.

14. The wireless device of claim 9, wherein the registration request comprises an identifier of the second network.

15. The wireless device of claim 9, wherein the registration accept message comprises one or more of:
a closed access group identifier (CAG ID) associated with an underlying network capability to access an interworking function of the second network;
a single network slice selection assistance information (S-NSSAI) associated with the underlying network capability to access the interworking function of the second network;
a data network name (DNN) associated with the underlying network capability to access the interworking function of the second network;
a registration area associated with the underlying network capability to access the interworking function of the second network; and
a mobility restriction associated with the underlying network capability to access the interworking function of the second network.

16. The wireless device of claim 15, further comprising:
sending, by the wireless device to the first network, a session establishment request message indicating that the session is for an Internet Protocol Security (IPSec) tunnel connection to the interworking function of the second network;
receiving, by the wireless device from the first network, a session accept message; and
sending, by the wireless device to an interworking function of the second network, an Internet Protocol Security (IPSec) tunnel connection request via the session, wherein the interworking function is a non-3GPP interworking function (N3IWF).

17. A non-transitory computer-readable medium comprising instructions that, when executed by one or more processors, cause the one or more processors to perform operations comprising:
sending, by a wireless device to a base station of a first network, a registration request;
receiving, by the wireless device from a mobility management function of the first network, a registration accept message indicating that the first network provides underlay support for a second network; and
sending, by the wireless device to the mobility management function of the first network and based on the indication of underlay support, a request to establish a session with the first network.

18. The non-transitory computer-readable medium of claim 17, wherein the first network is an underlay network, and the second network is an overlay network.

19. The non-transitory computer-readable medium of claim 17, wherein:
the first network is one or more of:
an onboarding network;
a first public land mobile network;
a first non-public network; and
a first standalone non-public network; and
the second network is one or more of:
a second public land mobile network;
a second non-public network; and
a second standalone non-public network.

20. The non-transitory computer-readable medium of claim 17, wherein the registration accept message indicates that the first network provides onboarding support for the second network.
